(19) United States
(12) Patent Application Publication
(10) Pub. No.: US 2024/0404404 A1
(43) Pub. Date: Dec. 5, 2024

(54) Decentralized Road Safety System with AI-based Road Warning Signs

(71) Applicant: Mehrgan Rouhi, Bethesda, MD (US)

(72) Inventor: Mehrgan Rouhi, Bethesda, MD (US)

(21) Appl. No.: 18/644,091

(22) Filed: Apr. 23, 2024

Related U.S. Application Data
(60) Provisional application No. 63/497,740, filed on Apr. 23, 2023.

(51) Int. Cl. G08G 1/0967; G08G 1/01; G08G 1/0968

(52) U.S. Cl. CPC G08G 1/096775; G08G 1/012; G08G 1/0133; G08G 1/096883

(57) ABSTRACT

A road safety system with a virtual animal crossing alert system, a portable road safety device, and a virtual road sign display system. The animal crossing alert system uses an AI module on a server to analyze real-time data on wildlife, weather, and traffic to predict animal presence and send alerts to a safety device on a vehicle when the likelihood is high. The portable device may connect to smartphones, physical buttons for user input, a camera interface for capturing road events, and vibration alerts and navigation apps. The portable device enables reporting of road hazards. The virtual road sign system processes data to determine optimal display times and rewards accurate data reporting with fungible tokens issued on a distributed ledger. The system integrates data from various sources, including user reports and distributed ledger NFTs, to provide timely, relevant alerts and information to drivers, improving overall road safety.

### CROSS-REFERENCE TO RELATED APPLICATIONS

This application claims the benefit of U.S. Provisional Patent Application No. 63/497,740, filed on Apr. 23, 2023, entitled “Blockchain-Based V2X Communication System & Animal Presence Prediction,” which is incorporated by reference in its entirety for all purposes.

### BACKGROUND

### Field

This disclosure relates generally to navigation systems and vehicle-to-everything (V2X) communication technologies, and more particularly, to an improved system for facilitating real-time reporting and interaction with navigation apps to enhance road safety.

### Background

Current systems, including widely used navigation apps such as Waze, Google Maps, and in-vehicle systems compatible with iPhone (CarPlay) and Android devices, face significant challenges that impact their effectiveness in improving road safety. Users often find the manual process of reporting road events via these platforms cumbersome and distracting, which not only poses safety risks but also detracts from the driving experience. This distraction is particularly problematic as it requires interacting with smartphones or in-vehicle systems while driving.

Moreover, the data related to road events reported through these systems is often limited in type and detail, which hampers the overall effectiveness of the data collected. These systems also struggle with integrating diverse data types from various users, including pedestrians and cyclists, thus limiting the comprehensiveness and utility of the safety data.

Another significant issue is the accuracy and authenticity of the data reported. Many systems are susceptible to receiving incorrect or misleading information due to the lack of robust validation mechanisms, which can degrade the reliability of safety alerts significantly.

There is a clear need for an improved system that simplifies the process of reporting road events to minimize driver distraction, enhances the quality and quantity of data collected, ensures the accuracy and reliability of the data, and effectively integrates information from all road users to enhance road safety comprehensively.

### BRIEF SUMMARY OF THE INVENTION

The system includes a road safety device to minimize the problems and factors involved in the driver's distraction during the manual reporting of road events (incident, anomaly). Using the road safety device, the driver's interaction with navigation apps and the car display (Car-Play, Android-Auto, etc.) increases and becomes easier. The road safety device allows the users to report Road events in more detail just by pressing a single button. The road safety device may automatically takes photos of the road event (incident, anomaly) without the driver's intervention.

This road safety device resolves the limitation for user interaction with navigation apps at times when the user does not need to use them for routing. Also, it maximizes the chance of observing and reporting road events (incident, anomaly) for the driver in different conditions. Using this road safety device and its capabilities in dangerous conditions and incidents provide more options for announcing hazard to the driver.

The road safety device with different methods minimize displaying the unintentional or wrong reports and solves the problems of ride-hailing app (Uber, Lyft) drivers to observe and report road events (incident, anomaly). It also enhances the taxi drivers' interaction with the ride-hailing apps (Uber, Lyft) with low distraction. This road safety device with the ability to connect to all navigation apps, including Waze, Google Maps, Apple Maps, etc. solves other problems explained in the background section and opens a new window in line with the growth of practical usage in the field of V2V and V2X communication.

Despite the low price for the road safety device, the software and hardware system are designed in a way that gives the road safety device capability to work without dependence on navigation apps, Car-Play, Android-Auto systems and vehicle displays. This road safety device is also compatible with them so that it does not interfere with their operation. The road safety device is easily connected to all old and new motor vehicles and solves the problem of V2V communication interruption in vehicles without restrictions on brand, features and production year. Furthermore, a specific version of the road safety device is also designed to work with bicycles and scooters.

The road safety device is capable of connecting vehicles to our system, V2V and V2X network, on the Blockchain.

The system provides many hands-on features to users and plays a significant role in increasing the safety of vehicle passengers and reducing road incidents. Also, the system implements V2V and V2X communication along with a safety reward token based on road segment NFTs and public distributed ledger (e.g., Blockchain). The safety reward is provided as a SCT (Safety Contribution Token) that increases the motivation of users to provide road incident data. The SCT system uses road NFTs and distributed ledger (e.g. Blockchain) technology to provide a platform for creating a decentralized, virtual road network with incident information to improve safety. Furthermore, the system, specifically aims to solve problems associated with vehicle-animal collisions and includes a virtual animal crossing road warning signs, that users of the real world road can access. The virtual animal crossing road warning sign predict the animal presence ahead of the driver based on different variables. This is done by using various elements of the system, including hardware road safety devices, artificial intelligence, and distributed ledger technology (e.g. Blockchain). The SCT system makes it practical to predict the probability of animal presence on the road ahead and provides early notification that a driver can see and take action based on. The system provides occasional virtual road warning signs. In this system, using software and hardware, the vehicles, drivers, passengers, bike and scooter riders may interact with the transportation metaverse in various way including through a distributed ledger.

This distributed ledger system connects real world roads to virtual roads of the transportation metaverse, so users can participate in this transportation metaverse and make earn rewards by traveling and doing acceptable activities through real roads. IN addition users will have more safety on the roads by using system features. The system splits the roads into unique virtual road segments. The virtual roads may be comprised of multiple geo-tiles. A virtual road may be associated to a NFT.

The value of the geo-tiles and virtual roads (a set of geo-tiles) is determined based on various criteria and features of the road network, including the amount of daily transportation, geographical area, user behavior, and supply and demand.

The system may use geographic map data for the delineation and characterization of virtual road geo-tiles. The system may employ a suitable source of street map data, for example, OpenStreetMap data may be used. This data may undergo preprocessing to accurately extract and define features for the virtual road segments within the system's architecture.

Each virtual road segment may be standardized to dimensions that facilitate uniform analysis and interaction within the system, for example the segments may be designed as squares, with each side measuring 153 meters in length, approximately translating to 502 feet. The dimensions may be set to ensures that each segment is substantial enough to represent meaningful sections of roadways while maintaining manageability for data processing and analysis.

To accurately place and reference these virtual road segments on a global scale, the system may employ a widely recognized geospatial reference framework. The World Geodetic System 1984 (WGS84) may be used to serve as the foundational geographic coordinate system for this purpose, offering a well accepted standard for Earth geography. Within spatial databases and applications that handle geospatial data, the Spatial Reference System Identifier (SRID) 4326 is assigned to data adhering to the WGS84 standard. This identifier ensures that the system's geospatial data aligns with global positioning standards, enabling consistent and precise location referencing across the system.

For the unique identification and management of individual road segments, a geohash encoding system may be implemented. Each segment may be assigned a geohash with a precision of seven floating points, serving as a unique identifier for the segment. This approach allows for efficient indexing and retrieval of segment data, facilitating various system operations such as analysis, reporting, and the application of the system's functionalities to specific road sections.

For fair distribution reward, the Proof-of-Help (POH) algorithm is used. Calculation and distribution reward (SCT) depends on various factors that the system calculates. Some of them are as follows: type of road safety device connected to the vehicle, type of vehicle, type of fuel, amount of emissions, type of use, validity, peripheral parts connected to the main road safety device, validity of vehicle avatar and user activity avatar, records of avatars, proper behaviors, amount of help, compliance with driving rules, type of reports sent, approval and validity rank of reports, quantity and quality of system activities, road network features and Blockchain-based blocks in which the user activity and traveling of users are recorded, the distance traveled by avatars, the campaigns and activities on geo-tiles, type of NFTs attached to the user avatars, cryptocurrency wallet (hereafter will refer to it as wallet) SCT transactions and its validity, impact of user activities on the results in order to increase safety of roads, and reducing accidents and environmental damage.

Traveler UseIDs have a user activity avatar as NFT in this system and they may get rewards in the correspond private key (for example as found in a cryptographic wallet) owned wallet. By connecting the road safety device to the vehicle, a dedicated vehicle avatar will be created and a corresponding NFT may also be created for the vehicle. The owner of the vehicle avatar can issue their permission so that other users (up to 3 users) with different avatars and different wallets can use the same vehicle. The subject matter does not directly interfere with the validity of the user activity avatar of the original owner, but if the validity of the avatar of the vehicle is reduced, it can affect the quantity of future rewards for all 3 users.

The ownership of the vehicle avatar depends on the use and ownership of the vehicle. In case of handing over or selling the vehicle, the vehicle avatar will be sold to the new owner or deactivated by the traveler userID. NFT value of vehicle avatar is determined based on the POH algorithm including validity of vehicle avatar and supply and demand in the marketplace.

In addition to calculations and initial processing of data and transferring it encrypted to the Blockchain and Transportation metaverse-based avatars, these road safety devices make it easier to receive data and evolve the user's avatars.

The system will have a cryptocurrency or token (SCT). The system may use an artificial intelligence engine to analyze user behavior and data validation and the SCT reward may be calculated by the POH algorithm

### BRIEF DESCRIPTION OF THE DRAWINGS

FIG. 1A: a high-level diagram that illustrates a transportation metaverse system

FIG. 1B: high-level data loading diagram that illustrates the data that goes into the database

FIG. 1C: A flowchart for system data initialization.

FIG. 1D: The number of roads covered by blocks.

FIG. 1E: An example geo-tile overlayed on a map

FIG. 1F: The example geo-tile with four tiles breakout showing layers of data

FIG. 1G: The example geo-tile with a set of geo-tiles highlighted making up the virtual road from A to B

FIG. 1H: The example geo-tile with the second set of geo-tiles highlighted making up a second virtual road from C to D

FIG. 1I: Each block with different data as a layer (categorized).

FIG. 1J: a high-level diagram that illustrates how warnings are generated by the AI engine

FIG. 1K: A process flow for a Road Safety Device: Point of Event Reporting and Asset Minting Process

FIG. 1L (FIG. 58): Block diagram for POH algorithm along with artificial intelligence engine.

FIG. 1M (FIG. 60): Flowchart for function process of the Ranks in POH algorithm.

FIG. 1N (FIG. 61): Flowchart for function process of the Rank X (mode X>Z) in POH algorithm.

FIG. 1O: Block diagram for the whole system function.

FIG. 1P: Use Case Diagram for the Transportation Metaverse API

FIG. 1Q: Block diagram of the Blockchain proxy Dapp to interface between the database of server and the blockchain platform.

FIG. 1R: Different elements of the road safety device version 1 which are connected to each other and to the peripheral units in a vehicle.

FIG. 2: Block diagram of road safety device version 1 (Connection of road safety device version 1 to server, smartphone, peripheral parts).

FIG. 3: The GUI road safety device placement on the steering wheel of a vehicle and a bicycle.

FIG. 4: Physical buttons and round touch direction selection, screen and other elements of the GUI road safety device.

FIG. 5: User interaction with the GUI road safety device; icons arrangement on the display.

FIG. 6: Various reports of road events and display them on the display.

FIG. 7: Display road events and report a new road event by the driver simultaneously.

FIG. 8: Placement of a separate speaker in the vehicle to announce notifications.

FIG. 9: The GUI road safety device with a new arrangement of icons, specific for ambulance, fire truck, school bus.

FIG. 10: Function of the peripheral unit camera (basic version) for taking a photo of the animal while reporting a road event by the driver.

FIG. 11: Replacing the smartphone camera with the peripheral unit camera to connect to the road safety device.

FIG. 12: road events detecting and reporting using peripheral unit camera (advanced version).

FIG. 13: Display notifications issued by the artificial intelligence engine to predict the chance of animal presence on the road ahead of the driver.

FIG. 14: Display Road notifications like speed limit, speed camera, etc.

FIG. 15: Display notifications issued by the artificial intelligence engine for high-risk and collision-prone areas.

FIG. 16: Display the high probability of collision with other vehicles at intersections and secondary routes to main intersections or vice versa.

FIG. 17: Announcing the presence of vehicles on a mission like an ambulance or a school bus while getting off children.

FIG. 18: Block diagram for the connection and position of the electronic components which made the version 1 road safety device, including mainboard, the GUI road safety device, peripheral unit of the Gas Pedal Pad of vehicles and peripheral unit of safety alarm bracelets for motorcycles.

FIG. 19: Block diagram of connection and position of electronic components which connect peripheral unit camera of advanced version to the road safety device version 1.

FIG. 20: Placement of the road safety device version 2 (special road safety device for users of navigation Apps) in the vehicle.

FIG. 21: Peripheral unit connection to the road safety device version 2 in the vehicle.

FIG. 22: Block diagram of road safety device version 2 (road safety device version 2 connection to the server, smartphone, peripheral parts).

FIG. 23: Block diagram of connection and position of electronic components of road safety device version 2.

FIG. 24: Block diagram of connection and position of electronic components that made the Gas pedal pad peripheral unit of vehicles and safety alarm bracelets for bicycles and scooters.

FIG. 25: Schematic for peripheral circuit GAS pedal pad for communication with device version 1.

FIG. 26: Schematic for safety alarm bracelets peripheral unit for communication with road safety device version 1 including PPG sensor circuit, wireless transceiver circuit.

FIG. 27: Schematic for Gas Pedal Pad Cover peripheral unit for connection to road safety device version 2 including circuits of vibrator, Loadcell.

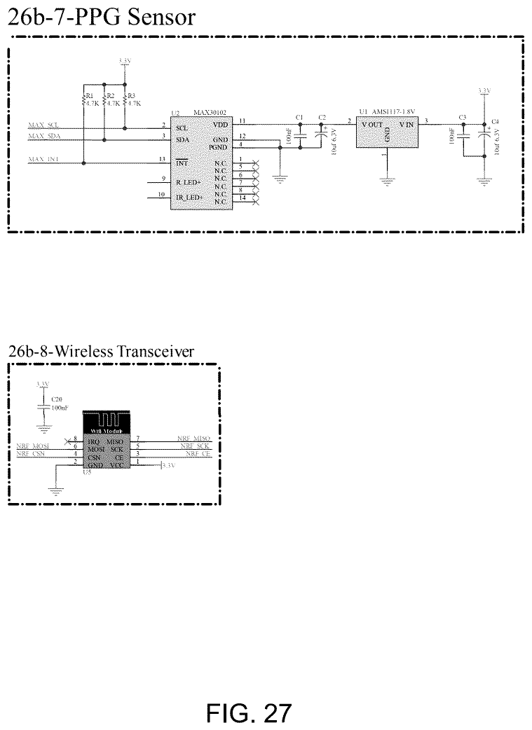

FIG. 28: Schematic for Safety alarm bracelets peripheral unit to connect to road safety device version 2 including circuits for PPG sensor, wireless transceiver.

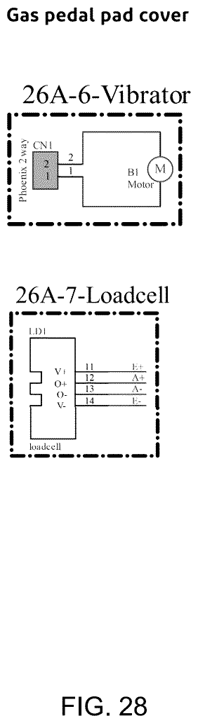

FIG. 29: System overview.

### DETAILED DESCRIPTION

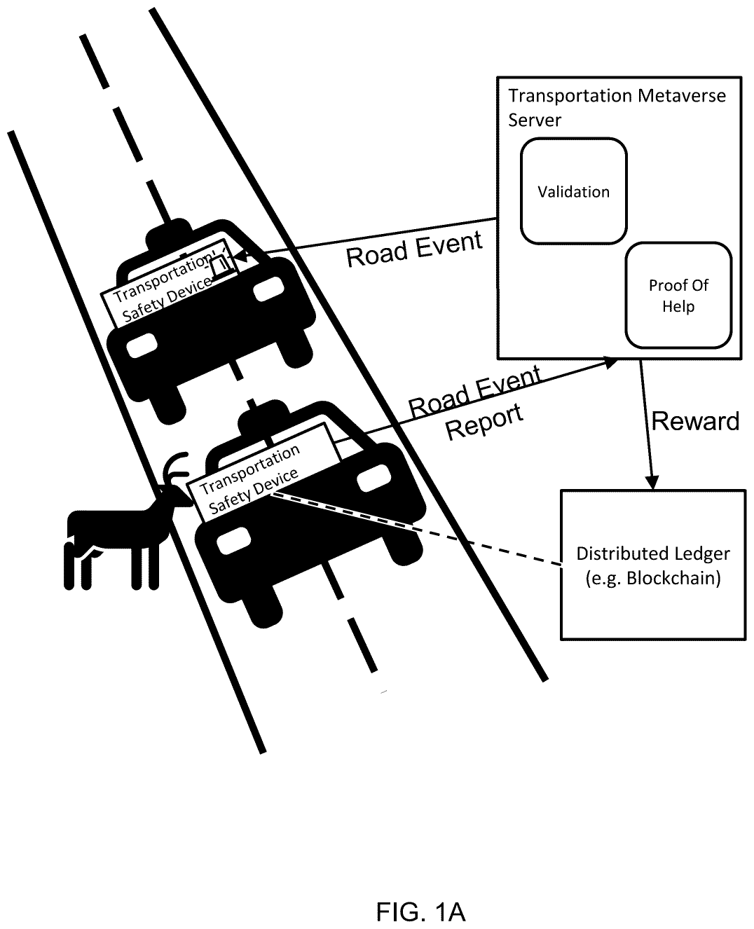

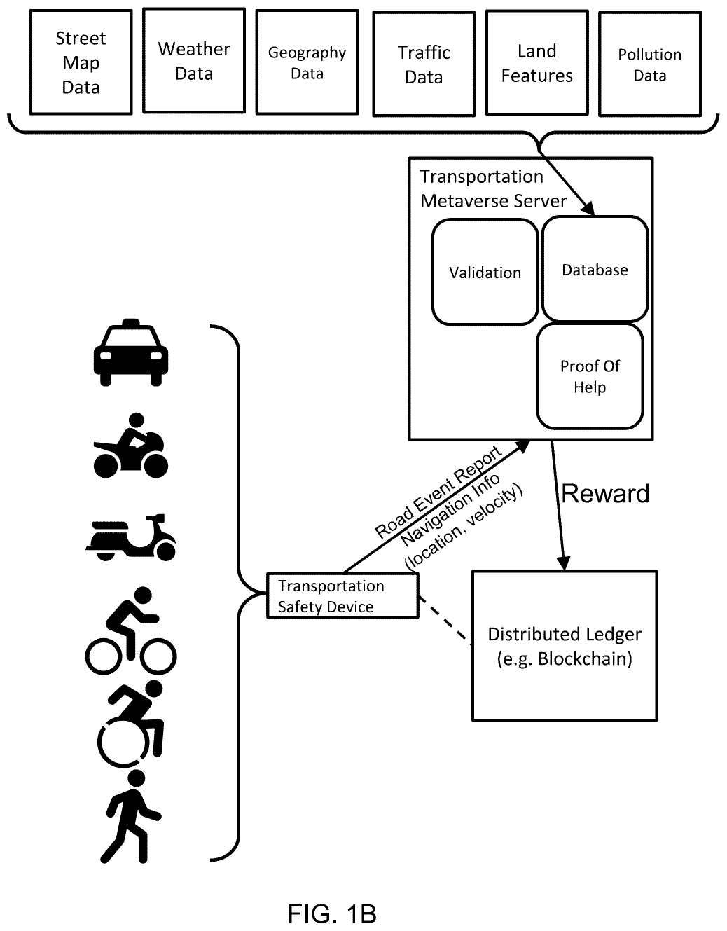

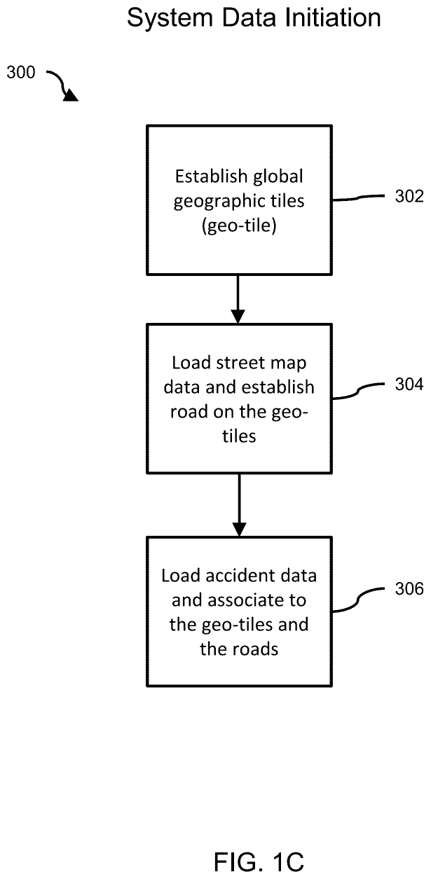

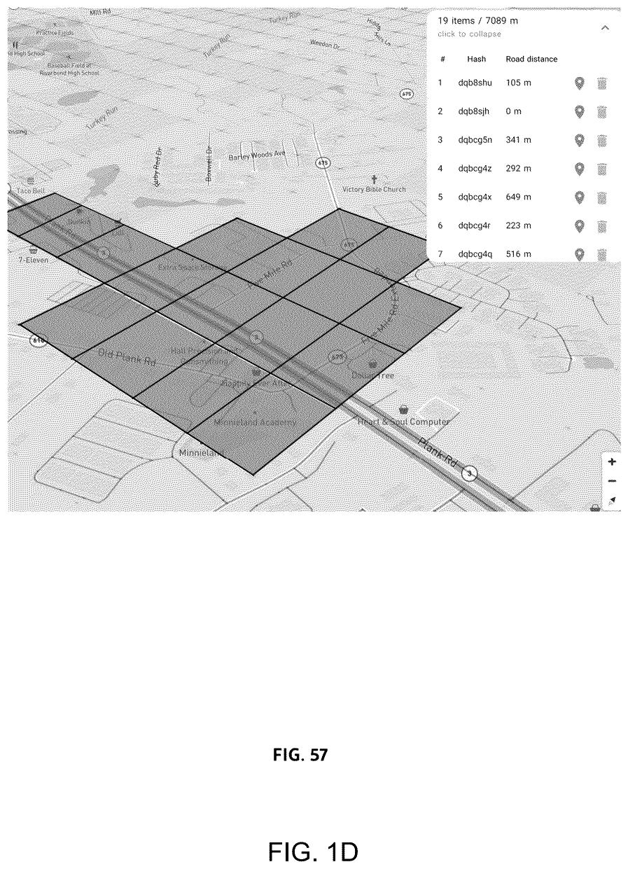

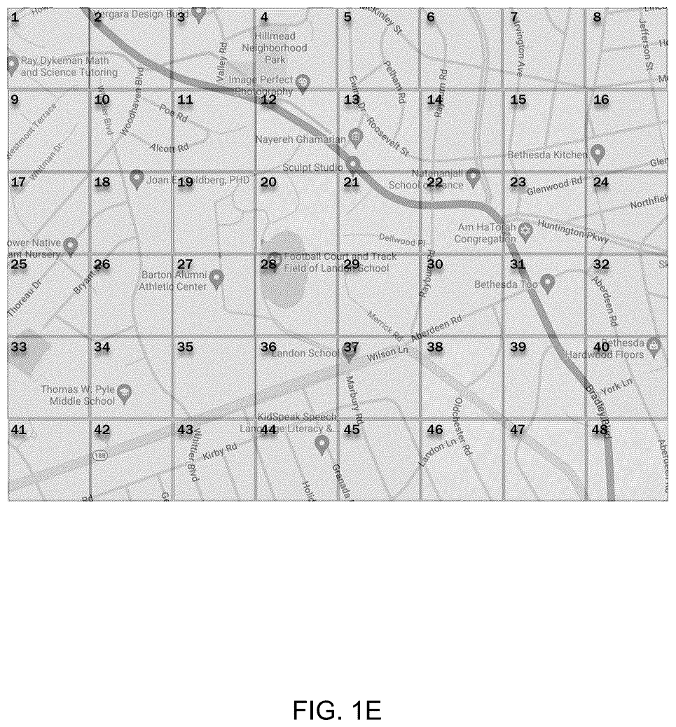

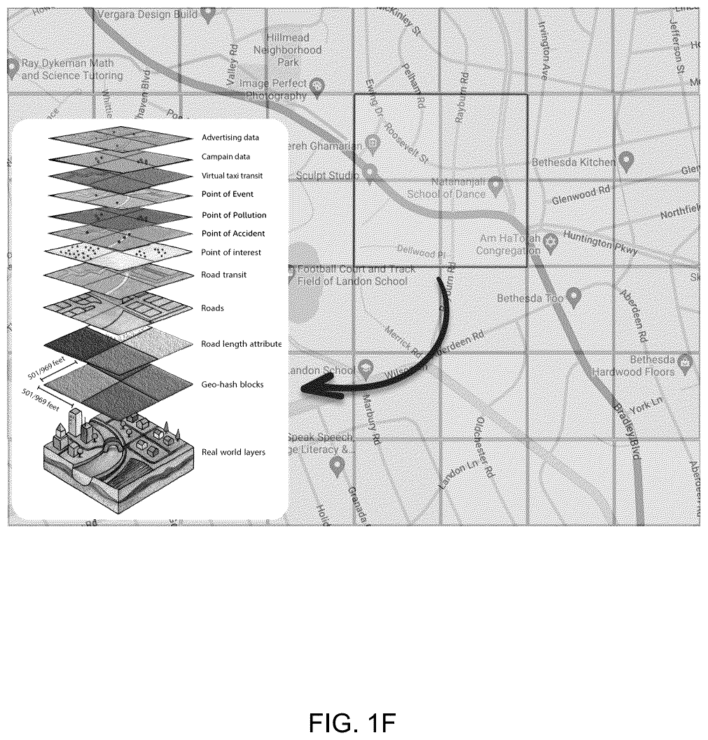

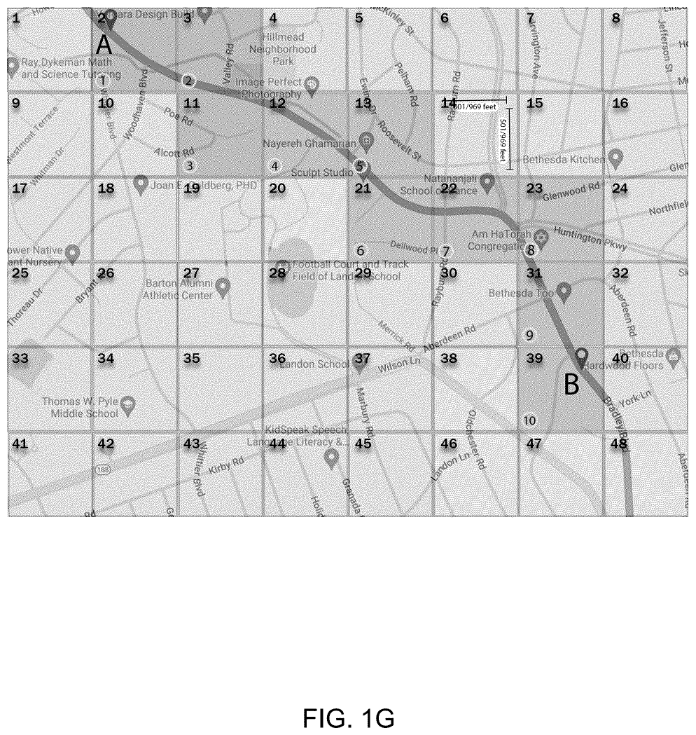

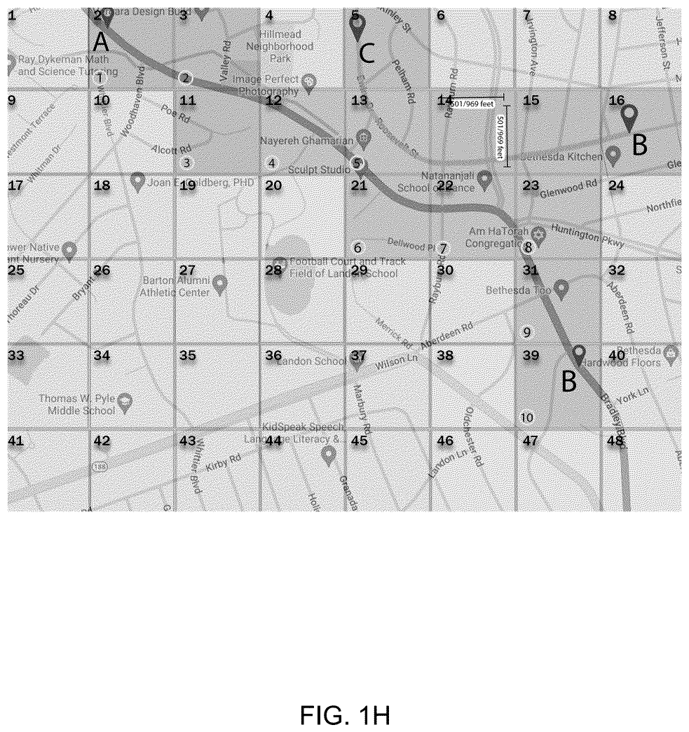

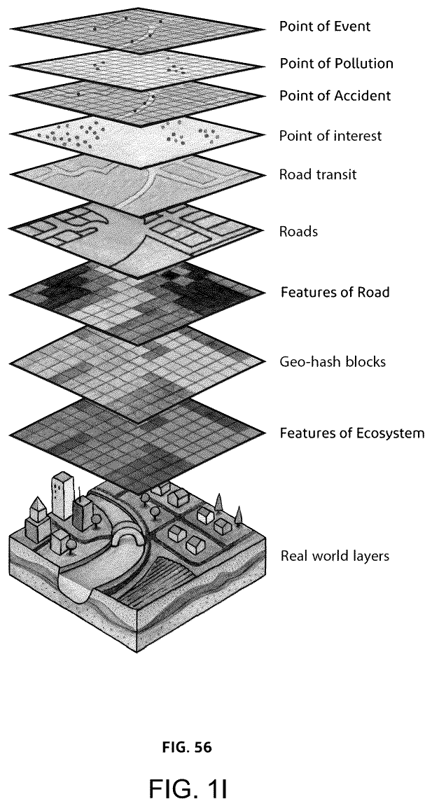

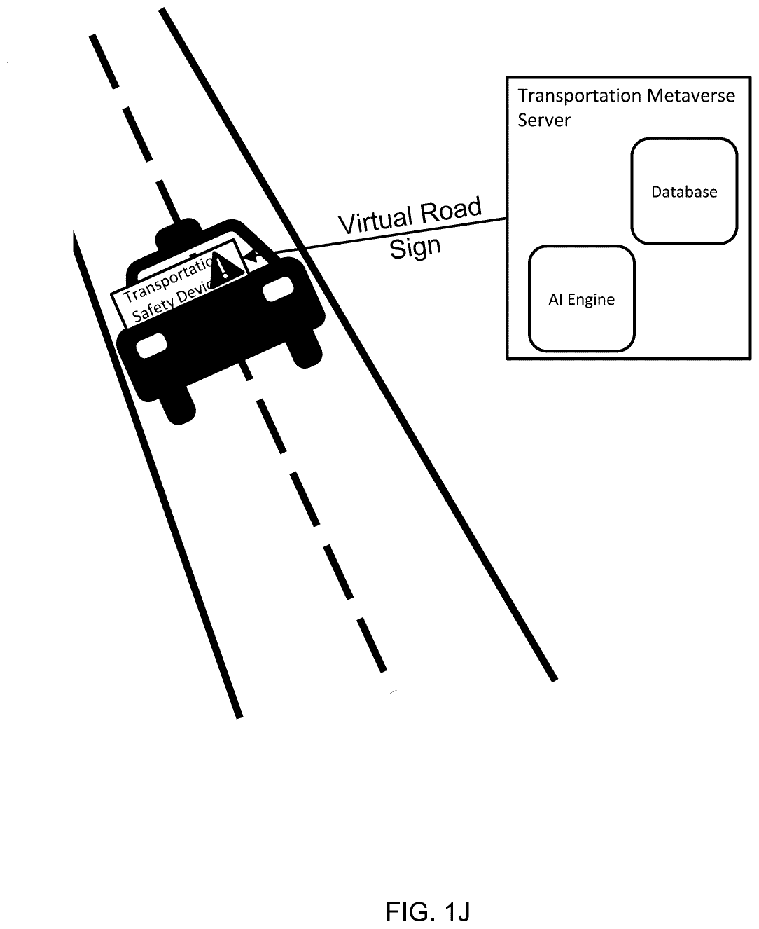

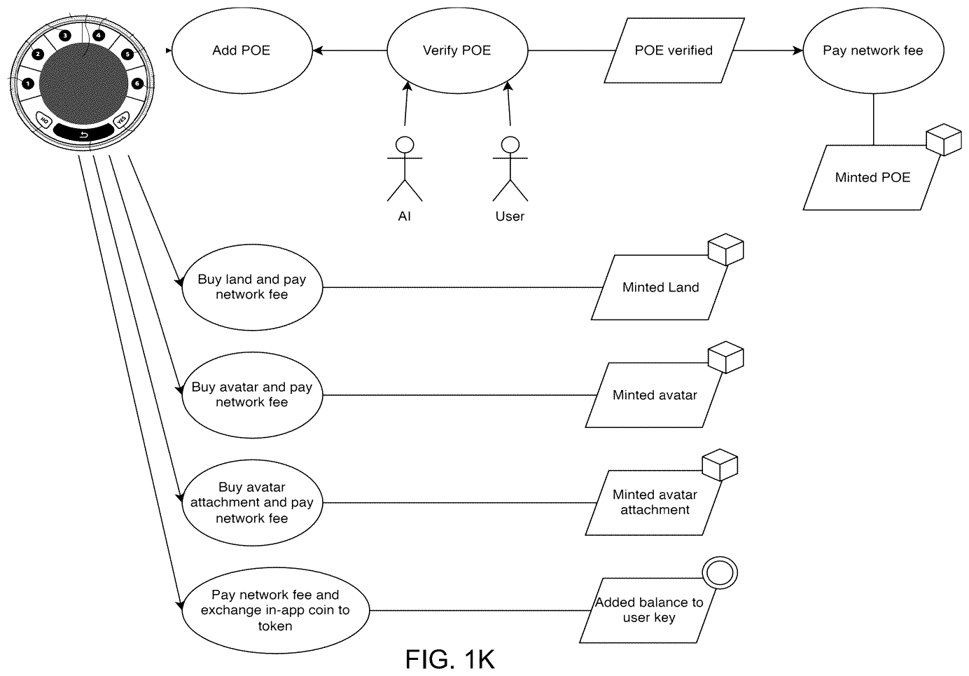

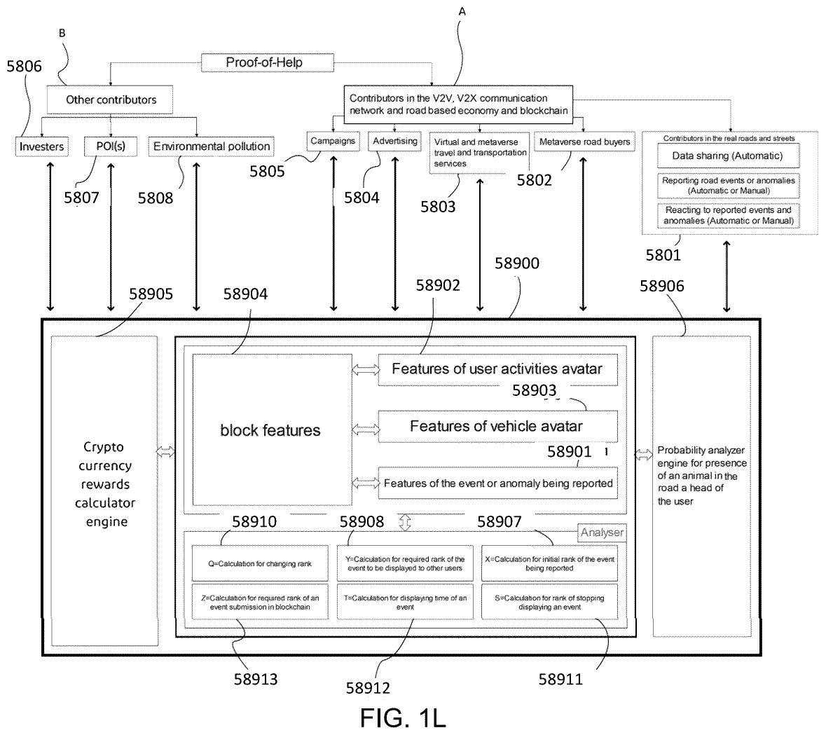

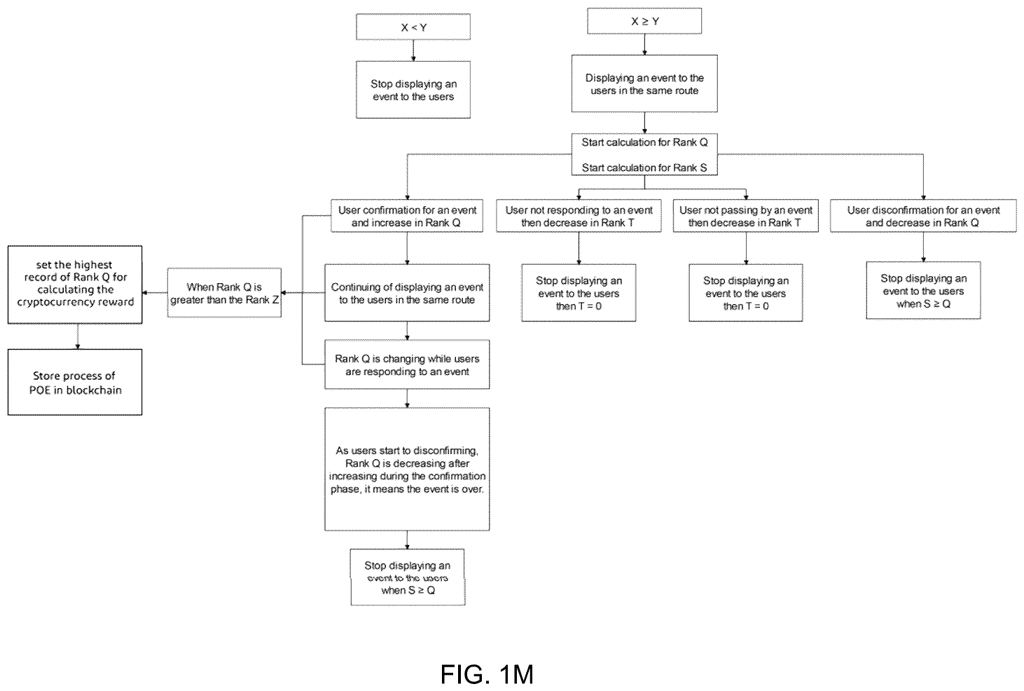

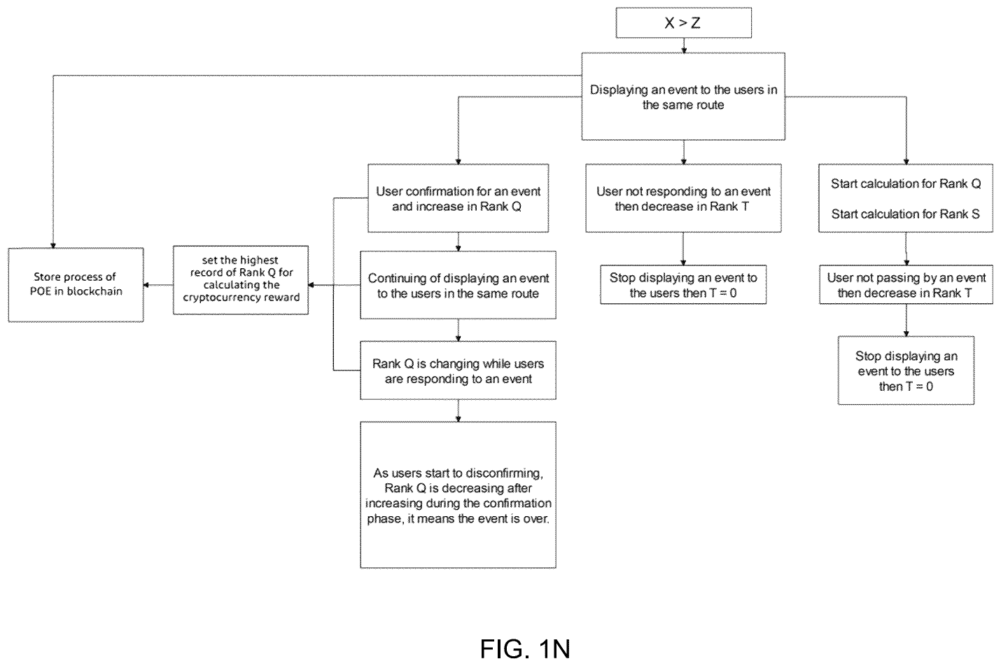

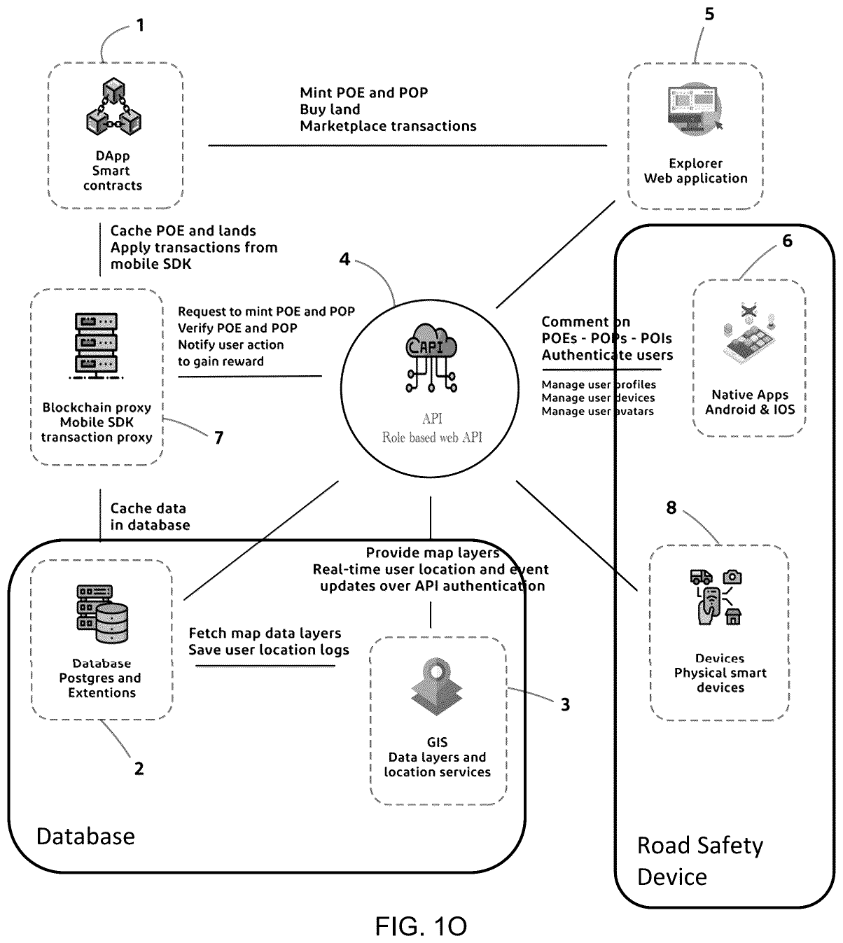

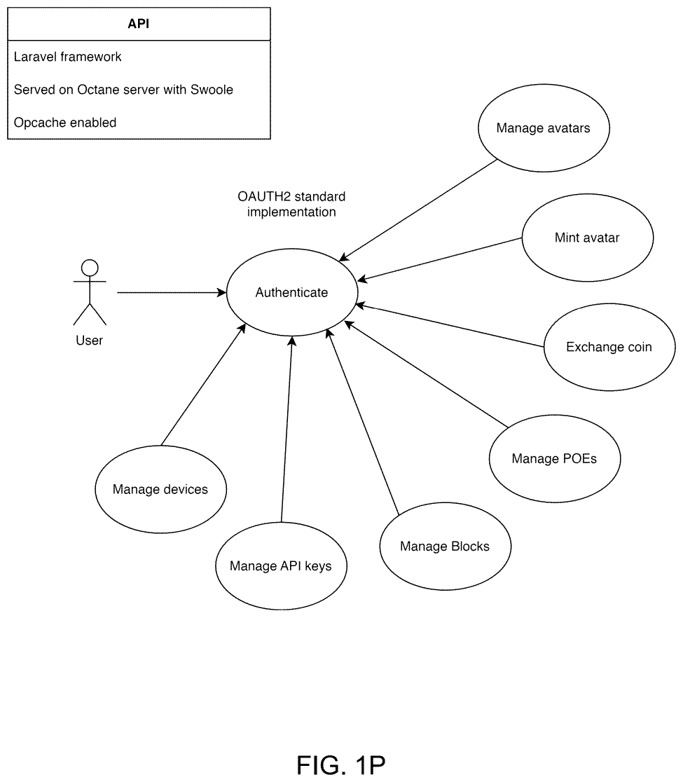

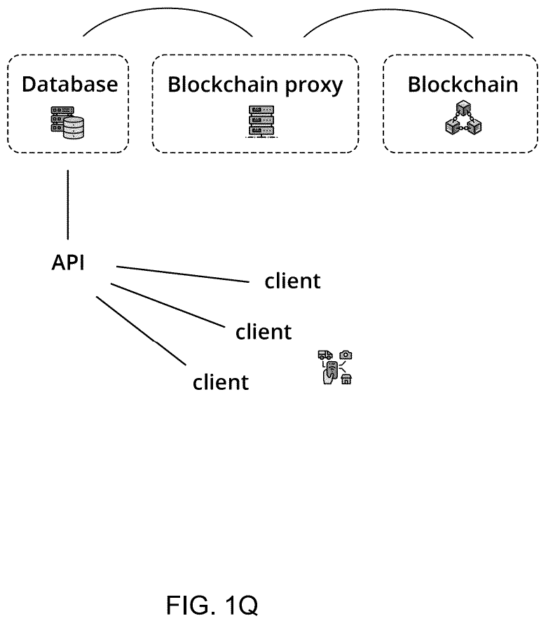

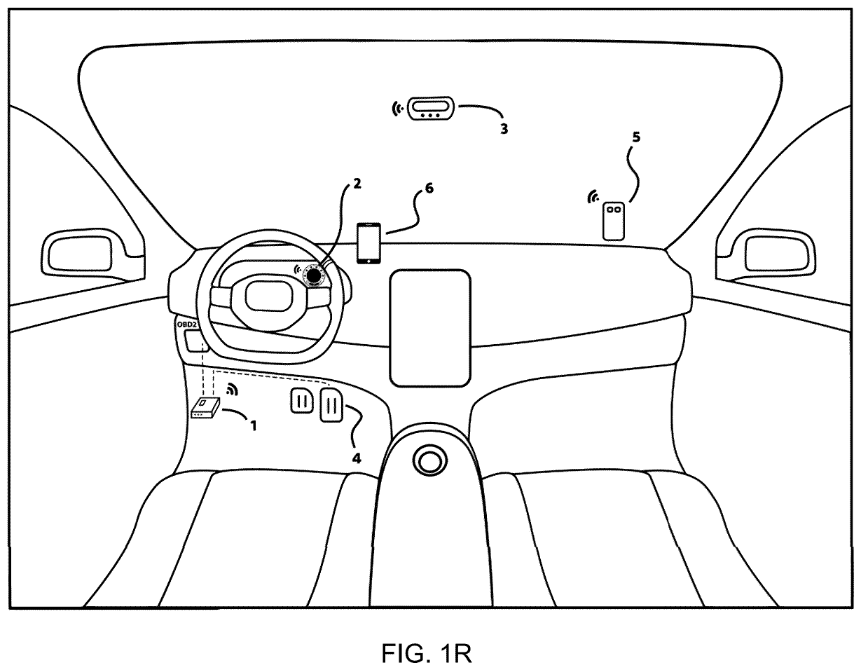

FIG. 1A shows a high-level diagram 100 that illustrates a transportation metaverse system 102, which includes a validation module 104 and a Proof of Help (POH) algorithm 106. The transportation metaverse system 102 is connected to a Distributed Ledger 108 (e.g., Blockchain) via a reward path 110. The Distributed Ledger 108 stores the validated Road Event data.

A first vehicle 111A with a first road safety device 112A and a second vehicle 111B with a second road safety device 112B, each capable of reporting Road Events. When a Road Event occurs, the first road safety device 112A sends a road event report 116 to the transportation metaverse server 102 for validation by the validation module 104.

The validation module 104 assesses the validity of the received road event report 116. If the road event report 116 is deemed valid, the transportation metaverse server 102 may send a validated road event 118 to the second road safety device 112B, which then displays a road event warning 120 to alert the driver of the potential hazard ahead.

Additionally, the Proof of Help (POH) algorithm 106 calculates a reward based on predefined criteria for the first road safety device 112 that reported the validated road event. The calculated reward is then sent via the reward path 110 to the distributed ledger 108, where it is securely stored and associated with a private cryptographic key of the reporting road safety device 112.

FIG. 1B shows a high-level data loading conceptual diagram 200 that illustrates the data that goes into the database 202 on the transportation metaverse server 102. The data includes street map data 206, weather data 208, geography data 210, traffic data 212, land features 214, and pollution data 216.

The road safety device 224 is depicted with various icons representing different use scenarios for the road safety device 112C, specifically in a car 230, a motor cycle 232, a scooter 234, a bicycle 236, a wheelchair 238, and a walking person 240. These icons illustrate the diverse range of scenarios road safety device 224 to provide road event reports 116 and contribute to the overall safety of the transportation network.

FIG. 1C shows a flowchart 300 for system data initialization. The flowchart 300 starts at box 302 where global geographic tiles (geo-tile) are established. The flowchart 300 continues at box 304 where street map data is loaded and roads are established on the geo-tiles. The flowchart 300 then finishes to box 306 where accident data is loaded and associated to the geo-tiles and the roads.

At box 302 the global geographic tile geo-tiles are established.

In considering the process of dividing the Earth's surface into defined areas, the transportation metaverse system may employ various methods. Utilizing the Haversine Formula, known for its precision in calculating distances on a spherical surface, the system may initially demarcate exact geo-tiles globally. These geo-tiles, potentially measuring 501.969 feet by 501.969 feet (153 meters by 153 meters), maintain an aspect ratio of 1:2 in the WGS84 coordinate system (SRID=4326). Each geo-tile may be uniquely identified by a geo-hash, assigned with seven decimal places of precision.

Subsequent to the delineation of geo-tiles, the system may leverage street map data to preprocess and classify features within each geo-tile, thereby distinguishing the roads. Roads may be represented as collections of geo-tiles, each characterized by various weighted features, as illustrated in FIG. 1I. This classification not only includes road features but may extend to environmental elements, all organized in multiple layers within the system. As the real world evolves, these virtual representations may be updated to reflect changes, maintaining synchronization with their physical counterparts.

The system may further enhance its spatial data structure by creating interactive geo-tiles capable of integrating with distributed ledger technology. The valuation of each geo-tile may be based on multiple factors, such as road network complexity, transportation volume, and interactions within the safety device network. The uniqueness of each geo-tile ensures that every virtual road consists of a distinct set of geo-tiles.

While the example provided utilizes square geo-tiles, it is worth noting that the system may incorporate various other shapes, such as hexagons or a composite of shapes, to effectively cover the Earth's terrain. The system accounts for the differences between Cartesian and spherical coordinate systems, implementing a formula to approximate a 501.969 feet (153 meters) distance in spherical terms. Recognizing the Earth's ellipsoidal shape, the system opts for a spherical model to maintain consistency in geo-tile size, accepting minimal errors introduced by this simplification.

Ultimately, the method chosen to establish geo-tiles aims for the highest degree of accuracy, minimizing potential discrepancies and ensuring that each geo-tile's dimensions and position are precisely defined. The system's adoption of the Haversine Formula, as endorsed by R. W. Sinnott, underscores its commitment to precision, especially over short distances where this approach is particularly effective.

The Haversine Formula is as follows where φ1 is first point latitude, φ2 is second point latitude, λ1 is first point longitude and λ2 is second point longitude that all are in radians.

$$φ1 = latitude 1 \cdot \frac{π}{2}$$

$$φ2 = latitude 2 \cdot \frac{π}{2}$$

$$λ1 = longitude 1 \cdot \frac{π}{2}$$

$$λ2 = longitude 2 \cdot \frac{π}{2}$$

$$h = {sin}^{2} ( \frac{φ2 - φ1}{2} ) + cos ( φ1 ) \cdot cos ( φ2 ) \cdot {sin}^{2} ( \frac{λ 2 - λ 1}{2} )$$

And to calculate the distance in radians the following can be use:

$$θ = 2 \cdot arcsin ( \sqrt{h} )$$

$$θ = 2 \cdot arctan ( \frac{\sqrt{h}}{\sqrt{1 - h}} )$$

And finally the system can transform distance to feet by multiplying radians to earth radius which is estimated at 20902230.97 feet (6,371,000 meters).

R=20902230.97 feet (6,371,000 meters)

d=R·θ

At Box 304 the street map data is loaded and roads are established on the geo-tiles

FIG. 1D: The number of roads covered by geo-tiles.

FIG. 1E shows an example geo-tile overlayed on a map. The system identifies numerous roads varying in length and attributes, with some geo-tiles not encompassing any roads at all.

FIG. 1F show the example geo-tile with four tiles breakout showing layers of data. For example the official United States accident data from 2020 to 2023 may be allocated to corresponding roads within the geo-tiles, using their Point of Accident (POA) geographical coordinates. It is designed so that users traversing these roads can report road events (POE) or instances of environmental pollution (POP) through the use of mobile applications and the road safety device. The collated data is cataloged with geographic details, road assignments, and transit routes, thereby enriching each geo-tile with a diverse array of data categories.

In the accompanying illustration, a visual representation of these categories is provided, showcasing the data organized in layered blocks. The figure presents four such geo-tiles, depicted adjacently for comparative analysis.

FIG. 1G show the example geo-tile with a set of geo-tiles highlighted making up the virtual road from A to B. Roads are segmented into a series of geo-tiles, with a given stretch of road encompassing a set of these geo-tiles. For instance, a road running from point A to point B might be divided into a set of 10 geo-tiles. Therefore, acquiring the segment from A to B equates to gaining ownership of the set of geo-tiles that constitute this specific route, as well as partial ownership of any other roads that fall within these geo-tiles, allowing for the potential collection of SCT from these additional road segments.

FIG. 1H shows the example geo-tile with the second set of geo-tiles highlighted making up a second virtual road from C to D. As a result, a geo-tile may contain multiple roads, intersections, and various geographical features, or it might encompass just a singular road or potentially none. For example, in the illustration provided, geo-tile number 33 is void of any roads, whereas geo-tile number 37 includes multiple roads and intersections.

Should an individual acquire the segment from route A to B, and if I intend to purchase the segment from route C to D, geo-tile number 13 would be a part of this segment. In such a case, I would have the opportunity to acquire only the geo-tiles highlighted in blue (numbers 5, 14, 15, 16).

In the system, the total value of a set of geo-tiles is determined by various factors including road length, traffic volume, data storage capacity, user engagement, advertising frequency, campaign activity, virtual passenger traffic, and virtual traffic ticket issuance.

While there is no inherent requirement to connect all geo-tiles containing road data to the distributed ledger, the initial purchase and minting of road segments as NFTs by users facilitate their linkage as ERC 1155 NFTs. Before this distributed ledger connection, the system remains operational. Irrespective of the minting status, users reporting road incidents or environmental issues validated by the POH algorithm may record these events on the blockchain as ERC 1155 NFTs after incurring a network fee, thereby enhancing the validity of the activity avatar and increasing their SCT rewards. When a road or event is recorded on the distributed ledger, it is held as an NFT in the user's wallet, along with the user's activity avatar and vehicle avatar.

Geo-tiles with a higher frequency of stored events on the blockchain tend to accrue greater value and credibility, which, in turn, elevates the value of the roads within them and enhances the available amenities to the road controller. The integration of roads and events onto the blockchain aims to confer exclusive data ownership of the geo-tile and the road to the road controller.

Each geo-tile is delineated, allowing precise characterization of each segment. These characteristics are detailed and include road type, length, traffic volume, data storage, user engagement, advertisement and campaign counts, and virtual passenger volumes.

This structured approach uniquely positions each geo-tile in the system, endowed with a specific geo-hash ID.

FIG. 1I Each block with different data as a layer (categorized).

FIG. 1J shows a high-level diagram 1000 that illustrates how warnings are generated by the AI engine 1006. The diagram 1000 shows the transportation metaverse server 102 that includes the database 202 with data from the geo-tiles and Road Event Report and an AI engine 1006 uses this data to be trained on and to make predictions. The system employs data from geo-tiles and roads along vehicle routes and destinations as inputs for an AI engine. This AI engine is capable of issuing alerts about potential animal presence, accident risks, or other relevant warnings.

The road safety device receives a message from the transportation metaverse server 102 to display the virtual road sign 1008, indicating that the AI Engine 1006 determined the data contributed to determining the virtual road sign 1008 should be displayed.

FIG. 1K: A process flow for a Road Safety Device: Point of Event Reporting and Asset Minting Process.

FIG. 1L: Block diagram for POH algorithm along with artificial intelligence engine.

FIG. 1M: Flowchart for function process of the Ranks in POH algorithm.

FIG. 1N: Flowchart for function process of the Rank X (mode X>Z) in POH algorithm.

FIG. 1O: Block diagram for the whole system function.

FIG. 1Q: Use Case Diagram for the Transportation Metaverse API

FIG. 1R: Block diagram of the Blockchain proxy Dapp to interface between the database of server and the blockchain platform.

Some definitions of terms used in this document.

A road event report may encompass a variety of incidents observed on or near roadways. This report can include anomalies such as unexpected road conditions or obstructions, as well as the presence of wildlife, specifically noting instances of animals directly on the road or in close proximity to it. Each report is designed to capture significant details about these events, which may assist in enhancing road safety by informing drivers through timely notifications based on the specific nature and location of the reported event.

Road Safety Device are physical devices and or an app running on a smartphone. The road safety device allow traveler userIDs to input data such as road events, traffic conditions, and safety hazards that are sent to the transportation metaverse server. The road safety device version 1 may be considered a kind of practical miner for vehicles, which has a completely different process and function from the prominent consensus algorithm minor proof-of-work cryptocurrency miners. Proof-of-work miners mine cryptocurrency by performing math calculations and do not bring any other use to its owner. But road safety device 112 as miner originates the Road Event Report and instead having to be added to the block after a mathematical con enhances the safety of drivers and passengers in the roads.

### Transportation Metaverse Server is

### POH Algorithm

Virtual Road Each virtual road is comprised of a set of geo-tiles, which can be bought and sold as NFTs.

Value of the road, this is a summation of the value of the set of geo-tiles that make up the road. For example a total of the value of the geo-tiles that make up the road.

Street map data provides electronic street data that includes information about roads, their features, and the surrounding environment. One possible source of such data is OpenStreetMap, a collaborative project that may create and maintain free, editable maps of the world. Street map data may include details such as road types, speed limits, road lengths and widths, road signs, cameras, fences, road lighting facilities, and ecosystem features like area types (residential, commercial, forest park, forest, agriculture, etc.), landscape, vegetation, water bodies, weather, animal species, and pollution levels.

A distributed ledger is a decentralized database consensually shared and synchronized across multiple nodes or participants within a network, where each maintains a copy of the ledger. Changes to the ledger are simultaneously reflected across all copies through a consensus mechanism, ensuring the ledger's transparency, immutability, and resistance to tampering. Blockchain, a well-known type of distributed ledger technology, is exemplified by its use in cryptocurrencies like Bitcoin and Ethereum but is also applicable to a range of other areas such as supply chain management, voting systems, and identity verification. Distributed ledger technology extends beyond blockchain, accommodating various platforms including Ethereum and its compatible blockchains, as well as non-blockchain platforms like Solana, which offers high-throughput solutions. These diverse technologies support the deployment of NFTs and highlight the flexibility of distributed ledgers in applications where decentralization is crucial.

Each UserID is associated with a user-type.

The first user-type is a “traveler.” A traveler userID corresponds to users who travel on the roads and streets. For example, drivers of motor vehicles, including passenger cars, motorcycles, heavy-weight vehicles, trucks and public vehicles, ambulances, fire trucks, school buses, etc. But the traveler userID may also be used by bicycle and scooter riders; passengers of private and public vehicles, pedestrians, disabled, elderly and children, etc.; users of navigation Apps (smartphone and car display).

Traveler userIDs may use the transportation metaverse system services using various road safety devices or smartphone Apps.

The second user-type is a “virtual road controller.” Virtual road controller userIDs can connect to the transportation metaverse system and using a private cryptographic key, typically from a cryptographic wallet, and are able to view and take ownership of virtual roads. The virtual road controller UserID by the virtual road's connect to the real world roads and, by using the transportation metaverse system options, enhance road safety, monitor and mitigate accidents and damages, and gain SCT rewards based on the POH algorithm.

Virtual road controller userIDs can gain SCT rewards through various means, such as a part of the reward (SCT) of traveler userIDs who travel on the roads and gain SCT based on the POH algorithm; a part of the road reward from advertising (on smartphone, road safety devices, and the transportation metaverse); a part of the road reward from campaign activities; a part of the reward of virtual transportation services; a part of the paid traffic tickets on the roads; and reward from increase in road value.

Virtual road controller userIDs can activate or deactivate the display of advertisements on the virtual roads they control.

The third user-type is a “virtual traveler.” Using Virtual Reality (VR) headsets, virtual traveler userIDs can connect to virtual transportation metaverse taxis (equipped with 360-degree cameras) on desired routes. They can experience a real journey in the transportation metaverse environment and communicate with other virtual travelers or transportation metaverse tour leaders, enjoying a virtual trip thousands of miles away.

The fourth user-type is an “advertiser.” Advertiser userIDs, representing businesses and companies, can display targeted advertisements to traveler userIDs on specific roads or desired areas. These advertisements may be displayed in smartphone apps, on road safety device displays, and in virtual taxis streams. The advertising tariff may be determined based on the value of multiple geo-tiles of the target virtual road. The costs for the advertisements may be paid using SCT. Advertisements may only displayed when the vehicle stops for more than 5 seconds. Advertiser userIDs can also distribute conditional NFTs to targeted traveler userIDs, offering different prices or conditions for their services. Rewards from advertisements are shared among virtual road controller and traveler userIDs based on the POH algorithm. Some of the rewards from advertisements may returned to the transportation metaverse system treasury.

The fifth user-type is a “campaign creator.” Campaign creator userIDs, including individuals, groups, private organizations, and government agencies, can create campaigns on specific virtual roads for various purposes. The cost of creating a campaign may be calculated based various factors for example: the type of campaign, the features of the road blocks, the area covered, the results obtained or other factors. Campaign costs may be paid using SCT. These campaigns enable the collection of decentralized and transparent data (without violating user privacy), and the rewards of traveler userIDs in the campaign-covered blocks are increased. Rewards may be shared among traveler and virtual road controller userIDs, and a portion may be allocated to the system's treasury. Campaign creator userIDs can create various types of campaigns, such as data collection campaigns to extract data for research or diagnostics related to roads and the environment; marketing campaigns to identify potential customers and send them conditional NFTs, allowing them to use the services and products of the company; warning campaigns to notify traveler userIDs of general hazards or complications on specific roads; pollution mitigation campaigns to encourage traveler userIDs to reduce vehicle emissions or switch to electric vehicles; virtual tourism campaigns to charge virtual traveler userIDs for access to specific areas or events or to encourage the use of real-world tours and services; and environmental campaigns to identify and mark various types of environmental pollution and reward traveler userIDs for their contributions.

The sixth user-type is an “environmental contributor.” Environmental contributor userIDs can share locations or points of various environmental pollution, which can be viewed by other users, followers, or subscribers after validation by the POH algorithm. These pollutants include all kinds of visible environmental pollution, such as residual pollution, water pollution, and visual pollution.

The road safety device 112 may come in different version, which are designed for different usage scenarios. A car road safety device, aka version 1, is intended for drivers of motor vehicles. A bike road safety device, aka version 2, is intended for riders of motorcycle, scooter, bikes riders and similar vehicles. And a walker road safety device, aka version 3.

FIG. 1S shows the road safety device main board (FIG. 1S, No. 1) and the graphical user interface (gui) (FIG. 1S, No 2). Additionally, the figure includes a camera unit (FIG. 1S, No. 3), a gas pedal pad (FIG. 1S, No. 4), a safety alarm bracelet (FIG. 1S, No 5), and a smartphone (FIG. 1S, No 6). The car road safety device connects to a vehicle. The car road safety device may connections (wired or wirelessly) between the components that make up the road safety device, for example the Graphical User Interface (GUI) component and the mainboard. The GUI component may be placed on the steering wheel of a vehicle or motorcycle or any other place in the car that is suitable for driver to see and touch (FIG. 1S, No. 2).

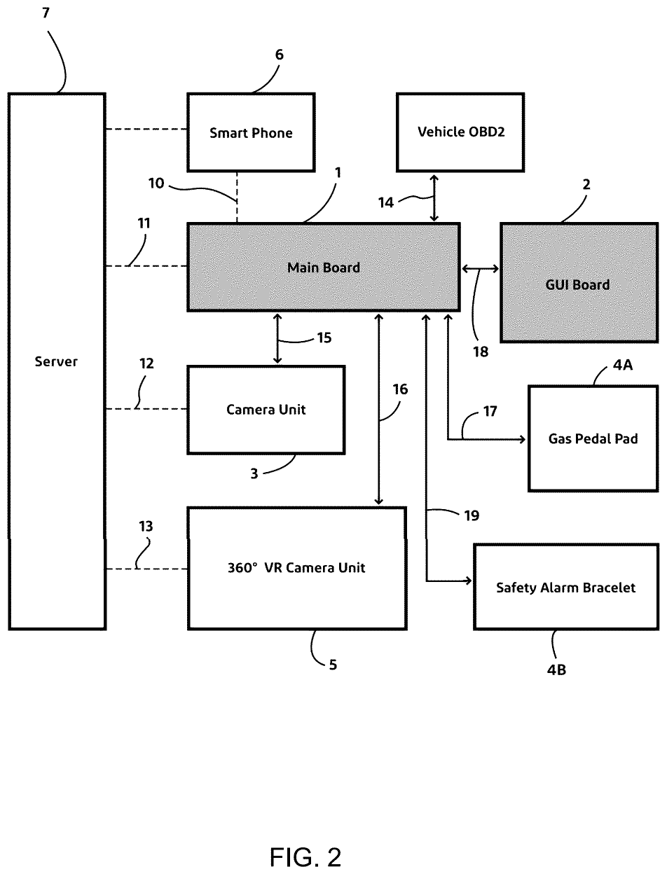

FIG. 2 depicts a block diagram of a car road safety devices and includes two main parts and three peripheral parts and to additional parts. The two main parts are the mainboard (FIG. 2, No. 1) and the Graphical User Interface, GUI component (FIG. 2, No. 2), that include physical buttons. The three peripheral parts include a camera peripheral unit (FIG. 2, No. 3); a vibrating alarm, either in the form of a gas pedal pad (FIG. 2, No. 4A) for cars, or a safety alarm bracelets (FIG. 2, No. 4B) for motorcycles, bicycles and scooters; and a Peripheral units of 360-degree virtual reality camera (FIG. 2, No. 5). In addition, two other parts are shown connected to the system first Smartphone and Apps (FIG. 2, No. 6) and second a Server (FIG. 2, No. 7) peripheral units,

The road safety device may have the capability to connect to a smartphones and other

The Mainboard (FIG. 2, No. 1) is the main processor of the road safety device 112. The mainboard (FIG. 2, No. 1) is made up of various parts and circuits, which works based on the POH algorithm. In addition to data processing, calculations and transmission, it provides functional features needed for the vehicle drivers. Some of these services (functional features) are provided to users using the second main part of the system (GUI road safety device).

A-2: Graphical User Interface (GUI Road Safety Device) with Physical Buttons (FIG. 2, No. 2)

One of the important purposes of designing GUI road safety device for this system is to create a simple way with no risk for drivers to report road events (incident, anomaly) without distraction and time-consuming steps and always observe them at the right time. The GUI part of road safety device version 1 provides the driver to report road events (incident, anomaly) without getting on the time consuming and risky steps and without using smartphone display and car display (Car-Play and Android-Auto, or Car-2-X of Mercedes Benz and etc.). In the other hand the GUI road safety device version 1 is always available to the driver to observe and report road events (incident, anomaly), to do this, unlike common navigation apps, there is no need to see the app screen on the smartphone or car display and unlike some navigation apps, there is no need to select a destination route to observe or report a road event (incident, anomaly), so it is always ready as a proper assistant to announce the events or hazard to drivers at the right time.

The GUI road safety device is placed on the steering wheel or a proper place in the vehicle and is always accessible for the driver to announce road events (incidents or anomalies). Fulfilling this, the round display and Lighting LED around it and a buzzer are used.

In the other hand, the GUI road safety device with a microphone and physical buttons and a three-mode round touch (The user uses it to specify the left, right or middle side of the reported road event) enable the driver to report the events in detail without any distractions or any risk.

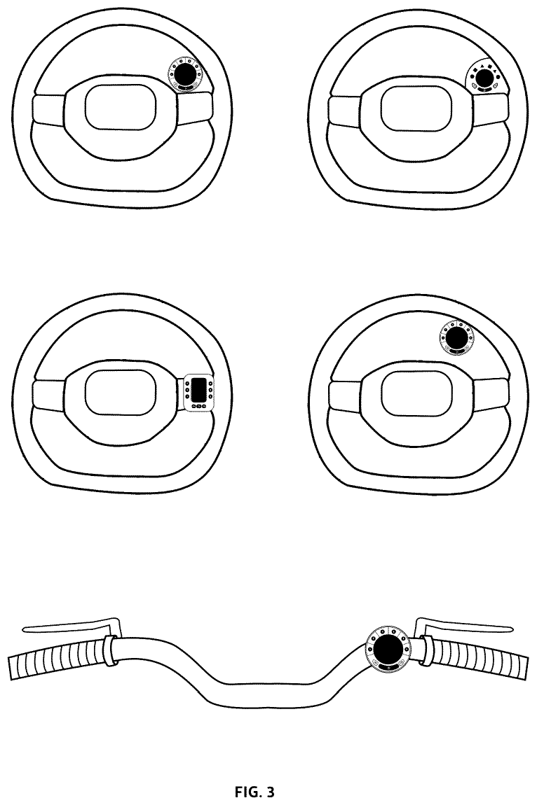

Wireless connections are used to transfer data between GUI road safety device and other parts of the system, so that this GUI road safety device is easily placed on the steering wheel of the vehicles and motorcycle or in a proper place in the vehicle. (FIG. 3)

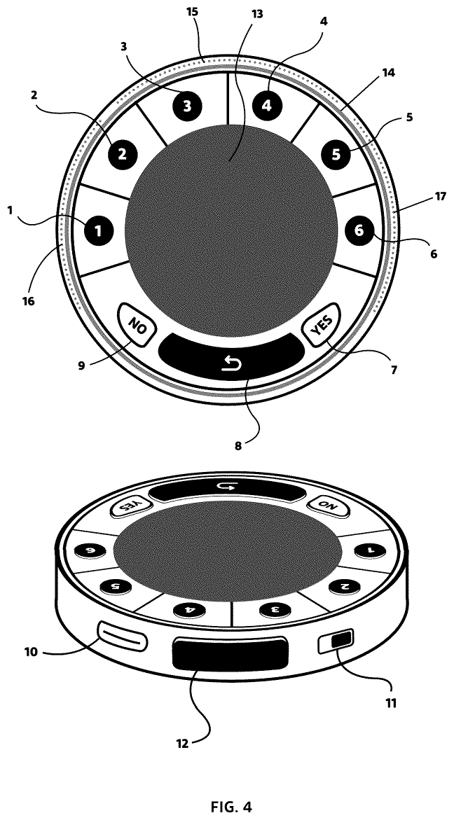

The appearance of the GUI road safety device is depicted in (FIG. 4), No. 1,2,3,4,5,6 are physical buttons for reporting road events, No. 7 (Yes button) for approving a road event, No. 8 (Return button) is for displaying other road events No. 9 (No button) is for rejecting road event, No. 10 is charge connector, No. 11 is the on/off button, No. 12 is emergency button, No. 13 is a round display, No. 14 is multi-color LEDs which are placed under the strip touch around the road safety device. This multi-color LED is additional warning feature that are used to notify the driver in various situations and also used as a guide to show the direction of the located road event. These LEDs are arranged in a circle and divided into 4 equal parts, each of these parts demonstrate the direction of the road event (left-right-middle-rear). After a road event is being reported by the user pressing a physical button, in some cases it is necessary for the user to specify the direction of the road event (left-right-center). In order to not distracting the user and determining the direction of the road event in a short time, the LEDs under the touch strip (in Equal Part) are lit in 3 colors to guide easily the user to choose proper part of the touch (right, left or middle) relating to side of road event., No. 15, 16, 17 is strip touch around the road safety device, which users by touching each side of this strip touch will add the direction (side) of located road event to their report (NO. 15—middle side-No. 17—right side-No. 16—left side).

Traveler UserID may report categorized road events with minimal distraction without interacting with the display of smartphone or car display (Car-Play, Android-Auto, etc.).

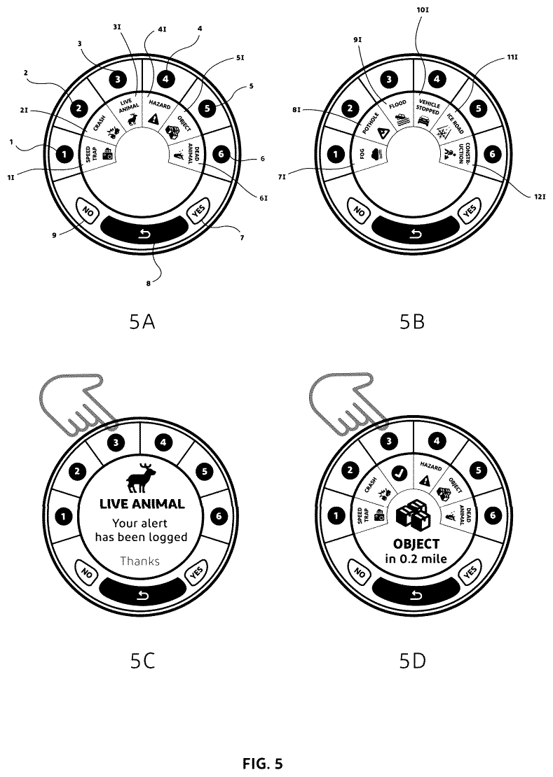

By pressing one of the physical buttons (1, 2, 3, 4, 5, 6) in (FIG. 5 (5A)), a road event will be reported by the driver. By pressing button 8 in (FIG. 5 (5A)), the screen turns to FIG. 5 (5B) where more other road events are located. After a road event is reported, the buzzer of the road safety device beeps a short sound, if there is no warning or hazard to display, “sent report confirmed successfully” is displayed for 3 seconds (FIG. 5 (5C)). If there is a hazard or a road event to display, only a tick mark will appear on the reported road event icon (FIG. 5 (5D)), then the driver will be informed of successful reported road event by hearing the beep sound of buzzer.

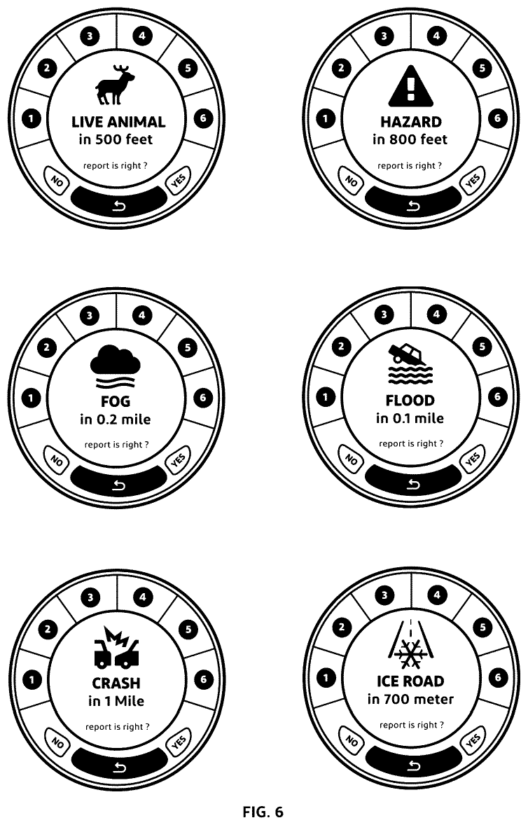

As it is depicted in (FIG. 5 (5A)), the numbers 1I, 2I, 3I, 4I, 5I, 6I are user guide icons for physical buttons that are displayed near them. Despite the fact that the users can change the layout of the icons from the setting menu, the road event icons are designed in a such a way that to be moved automatically to the main page, when necessary, based on the conditions and road needs so that the users do not need to press button No. 8 as much as possible (FIG. 4, No. 8). For example, in an area where there are many reports of ice road in the winter season, the system moves “ICE ROAD” icon to the main page on the display by checking the different conditions so that it is easier for the users to access it, but in normal conditions the default icons are displayed. FIG. 6 depicts various modes of road event (incidents or anomalies) reported by other drivers. The YES and NO buttons are for approving or rejecting road event reported by other users or automatic detection system of advanced camera peripheral unit.

In addition to displaying road events and other warning through the screen of GUI road safety device version 1, the GUI road safety device capabilities provide other ways to inform the drivers in various situations, which are as follows:
1—The strip LEDs around the GUI road safety device version 1
2—Buzzer warning sound
3—Through the speaker or headset connected to the road safety device
4—Vibrating warning via the Gas pedal pad in car or via Safety Alarm for motorcycle

This type of announcement can be used in combination by evaluating the said conditions and level of dangers of road event ahead. The difference in the type of warning in various conditions makes the driver more sensitive to the categorized warnings, and notices them even without looking at the screen. Thus, the announcement of road events or other warning in navigations apps by using this road safety device are more useful and distract the driver less, and the chance of informing the driver of hazard will be increased. The combination of announcements to the drivers can be changed in different conditions, such as level of the road event dangerousness, validation rank of the reported event, type of road, speed limit, type of behavior of the driver in the last 15 minutes, weather conditions, type of vehicle, and distance to the road event.

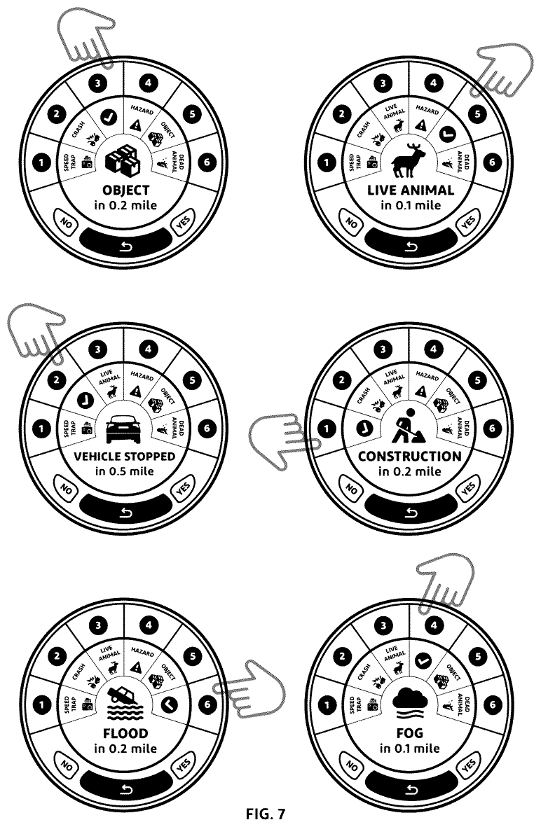

Sometimes, while users are informed of a road event or hazard on the display of the road safety device, they may report a new road event simultaneously. These modes are depicted in FIG. 7.

By pressing a single button, the driver reports a road event and at the same time the camera peripheral unit automatically takes a photo of road event. In some situations, or dangerous cases, the driver may feel it necessary to provide more explanations about the road event so that other drivers will be more aware of it, and the driver can press a report button for more than 3 seconds to add 6 seconds voice to the road event report, Numbers 1, 2, 3, 4, 5, 6 in (FIG. 5 (5A)).

The system evaluates the report and inform other users of the same road if necessary. for example:
“There is a pit on the right side of the road which is hard to see”
“lots of deer on the left side of the road among the trees”
“Falling Rock from the mountain, stop!”
“Children are playing on the right sides of the street, be careful”

In order to the sounds played from the speaker not to be annoying, all of the sounds are filtered. In fact, all the voices which are added by the users at the time of reporting road events, do not notified to the other users. All filters are done in the system using following items:

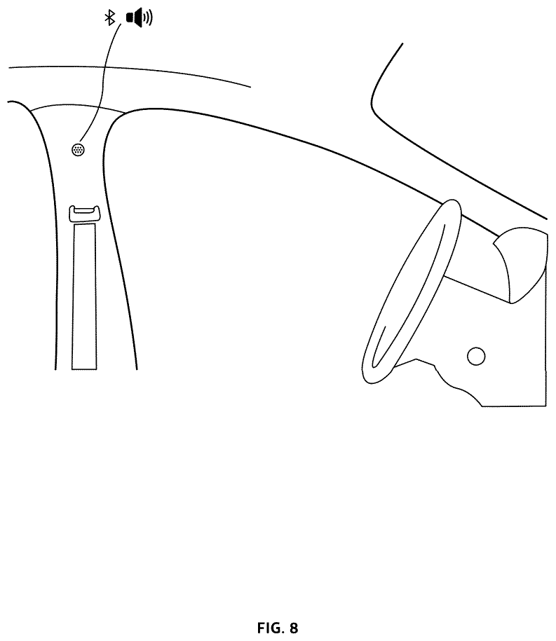

The dangerousness level of the road event, the validity of the avatar which is reporter, the validity of the road event, the distance of users to the road event, and the features of road geo-tiles like speed limit, weather conditions, etc. This 6-second voice is played through the small and wireless speaker of the road safety device. To hear this voice in motorcycle the users can connect a headset to the road safety device or use the speaker of the road safety device. To hear this voice in the car the speaker can be placed at the pillar next to the driver (FIG. 8) of course, the road safety device's audio system has capability to connect to the vehicle's Bluetooth, but considering that the driver may be listening to music or a radio station, and preventing the music from being disconnected and connected over times, and also to avoid annoying the passengers of taxi, this speaker is a proper alternative, so just the driver hears the sound by adjusting its volume.

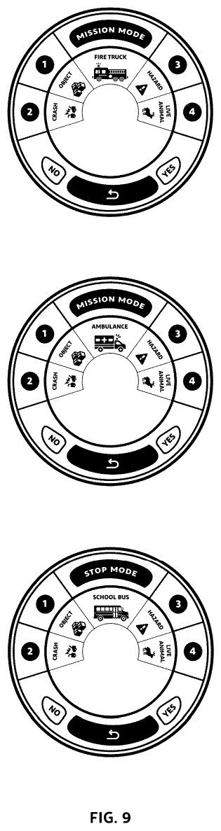

The appearance of GUI road safety device is a little bit different in some vehicles such as fire trucks, ambulances and school buses (FIG. 9).

### B: Peripheral Units of the System

The peripheral units can be connected to the road safety device version 1. It is designed in such a way that for using the main feature of system is not necessary to connect peripheral units to the main road safety device, but by adding them, more features will be accessible for user.

By adding each peripheral unit the amount of SCT reward potentially will increase based on the POH algorithm.

For example, there are embedded dash-cam in some vehicles, thus it is not logical to buy peripheral camera unit. the road safety device in such a way that it has the capability to connect to the various types of dash-cams in the vehicles. The user can use the more features by connecting dash-came to the main road safety device so there is no need to buy peripheral camera unit.

As it is depicted in the block diagram (FIG. 2), No. 3, 4A, 4B, and No. 5 are peripheral units.

### Functions of Each Peripheral Unit.

### B-1: Camera Peripheral Unit (FIG. 2, No. 3)

This peripheral unit adds various automatic functions to the system, including taking photos of road events, detection of some road events to notify drivers. But access to all these features depends on the type of Camera peripheral unit that is connected to the main road safety device version 1.

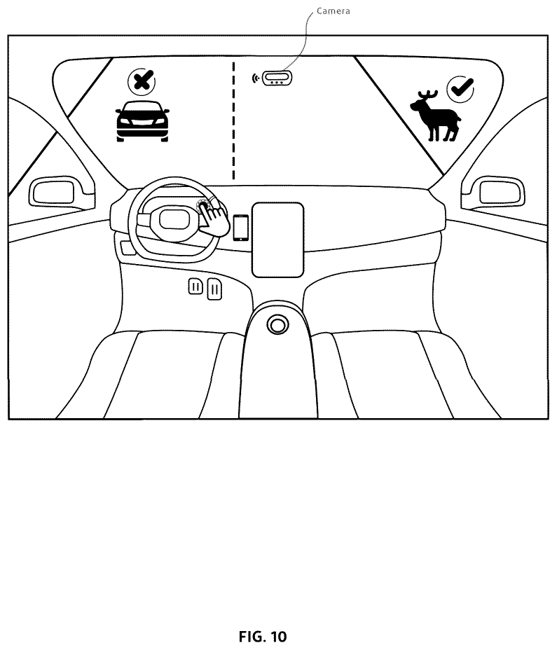

By pressing a single physical button associated with the road event on the GUI road safety device, the camera unit is automatically activated to detect and match road events, and if necessary, takes photos, logs and sends them to the server. It is not necessary to take photos and match images of all road events because it is done based on the priorities and goals of the system. For example, in our system if the driver wants to report an animal on the shoulder, a photo is taken automatically. In addition to sending the proper image to the server for storage and image processing (FIG. 10).

It helps us to gather proper data from animals, and the systems artificial intelligence AI engine has more inputs to predict animal presence in the road ahead.

For example, the connection of two versions of the peripheral unit of the camera to the main road safety device version 1 which are very similar to the car dash-cam, will be covered in the following:

### B1-1: Camera Unit (Basic) Version 1

In this version, while maintaining the production cost low, the expected performance of the camera peripheral unit is fulfilled. This version is capable of taking photos automatically of the road events, initial matching and sending images to the server. This version does not have capability to identify road event automatically, but by pressing the single physical button on the GUI road safety device to report a road event, the camera unit is activated automatically to identify and take a proper image of a road events, and after matching, it will be stored.

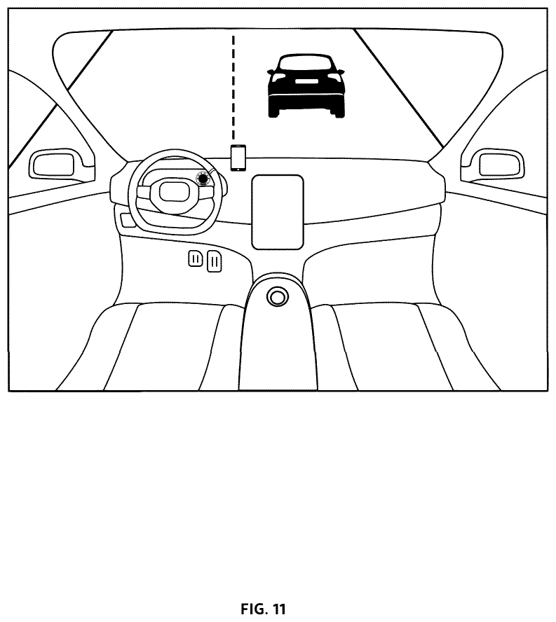

Users who have smartphones with good camera quality also can use their smartphones instead of the Camera peripheral unit of this version. It is enough to place the smartphone on the holder of the dashboard in such a way that it is calibrated with the road (FIG. 11). Then the smartphone camera does the same jobs like Camera peripheral unit and taking photo without the driver intervention and without displaying it on the smartphone screen.

### B1-2: Camera Unit (Advanced) Version 2

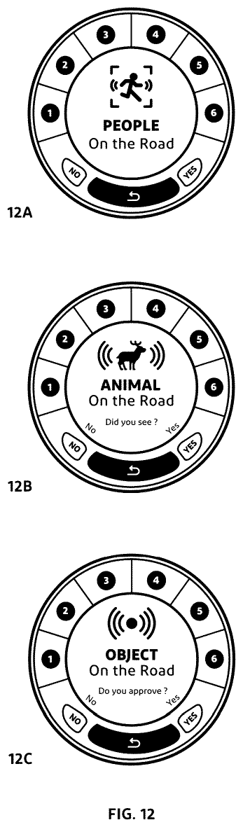

For this version of the peripheral camera unit, NVidia Jetson Nano hardware with higher processing power and AI core, is preferred. Compared to the basic version it is expensive. By connecting advanced version to the main road safety device, in addition to providing the tasks of the peripheral basic camera unit, such as taking photo automatically and initial matching and etc. it also adds capability of automatic detection of road events and abnormal obstacles ahead of drivers to the system, these road event which have been detected automatically are immediately announced as notification to the driver using GUI (FIG. 12). Some road events are transient such as the sudden presence of a pedestrian ahead of the driver (FIG. 12, No. 12A), this kind of road event momentarily announced to the driver, and do not need to be reported as road event, but some of these automatic road event detections are not transient such as the presence of an animal on the shoulder or an object in the middle of the road and has potentiality to make dangerous situation for other drivers on the road. In these cases, in addition to notifying the driver, a report of road event is sent to the other drivers in same route. In some cases, reporting these road events to the other drivers requires a confirmation from the driver just by pressing the YES button (FIG. 4, No. 7) on the GUI road safety device (FIG. 12, 12B, 12C).

This interaction between the user and the road safety device makes artificial intelligence engine learning to be developed and the system's artificial intelligence gets a better understanding of reportable and dangerous road event and reports them without the driver's intervention over time.

### B-2-1: Gas Pedal Pad (FIG. 2, No. 4A) for Vehicles

### B-2: Vibrating Alarm

This peripheral unit which is installed on the gas pedal of the vehicle is used as vibrating warning notifier for dangerous road events or situations.

### B-3: 3D VR Camera Peripheral Unit (FIG. 2, No. 5)

Connecting this peripheral unit to the road safety device, the feature will be accessible to owner of the vehicle to give virtual rides to the virtual traveler UserID in the Transportation metaverse, so the virtual traveler UserID can request a virtual ride in desired route (from an origin to a destination). When a virtual ride request is accepted by a traveler UserID whose avatars are in Transportation metaverse, the virtual travel UserID starts receiving a video stream (preferable a 3D virtual reality video stream) the virtual traveler UserID may provide this video stream in a VR headset. In addition to the video stream, the system may allow the virtual traveler UserID to have fun with mini-games and enter special areas for virtual travelers and use social networks. The traveler UserID's private key may get additional SCT reward based on distance and value of the road traveled.

### B-2-2: Safety Alarm Bracelets (FIG. 2, No. 4B) for Motorcycles, Bicycles and Scooters

This peripheral unit is a bracelet designed for motorcycle, scooter and bicycle riders, and it is used to vibration warning announcement for dangerous road events or situations.

### 2—Taking Photo of Road Events Automatically

By pressing a single physical button associated with the road event on the GUI road safety device, the camera unit is automatically activated to take a proper photo of the road event and may do initial matching before sending to the transportation metaverse server. Also, if the road safety device connects to the advanced version of the camera unit, it performs the usual tasks of the camera unit and in addition to the performed tasks, doing automatic detecting and reporting of some road events.

### General Description of the Road Safety Device Version 1

By connecting the main road safety device to the vehicle using the OBD2 port, two avatars are created for the user as NFT on the smartphone app. The first avatar is for vehicle, which is created automatically according to data extraction from the vehicle based on the parameters of the brand, model and function of the Vehicle also some question be asked from user and will be matched with the extracted data from the vehicle.

Motor vehicles may be categorized into various types for example: Hatchback, Sedan, SUV, MUV, Coupe, Convertible, and Pickup Truck, flatbed trucks, ambulances, taxi, fire truck, bus, school bus, motorcycle etc., and avatar appearance is created based on type of vehicles, also the avatar can be customized by the owner.

The second avatar is user activity avatar which is associated with the driver, and will be created by the user.

The rating and validity of the vehicle avatar are calculated based on POH algorithm, one of the important parameters in this algorithm is the vehicle emission level. The vehicle emissions level depends on many dynamic and static parameters, including engine condition level, factors as fuel formulation, air-fuel ratio, ignition timing, compression ratio, engine speed and load, engine deposits, coolant temperature, and combustion chamber configuration and also driving style has a significant impact on emissions than traffic conditions based on these parameters the road safety device helps the system to evaluate the emission level index per mile for each vehicle by receiving the necessary vehicle data using the OBD2 port and performing the necessary calculations.

The emission level index per mile is calculated, and the vehicle faults to be fixed to decrease the pollution emission level then will be announce to the driver. This way the rank of emission level for the vehicle avatar is always up to date in The transportation metaverse and will be ranked. The position of the vehicle avatar in this ranking is one of the influencing parameters in the POH algorithm and affects the SCT reward.

The POH algorithm may us a distributed ledger to distribute the amount of SCT rewards

The POH algorithm calculation of the SCT reward may depends on various parameters that the system calculates, some of them are as follows:

Type of road safety device connected to the vehicle, type of vehicle, type of fuel, level of emissions, type of user, peripheral parts connected to the main road safety device, validity of vehicle avatar and user activity avatar, records of avatars, acceptable driver behavior, level of compliance with driving rules, type of road event reports sent, validity rank of reports, quantity and quality of systematic activities, road network price (multiple geo-tiles of roads price) which the activity of user is recorded there, The amount of campaigns and advertisements on the roads that the user has passed through, the distance traveled by avatars, type of NFTs available to the driver user activity avatar and vehicle avatar, validity of user cryptocurrency wallet (SCT transactions and amount of SCT staked), impact of user activities in order to help to increase safety of roads, and reducing accidents and environmental damage. The user activity avatar also has a virtual driver's license in which the points and virtual traffic tickets of the drivers are recorded.

Using the system app on smartphone, the users can adjust the road safety device internet connection settings, access their wallet, and check their traveled routes and rank of their activity and the SCT reward. The user can also take advantage of system suggestion to get more SCT reward, and they can buy items for vehicle avatar or driver avatar as NFT from the marketplace to increase their avatars validity and subsequent SCT rewards.

The user can activate the display for 5-second ads on their GUI road safety device so that they can observe the ads when the vehicle is stopped and get some SCT as reward. User can pay their avatar's virtual traffic tickets. They can find active campaigns near to their location and join them.

### The Function and Features Provided by the Road Safety Device Version 1 for the Drivers of Motor Vehicles

1—Reporting Road Events Manually with Minimal Distraction and Low Risk and Increasing Chance of Observing them at the Right Time by the Driver.

One of the important purposes of GUI road safety device design for this system is to create a simple way with low risk for drivers to report road events (incident, anomaly) with low distraction and in a time efficient process with minimal steps and increase the chance to observe them at the right time. The GUI road safety device of version 1 enables the driver to report road events (incident, anomaly) without getting pulling up a reporting app on a smartphone, which can be time consuming and risky as it can distract from the task of driving safely. Reporting apps on a smart phone for example may be Car-Play and Android-Auto systems, and others. In comparison to the smartphone reporting App the road safety device is always available to the driver to observe and report road events (incident, anomaly), to do this, unlike common navigation apps, there is no need to see the navigation app screen on the smartphone or car display and unlike some navigation apps, there is no need to select a destination route to observe or report a road event (incident, anomaly), so it is always ready as a proper assistant to announce to drivers the events (incident, anomaly) or hazard at the right time. In addition, the road safety device provides the ability to report details of the road event automatically without driver intervention.

Also, the road safety device may report a hazard automatically when the vehicle suddenly stops, suddenly changes direction, or is at an abnormal angle to the road. When this situation is detected the peripheral camera unit may take a photo of road and the photo may be evaluated for road conditions and hazard. The photo can be sent to the server without the user interaction.

### 3—Taking Advantage of Smart Animal Crossing Occasional Warning Signs Feature of System in Vehicle

The road safety device may receive interactions from the user about the presence of an animal for example on the shoulder or in the middle of the road. The user can report about these animals so other drivers will be aware of the risk. The animal report from the road safety device may be sent to a public distributed ledger (e.g. Blockchain) where an algorithm along with artificial intelligence engine may create a virtual road warning sign.

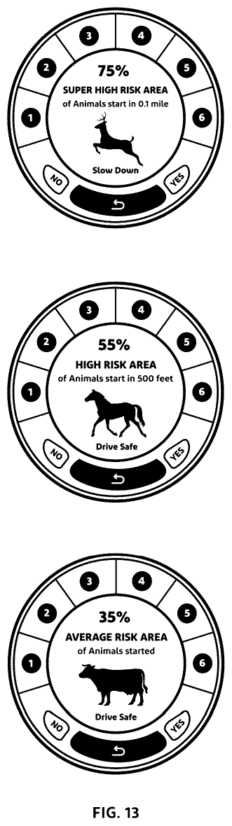

The virtual road warning sign may be an animal crossing road signs. By analyzing various variables in the road made these signs smart to predict the chance of animal presence in the road ahead of the driver. Finally, using GUI road safety device or other electronic road safety devices like smartphones or vehicle display, and etc. the system may announce the virtual road warning sign, for example a smart animal crossing warnings (FIG. 13).

### 4—Display Necessary Road Warning

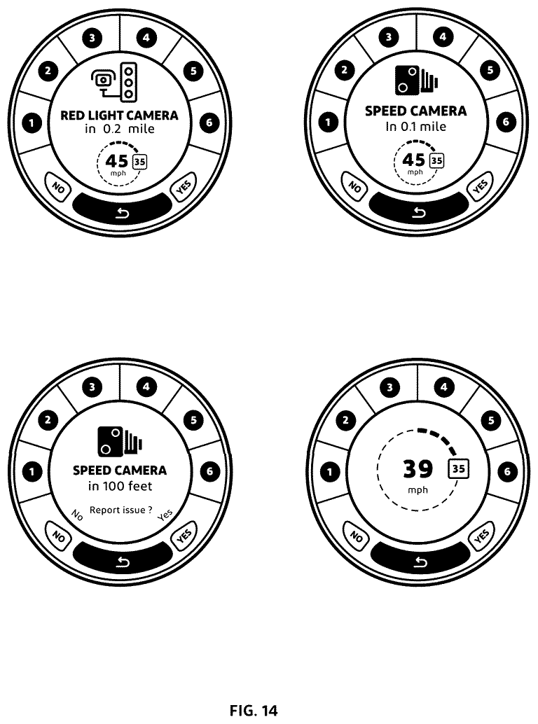

Displaying the road speed limit, speed limit cameras and traffic light cameras (optional) (FIG. 14)

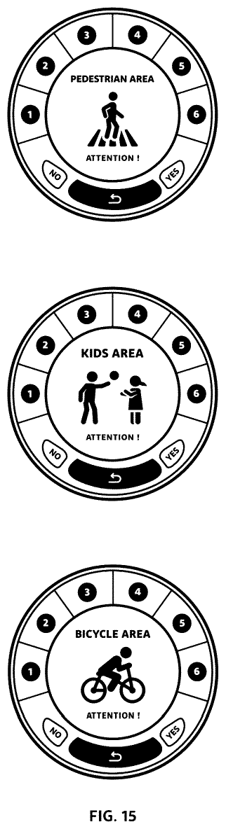

Notifying the users about high-risk area where colliding with pedestrians or children and cyclists is probable based on time and road conditions and road records (FIG. 15).

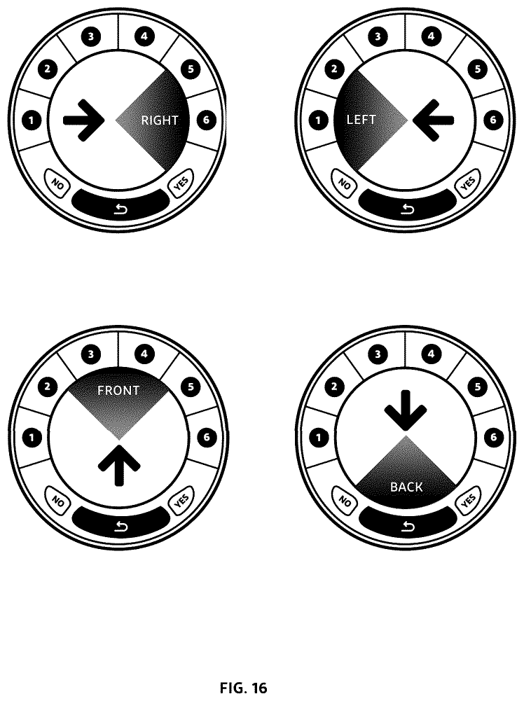

### 5—Notifying a Probable Accident (FIG. 16)

This road safety device may send vehicle data like speed, direction of movement, angle of movement and location to the transportation metaverse server every 50 milliseconds. The system may then make calculations derived from this data, and if high probability of collision is determined then an announce or warning may be made to the involved vehicles. Ideal this warning can be provided a few seconds earlier the impending possible collision. For example, a probable collision at an intersection among two or more vehicle heading to that intersection from different direction may trigger an announcing a warning like a hard braking warning. This warning may be given to road safety devices in vehicles behind the one pending collision since they may also be at risk of rear-end collision with the lead vehicle at risk. The warning may be issued on the road safety device for vehicles in dangerous situation

To allow drivers adequate time to respond, the road safety device may issue alerts rapidly, ideally within milliseconds. This enables drivers to react to potential hazards effectively. In such situations, the device may not only display the direction of the road event on the graphical user interface (GUI) but also activate auditory cues like a buzzer. Additionally, the GUI may light up LEDs corresponding to the hazard's direction, and the system may engage other alert mechanisms, such as the speaker and a gas pedal pad warning, to enhance driver awareness and safety.

In addition to data transmission via the Internet, the road safety device may be capable of adding a radio section according to the frequency range of different countries to communicate without the Internet to traffic infrastructures such as traffic lights, local networks and DSRC (Dedicated Short Range Communications) infrastructures and other vehicles. But in this version, the system has omitted it to mitigate the costs. As an example, the frequency standard of the United States is specified by the IEEE 802.11p DSRC Channel Frequency Band Standard and includes channels range from 5.855 GHz to 5.925 GHz, commonly referred to as the “5.9 GHZ band”. The spectrum is further subdivided into 10 MHz channels.

6—for More Safety this System Informs the Drivers about Presence of Vehicle on Mission or School Buses Dropping Off or Picking Up Children

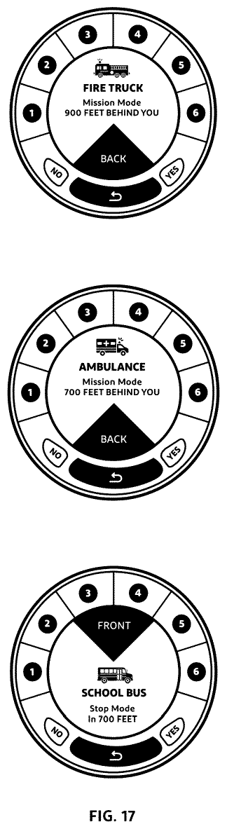

This system informs the drivers of the presence of a vehicle on a mission, such as a fire truck or an ambulance (before hearing the sound of the siren), along with the direction of the vehicle on the mission. (FIG. 17)

This system also informs the drivers of that route when the school bus is stopping to pick up and drop off children. (FIG. 17)

### 7—the System Evaluates the Emission Level Index Per Mile for Each Vehicle

The emission level index per mile is calculated, and the vehicle faults have to be fixed to decrease the pollution emission level then will be announce to the driver

### 8—Earning SCT Rewards by Participating in the Exclusive Method of the System

Earning SCT in the system based on road and Blockchain in accordance with the system method and POH algorithm.

### 9—Earning SCT for Virtual Taxi

Earning SCT for vehicles equipped with a 360-degree virtual reality camera peripheral unit via virtual passengers in The transportation metaverse.

The SCT reward system, includes hardware road safety devices, software, algorithms, a distributed ledger and other aspects of the transportation metaverse.

### Description for the Design of the Road Safety Device Version 1 and its Components

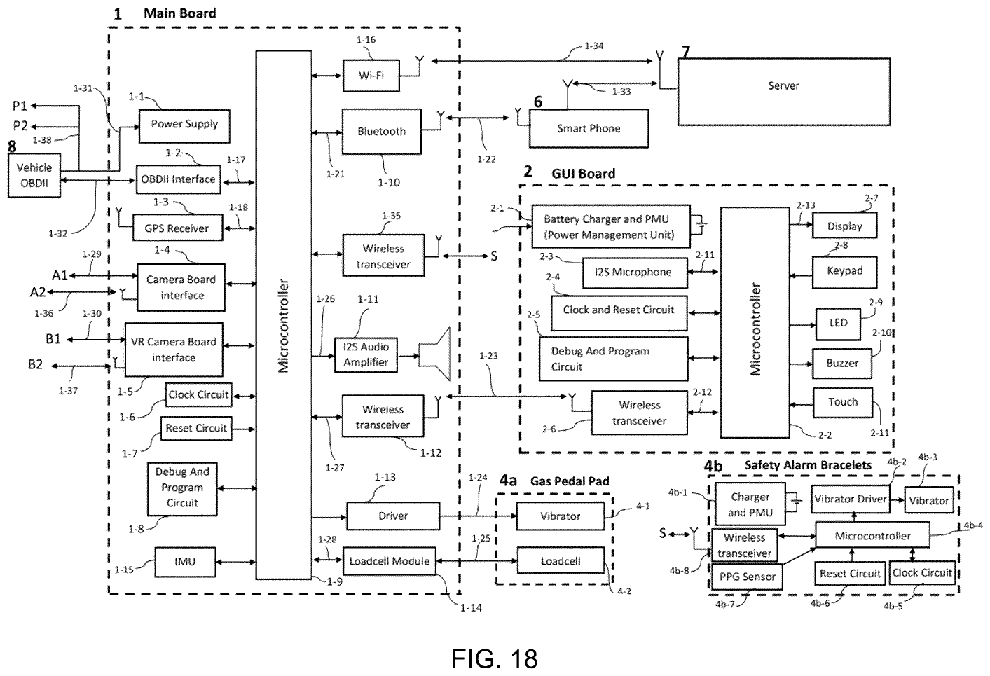

### The Mainboard of Processor and Control (FIG. 18, No. 1)

The mainboard of the road safety device works based on the POH consensus algorithm, which will be described in detail in the system architecture and software engineering section. The mainboard deals with processing data, calculations and transferring data. In addition, using GUI road safety device and other peripheral units, it provides practical and useful features for the safety of users in the roads. These functional features are described in the previous paragraphs. The block diagram and electronic components of the mainboard are displayed in (FIG. 18, No. 1).

A microcontroller like STM32F429ZGT6 with an ARM Cortex-M4 core may be used in the mainboard. The microcontroller controls and coordinates all function of electronic components in the main board. In order to benefit from the maximum performance of the processor and high response speed, no operating system has been used to launch the circuit, it has been programmed using C language in the IAR IDE. The mainboard connects wirelessly with the GUI road safety device (FIG. 18, No. 2) using route 1-23.

The mainboard may be connected to the motor vehicle, for example using the OBDII port (FIG. 18, No. 8) and the microcontroller may collect the necessary data through the port (FIG. 18, route 1-32) then send data to the server after being processed by the microcontroller. This circuit may communicate with the server in two ways. The performance of the road safety device m slightly different for each mode.

### Modes for the Performance of the Road Safety Device Version 1

### 1—First Mode

When the road safety device accesses Wi-Fi or hotspot in the vehicle, the road safety road safety device connects directly to the transportation metaverse server using the Wi-Fi (FIG. 18, No. 1-16 and route 1-34) to transmit data. In this case, the road safety road safety device may work without the need for a smartphone. road safety device. To achieve this, independence from the smartphone the mainboard is equipped with various components and sensors such as IMU (FIG. 18, No. 1-15) and GPS (FIG. 18, No. 1-3) and other electronic components. These electronic components along with GPS, aid the road safety device to send navigation data such as location, speed, angle of movement, etc. to the server without using a smartphone.

Although the road safety device version 1 is capable of providing all function to the user without the smartphone, the user needs a smartphone or computer at first to setup and create an account and avatar. To set up the road safety device, the user must connect the smartphone to the road safety device for example by Bluetooth. After the setup is done, the road safety device can work independently and there is no need to connect the app on the smartphone road safety device. In order to, the users access to the road safety device setting, marketplace and other information, they have to use system mobile app.

### 2—the Second Mode

This mode may be used when the road safety device does not access to Wi-Fi. In this mode, communicating with the server is done by connecting the road safety device to the smartphone for example through Bluetooth (FIG. 18, No. 1-10).

In this mode, connection to the server is done using the route (FIG. 18, No. 1-22 and 1-33)

The related data to location, movement and acceleration, etc. which were provided in the first mode through electronic components and sensors embedded in the road safety device version 1, are provided through the smartphone so that a smaller amount of data is transmitted through Bluetooth.

In the second mode, as necessary, to evaluate users' data like location and movement load acceleration, etc., validation done by matching the data of road safety device version 1 sensors and similar sensors in the smartphone. This step is always performed to evaluate the validity of events reported by the users which will be described in the System architecture and software engineering section in detail.

The schematic diagram designed for FIG. 18 No. 1 is the Mainboard.

### The Main Processor and Control Board

### Power Supply (FIG. 18, No. 1-1)

This electronic components supplies voltage for all parts of unit No. 1 (Mainboard 18 No. 1).

This circuit receives the input voltage in the range of 9V to 15V from the OBD2 port of the vehicle and supplies the +5V, +3.3V voltages required by the microcontroller circuit, and various parts of the mainboard (FIG. 18, No. 1) and it also is supplying voltage of the Gas Pedal Pad peripheral unit (FIG. 18, No. 4a).

The power supply in this circuit has Over Voltage, Reverse Polarity and Overcurrent protection to protect the microcontroller and other components from any faults.

### OBD2 Interface (FIG. 18 No. 1-2)

This part of the circuit is designed using the ELM327 module. It communicates with vehicles using OBD2 sockets using a serial connection (FIG. 18 No. 1-17) with the microcontroller. In this way, to read any type of data, the relevant ID Code is sent using the microcontroller and serial connection then response is received. For example, to read the value of engine speed, the 0c hex pad is used.

### GPS Receiver (FIG. 18 No. 1-3)

An Ublox NEO-6M module as GPS component has been used to track and acquire user information, which communicates and transmit data with the microcontroller using a serial connection (FIG. 18, No. 1-18). To evaluate users' location validity, the system may randomly match the data of GPS module in road safety device and similar data from the smartphone.

### IMU (FIG. 18 No. 1-15)

An IMU (inertial measurement unit) is an electronic component that combines inertial sensors—gyroscopes, accelerometers and compass—to provide acceleration and orientation data that can be used to calculate position and velocity. GPS and IMU module in the mainboard of the road safety device provide data to the microcontroller to be processed then the processed data is sent to server in an encoded format.

### Wi-Fi (FIG. 18 No. 1-16)

This module is used to communicate with the system server when the user access to Wi-Fi or hotspot in the vehicle, in this mode the road safety device connects directly to the server using Wi-Fi module to transmit data (FIG. 18, No 1-16 & FIG. 18, Route 1-34). In this mode, the road safety device works independently and there is no need to involve a smartphone. An ESP32-WROOM-32 module has been used to operationalize Wi-Fi connection. The data received from various component and sensors of the mainboard, as well as the data received from the vehicle, are transferred to the microcontroller to be processed then it is sent to the server through Wi-Fi module (FIG. 18 No. 1-16).

### Bluetooth (FIG. 18 No. 1-10)

In order to transfer data between the smartphone and the mainboard of the road safety device, a Bluetooth connection has been used. To put into practice this connection, a Bluetooth module with part number HC-05 is used in road safety device mainboard. This module is connected to the microcontroller by the serial connection (FIG. 18, No. 1-21). This module is part of the radio communication chain among the mainboard, vehicle, GUI board and smartphone.

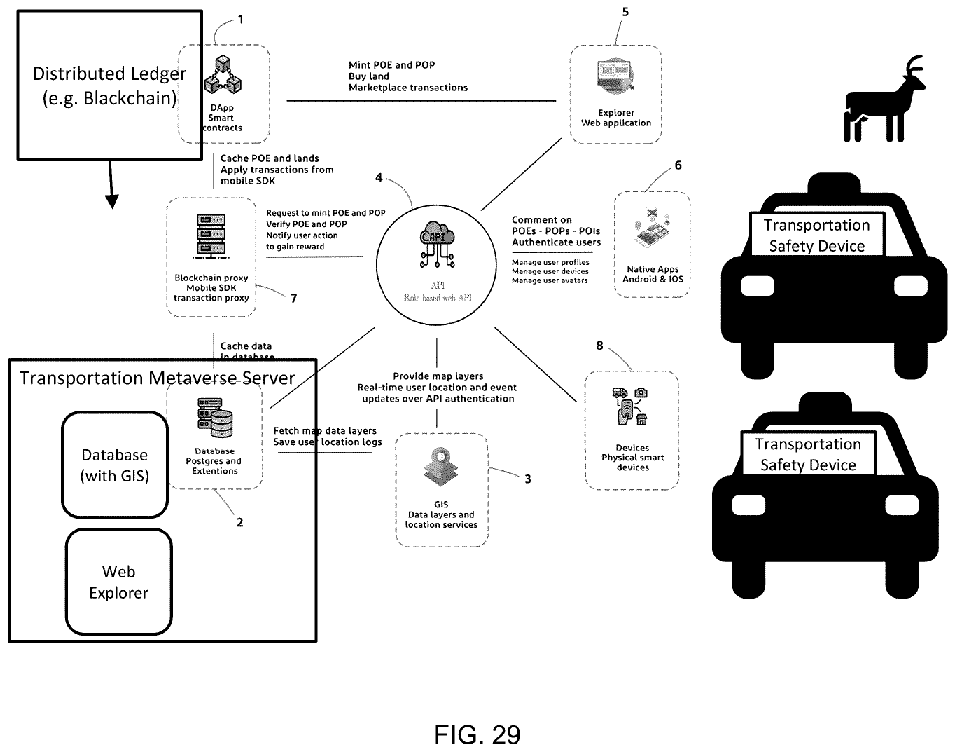

If using Wi-Fi, the road safety device connection with the server is direct and there is no need to involve the smartphone. But if Wi-Fi is not used (in second mode) communicating with the server is easily done by connecting the road safety device to the smartphone through Bluetooth (FIG. 18, route 1-22). A schematic diagram designed for FIG. 18 No. 1-10 (Bluetooth) is depicted in FIG. 29.

### Microcontroller (FIG. 18 No. 1-9)

In the motherboard of road safety device a microcontroller (STM32F429ZGT one) with core ARM Cortex M4 is used. In general, this processor controls and coordinates all electronic components, and communicates with the vehicle, GUI board and smartphone.

The following are Among the important tasks of the microcontroller; setting up and control the GPS circuit, Bluetooth circuit, WI-FI circuit, IMU circuit, wireless connection circuit between the mainboard and GUI board, OBD2 connection circuit with the vehicle, connection with the 3D VR camera peripheral unit board, connection with the camera peripheral unit board, Gas Pedal pad and Safety alarm Bracelets, as well as the producing audio output with I2S protocol.

In order to take advantage of the maximum performance of the processor and the high speed of response to start the circuit, no operating system has been used to implement the microcontroller software, its programming is done using C language in the IAR IDE. A schematic diagram designed for FIG. 18 No. 1-9 (Microcontroller) is depicted in FIG. 30.

### Clock Circuit (FIG. 18 No. 1-6)

The clock circuit provides the clock pulse for the correct and accurate operation of the microcontroller. All the timings related to software and hardware functions, including the timings related to all types of serial connection are coordinated by this circuit.

### Reset Circuit (FIG. 18 No. 1-7)

The reset circuit resets the microcontroller when the system is turned on just before complete stability of the power supply and also when manually resetting the system. A schematic diagram designed for FIG. 18 No. 1-7 (Reset Circuit) is depicted in FIG. 30.

### Debug and Program Circuit (FIG. 18 No. 1-8)

A JTAG port has been assigned for microcontroller programming and debugging for ease of software implementation as well as ease of diagnosing and fixing software bugs. A schematic diagram designed for FIG. 18, No. 1-8 (Debug and Program Circuit) is depicted in FIG. 31.

### I2S Audio Amplifier (FIG. 18 No. 1-11)

This circuit of the road safety device decodes, amplifies and broadcasts audio data. After evaluating and filtering in the server the audio data will be encoded then this circuit decoded the received data and by amplifying the range and power, it is delivered to the speaker then the audio messages will be notified to the users.

### Wireless Transceiver (FIG. 18 No. 1-12)

This circuit establishes a wireless radio connection between the microcontroller of the mainboard and the microcontroller of the GUI board in order to transfer the necessary data between mainboard and the GUI board. This connection is done by means of a radio circuit NRF24L01 as an encoded radio signal which is completely safe and proper for the needs of system and the mainboard of road safety device.

The wireless module (FIG. 18, No. 1-12) connected to the microcontroller using an SPI connection route (FIG. 18, No 1-27). A schematic diagram designed for FIG. 18 No. 1-12 (Wireless Transceiver) is depicted in FIG. 32.

### Driver (FIG. 18 No. 1-13)

This part of the circuit starts the vibrator motors embedded in the Gas Pedal Pad peripheral unit (FIG. 18, No. 4a (4-1)) so that the control signals are sent to driver circuit (FIG. 18 No. 1-13) using the microcontroller, and after amplifying the current and voltage, this circuit applies it to the vibrators of Gas Pedal Pad unit (FIG. 18, No. 4a (4-1)) through the route (FIG. 18. No. 1-24).

### Loadcell Module (FIG. 18 No. 1-14)

This circuit receives weak and noisy signal from Loadcell, and after removing noise and amplifying, converts the analog signals to digital ones. Then this digital signal is delivered to the microcontroller through two-wire serial connection (FIG. 18 No. 1-28). A load cell is a type of transducer which is used to convert mechanical force into a measurable electrical output.

The Loadcell sensor in this circuit is used to detect the presence of the driver's foot on the gas pedal, so that whenever the driver's foot is on the gas pedal, this sensor sends an output voltage corresponding to the pressure on the pedal to the microcontroller. The microcontroller estimates the amount of pressure on the gas pedal by measuring this digital value of this voltage. The pressure value is compared with a threshold value, and if it is greater than the threshold value, the foot on the pedal is detected and a decision is made accordingly. A schematic diagram designed for FIG. 18 No. 1-14 (Loadcell Module) depicted in FIG. 32.

### Camera Board Interface (FIG. 18 No. 1-4)

This circuit may create a connection (wireless and wired) between the mainboard and camera peripheral unit, so, Dash Cams or camera peripheral units will be connected to the road safety device with a private code. In this mode, even Dash Cams which do not have Wi-Fi connection capability (Internet connection) can be connected to the road safety device.

There are two types of fast and safe connection in the mainboard which are designed to communicate with the camera peripheral unit (wireless, wired), to provide more options for Dash Cams or camera peripheral units connecting with the road safety device. The camera board interface circuit (FIG. 18 No. 4) is in charge of this task in the mainboard circuit. In general, this circuit transmits necessary commands to the camera board and evaluates the camera status through this connection.

### Wired Connection Route A1 (FIG. 18 No. 1-29)

To create this connection, a CAN type serial protocol is used to create a connection between the camera peripheral circuit and mainboard of the road safety device, and the data is transmitted in the CAN protocol.

### Wireless Connection Route A2 (FIG. 18 No. 1-36)

To create this connection in the mainboard, a radio data transmission circuit No. NRF24L01 may be used in the mainboard of the road safety device, the “camera board interface circuit” (FIG. 18, No. 1-4). The complement of this radio transmission circuit is placed in the camera peripheral board circuit and using this wireless connection (FIG. 18, No A2), necessary commands are transmitted from the mainboard of the road safety device to the camera peripheral unit board.

For example, when a single physical button corresponding to the live animal is pressed on the GUI Board, after processing the command in the circuit of the GUI Board, the data is sent to the processor of the mainboard using the wireless route (FIG. 18, No. 1-23), and after the data is processed by the Microcontroller (FIG. 18, No. 1-9) it will initiate the data transmission to the server. If the road safety device is connected to the camera peripheral unit, the command to take a picture will be transmitted automatically at the same time and the appropriate encrypted code will be sent to the camera peripheral unit through one of these routes (FIG. 18, No. A1) or (FIG. 18 No. A2). The taken image of the road event is combined with the road safety device's unique code along with the location coordinates, direction of the movement, speed, etc. These images along with the encrypted data may be sent to the server via this route for validation and storage.

If for any reason, the Dash Cam or smartphone, responsible for the camera peripheral unit's function, is not connected to the internet, the encrypted image is stored in the camera unit memory and after connecting to internet, it is automatically sent to the server. It is worth mentioning that the peripheral camera units connected to the internet which sends images to the server online, will have a high validation level and earn more SCT reward.

On the other hand, there is another option, so that the Dash Cams or camera peripheral units which do not have this circuit will communicate with the road safety device through internet (using API). In this mode, the Dash Cams need to have internet connection capability to communicate with the road safety device through the server (FIG. 2 No. 11 and No. 12). With this capability, the users of Dash Cams or camera peripheral units with internet connection, can connect to the road safety device easily and there is no need for a hardware upgrade of Dash Cam circuit. Furthermore, the user can use the common features of the Dash Cams or camera peripheral units and there will be no interruption in the road safety device functionality.

As the second version (advanced) of camera peripheral unit is connected to the road safety device, the road safety device detects some road events automatically, then the code related to the road event along with its attributes will be sent to the mainboard of road safety device via a route on the camera board so, the mainboard sends relevant data to the GUI Board and processes data and type of road event to inform and display to the driver. The type of notification is received by the driver is different according to type and risk level of road event and value of features of the road multiple blocks. The following combined methods are adopted by the system so that the drivers have more chance to receive notifications at right time:
1—Display the road events on the GUI road safety device.
2—Turning on the multi-colored LEDs (only in specific conditions) around the GUI road safety device (some of the road events or warnings have specific colors).
3—Various beep rhythms type played by the buzzer on the GUI road safety device. (some of the road events or warnings have specific beep rhythms).
4—Announcement by the system speaker (in specific situations).
5—vibrating warning notifier for dangerous road events or situations by Gas Pedal Pad or Safety alarm bracelet

Usually, these options are used in combination by evaluating the road events or situations.

### VR Camera Board Interface Circuit (FIG. 18 No. 1-5)

This circuit creates the connection (wireless, wired) between the mainboard of road safety device and the VR camera peripheral unit. Also, this circuit is responsible for communicating and buffering the signals between the mainboard and the VR camera peripheral unit. For example, when the driver accepts a virtual ride via GUI road safety device, the VR camera peripheral unit will be activated by the transmitted command from the microcontroller of mainboard road safety device via wired route B1 (FIG. 18 No. 1-30) or wireless route B2 (FIG. 18 No. 1-37)

GUI Road Safety Device with Physical Buttons (FIG. 18 No. 2)

This unit is considered the second main part of the system, which is designed for users to interact with the system and always available to the driver on the steering wheel or any proper place in the vehicle to report and observe road event. The GUI road safety device creates a solution to report road event in detail manually without distraction and long steps just by pressing a single button. Also, the GUI road safety device increases the chance of observing road event by the driver easily without distraction. So, to report a road event using this unit, drivers do not need to go through distracting, risky and long steps like Waze in smartphone or car display. The GUI road safety device provides the drivers to report road events without using smartphone or car display in short time.

The block diagram of GUI road safety device circuit is depicted in (FIG. 18, No. 2).

A STM 32H725RGV6 microcontroller with an ARM Cortex-M4 core is used in the GUI circuit to control and coordinate all function of electronic components in the GUI board. In order to have two-way wireless connection with mainboard, a wireless transceiver circuit is used (FIG. 18, No. 2-6) and (FIG. 18, route 1-23).

To take advantage of the maximum performance of the processor and high response speed, no operating system has been used to launch the circuit, its programming has been done with C language in the IAR IDE.

The mainboard communicates wirelessly with the GUI road safety device (FIG. 18, No. 2) using (FIG. 18, route 1-23). As displayed in (FIG. 18, No. 2), the GUI board consists of various circuit such as power circuit (FIG. 18, No. 2-1), charging circuit, round display screen, physical buttons, multi-color LEDs, 3-mode round touch strip, microphone and speaker.

### Battery Charger and PMU (FIG. 18, No. 2-1)

In addition to provide voltage for different sections of the GUI board, this circuit of the board is managing the power and charging of the lithium battery placed in the GUI road safety device, this circuit is also supplying and switching between the input power supplies of the battery.

### Microcontroller (FIG. 18 No. 2-2)

The microcontroller is embedded inside of the GUI board to control a singular function in the road safety device, doing that a microcontroller STM 32H725RGV6 with ARM Cortex-M4 core is used. This microcontroller is responsible for receiving and processing input data from the user, including physical buttons, touch, and microphone and etc. and on the other hand, it is in charge of receiving and processing data from the mainboard and peripheral units. It also starts up, controls and operates the various circuits in the GUI board such as wireless transceiver circuits, buzzer, LEDs, round display, etc. In order to take advantage of the maximum performance of the processor and high response speed, no operating system has been used to launch the circuit, it is programmed using C language in the IAR IDE environment.

### I2S Microphone (FIG. 18 No. 2-3)

A microphone along with the relevant circuits is placed in this unit so that it is possible to receive the voice of the driver and send it to the mainboard and the server.

### Clock and Reset Circuit (FIG. 18 No. 2-4)

The clock circuit is providing the clock pulse for the correct and accurate operation of the microcontroller, and all the timings related to software and hardware functions, including the timings related to all types of serial connection which are coordinated by this unit.

The reset circuit resets the microcontroller when the system is turned on and before complete stability of the power supply and also when manually resetting the system.

### Debug and Program Circuit (FIG. 18 No. 2-5)

For ease of software implementation as well as ease of diagnosing and fixing software bugs, a SWD port is designed for microcontroller programming and debugging.

### Wireless Transceiver (FIG. 18 No. 2-6)

This circuit establishes a wireless radio connection between the microcontroller of the GUI board and microcontroller of the mainboard in order to transmit the necessary data between mainboard and the GUI board. This connection is done by means of a radio circuit NRF24L01 as an encoded radio signal which is completely safe and proper for the needs of system and the mainboard of road safety device (FIG. 18, No. 2, route 2-12).

### Display (FIG. 18 No. 2-7)

The display of the road safety device is a round display (480×480 pixel) that is connected to the microcontroller via SPI connection (FIG. 18, route 2-13).

### Keypad (FIG. 18 No. 2-8)

The road safety device has 11 physical buttons that are directly connected to the micro ports and their status is continuously checked by the microcontroller.

### LEDs (FIG. 18 No. 2-9)

The multi-color LEDs which are placed under the strip touch around the road safety device's LCD are used to notify the driver in some situations and direction of road events. These LEDs are arranged in a circle and divided into 4 equal parts, each of these parts demonstrate the direction of the road event (left-right-middle-rear). Also, as a guide, it makes possible for driver to report the direction of road event via strip ring touch around the LCD easily with minimal distraction, the placement of these LEDs can be seen from the user side of GUI road safety device.

### Buzzer (FIG. 18 No. 2-10)

A buzzer is used to play different beep rhythms to notify the driver in necessary situations.

### Touch (FIG. 18, No. 2-11)

A 3-mode strip ring touch has been used around the physical buttons, which make it possible for driver to determine the direction of reported road event via strip ring touch around the LCD easily with minimal distraction. The position of strip ring touch of the GUI road safety device is displayed in FIG. 4 No. 15-16-17 (NO. 15—middle side-No. 17—right side-No. 16—left side)

### Peripheral Units Connected to Road Safety Device Version 1

### 1—Vibrating Warning Notifier

### Gas Pedal Pad (FIG. 18 No. 4a)

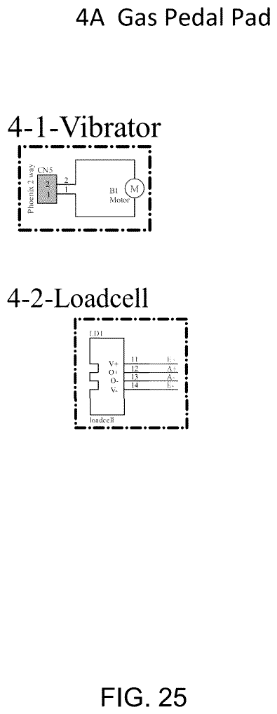

This peripheral unit is used in a vehicle as a vibrating warning notifier to inform the drivers in dangerous situations by vibrating the gas pedal. It may be a silicone pad that is installed on the gas pedal of the vehicle. This unit may have a number of vibrators and a loadcell circuit to detect the pressure of the driver's foot on the gas pedal. A schematic diagram designed for FIG. 18, No. 4a (Gas Pedal Pad) is depicted in FIG. 25.

### Safety Alarm Bracelets (FIG. 18, No. 4b)

The wireless Safety Alarm bracelet may be used for motorcycle, bicycle and scooter riders as vibration notifier in dangerous situations by creating of vibration in the hand wrist. Safety Alarm bracelet also has a PPG sensor to measure heart rate in times of danger or accident. An emergency button is also embedded in this bracelet, by pressing it the location and request for help will be sent.

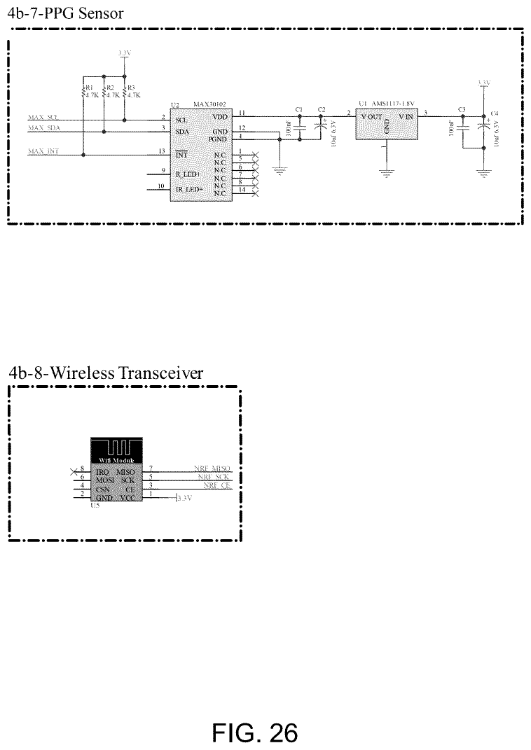

A schematic diagram designed for FIG. 18, No. 4b (Safety Alarm bracelets) is depicted in FIG. 26.

### 2—Camera Peripheral Unit

The mainboard of the road safety device is designed in a way to provide more options for connecting other Dash Cams or camera peripheral units to the road safety device, so camera units with different circuits can be connected to it. According to the type of camera unit features, the mainboard can provide the user with different functionalities.

For example, while basic peripheral unit (camera unit version 1) is connected to the road safety device, capabilities such as automatic taking photos of road event, initial matching and sending images to the server are added to the system.

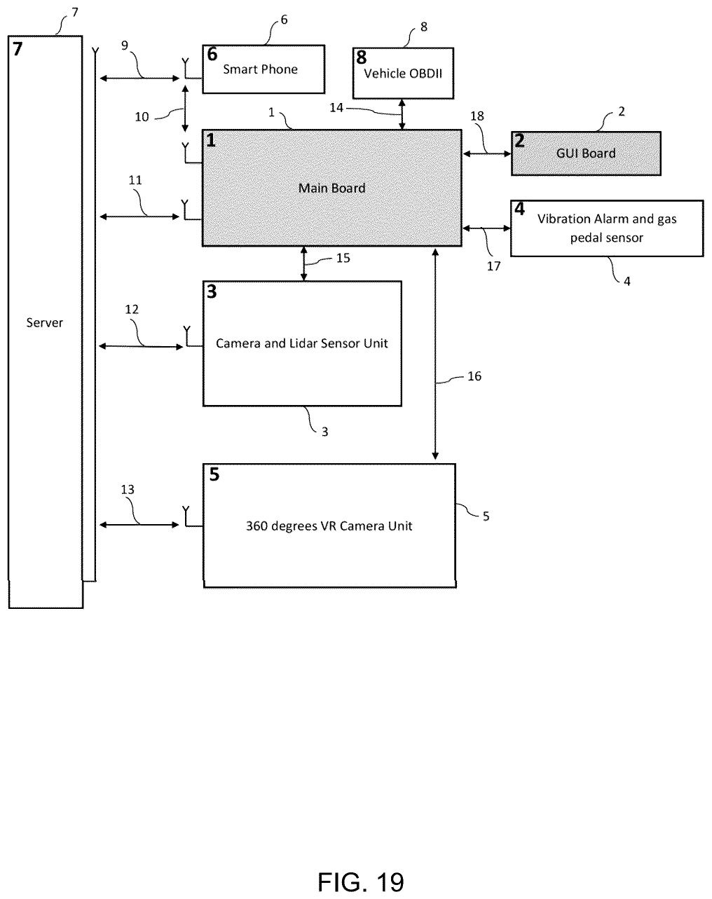

As another example, connecting the advanced peripheral unit (camera unit version 2 FIG. 19, No. 6), in addition to taking automatic photo of road event and initial matching, the features of some road event automatic detection and sending the report to the other drivers are added to the system.

As explained earlier, in order to mitigate the price of road safety device and to respect the rights of the consumer, the camera unit is designed as a non-compulsory unit in this system, so the users do not need to buy a camera unit to use the main features of the road safety device. But users will have access to more functionalities when connecting the camera unit to the main road safety device.

In the other hand a possibility has been provided to give the freedom to the consumer to connect Dash cams or other camera units to the road safety device. Therefore, the mainboard of road safety device is designed in a way that it can be connected to the majority of camera unit boards in the market. Connecting the camera unit to the road safety device, the user's SCT reward is also increased based on the POH algorithm.

The connection between the mainboard and camera unit is done using various methods:

Wired connection route A1 (FIG. 18 No. 1-29) or Wireless connection route A2 (FIG. 18 No. 1-36).

WIFI connection, in this way other Dash Cams or camera peripheral units with internet connection can connect to the main road safety device easily using system API. The user can use the common functions of the Dash Cams or camera peripheral units and there will be no interruption in their functionalities.
While the road safety device is connected to a peripheral circuit unit of the basic camera, the road safety device operates as follows: the driver presses the physical button related to road event on the GUI Board road safety device, after processing the command in the GUI Board circuit using the wireless route, the required data are sent to the mainboard processor (FIG. 18, No. 1). By processing the command using Microcontroller of the mainboard (FIG. 18, No. 1-9), required data is sent to the server.

At the same time, the microcontroller of the mainboard transmits unique encrypted code along with command of taking photo to the camera unit to be combined. The unique encrypted code includes: date and time, location coordinates, direction of the movement, speed and etc. Then the camera unit sends the proper photo of a road event along with the encrypted code to the server. If the camera peripheral unit is not connected to the Internet, the encrypted image will be stored in the peripheral memory unit and will be sent to the server automatically after the connection with the Internet is stablished.

It is worth mentioning that the cameras unit connected to the Internet which send images to the server in real time will have a higher validity and get more SCT reward.
In the case the road safety device is connected to an advanced camera peripheral circuit unit (FIG. 19, No. 6), NVidia Jetson Nano processor with AI core is used.

Using this processor raises the price of the of the camera peripheral unit highly, but the capability to automatically detect some obstacles or road event will be added to the road safety device in addition to the mentioned functionalities in the basic version of peripheral camera unit.

When the camera unit automatically detects an obstacle, object, or animal on the road, then the road event data is sent to the mainboard using route Wired connection route A1 (FIG. 19 No. 1-29) or Wireless connection route A2 (FIG. 19 No. 1-36). or through internet (using API), (FIG. 19, No. 6), Then the microcontroller of the mainboard processes the data and transmits relevant command to the GUI board to display proper notification to the driver, the type of informing the driver will be different according to the type of road event risk level.

Connecting advanced peripheral camera unit to the road safety device, the capability of automatic detecting and reporting of some road events will be added, but capability of manual reporting of road events by the users is still essential. Since advanced camera unit detects obstacles ahead of the driver and actual road events, so sending report of all these road events to the other drivers is not necessary. It should be noted that only continuous road events which may put other drivers in a dangerous situation should be reported, so it is necessary to separate them.

For example, the system can detect a pedestrian, an animal or an object in the driver's moving path, but detection of continuous or discrete road events depends on various factors which as a task is up to the driver.

Furthermore, the system cannot detect or distinguish the road events which are not in the angle and direction of the vehicle, cameras, lidar sensors and other sensors of the vehicle. Many of the dangers and road events which are reported by the drivers are potential, and cannot be covered by the cameras and lidar sensors; but the driver is able to observe them. for example, animals among the bushes in the shoulder, falling rocks from the mountain, some pits on the road, children at play (near a street), or other similar cases. So manual reporting of those kind of road events can help other drivers to be careful and be more prepared facing potential road event or danger ahead.

Also, in the near future, these interactions and data transmission among drivers, autonomous cars on the roads will be of great importance and helps artificial intelligence to be developed in these vehicles.

### 3—Virtual Reality 3D Camera Unit

This peripheral unit allows drivers to accept virtual rider in Transportation metaverse and make some SCT reward, and the passenger via VR headset will experience a real time virtual trip thousands of miles away. In addition to giving the user the curiosity of a travel experience in a route or a favorite city, this peripheral unit also allows virtual passengers entering special areas to communicate with other travelers and tour leaders and enjoying the real experience.

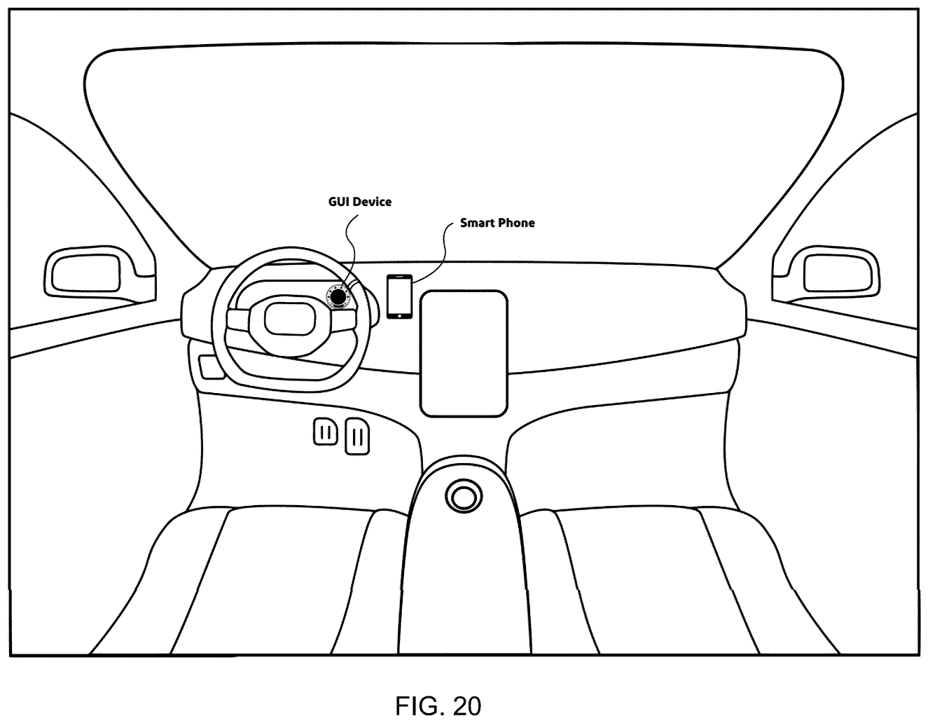

The road safety device version 2 road safety device for users of navigation apps, FIG. 20.

This version of the road safety device is specially designed for navigation apps such as Waze, Google maps, Apple maps and etc. to make user interaction easier with minimal distractions within the platform of these apps for reporting road events. In addition to providing users with capability to report road events in detail with minimal distractions just by pressing a single button, the road safety device version 2 increases the chances of users to be notified of road events ahead. Furthermore, the road safety device version 2 provides the users of these apps to report and observe road events when they are not using these apps or when these apps are not displayed on the smartphone screen or car display. For example, Waze navigation users are able to use this road safety device to interact with Waze app without using the app on their smartphones or car displays (CarPlay, Android Auto and etc.) and report the desired road event easily without distraction and observe road events or warnings ahead. Now without this road safety device, developers of the navigation apps who provides road event reports to the users are facing a big problem; that is, sending road event report using a smartphone or car display distracts the drivers to great extent. Also, if the number of reportable road events being increased and more details being added to them like Waze app, the reporting process takes more steps by driver and the driver being distracted more. As a result, the risk of accidents occurrence increases greatly. So, the developers and designers are forced to work with one of the following options which each of them has its own advantages and disadvantages.

1—Reducing Reportable Road Events and Inability to Add Details to them

In this case, the efficiency of the road event reports and the data collected from them will be sacrificed and it will subsequently have less impact on road hazard prevention, and in the other hand, the limited events without details do not have the required quality and efficiency for future usage.

2—More Reportable Road Events and Adding More Details to them

In this case, by adding number of reportable road events with capability to add details to them, the process of road event reporting takes more steps for driver and distracts the driver more, this subsequently increases the risk of an accident for the driver. Because, while driving the user is forced to go through these steps using complicated menus in the navigation apps of smartphones or the car displays (Car Play, Android Auto and etc.). In fact, doing this, the law “not using a mobile phone while driving” is violated. Furthermore, the drivers do not still have the possibility to report and observe road events while not using the navigation app.

Therefore, this road safety device solves these problems for users and developers of navigation apps. Using the road safety device, will make it easier for user to report more road events in detail with minimal distraction and avoid going through long process with many steps. On the other hand, the road safety device provides more options to the developers of navigation apps to notify the drivers in case of hazards and road event ahead. In addition to the said cases, this road safety device provides developers with the possibility of validating the reports and avoiding sending fake reports which is easily being done in the Android operating system (this problem has been explained in the background section). Also, this version of the road safety device may be open source and adjustable so the developers of the navigation apps are able to provide any similar features to users through this road safety device and enhance users' interaction, for example displaying road speed limit, speed cameras, traffic light cameras and etc. to the users. This road safety device may also have the capability to interact with ride-sharing apps platform such as Uber and Lyft and provides this functionality to the driver to observe, accept or cancel trips or add a ride to their queue easily with minimum distraction. Doing such tasks is done easier and with minimum distraction with the road safety device in contrast to a smartphone or Car-Play.

Ride-hailing app platform have some emergency functionality such as 911 assistant or follow my rides but in dangerous or life-threatening situations, using menu of these apps to ask help through smartphones or car display may be impractical or inaccessible given the urgency of the situation. The road safety device, having emergency button (FIG. 4, No. 12), provides the ride-hailing app drivers to use emergency functionality of these platforms easily without high risk or putting them in more dire situation.

In the other hand, drivers while using the navigation of ride-hailing app platform (for example Uber or Lyft) can use road safety device version 2 to interact with other navigation apps for observing and reporting road events without limitations which have been explained in the background section. The software of the road safety device may be open source and provided to the developers of navigation apps to have more freedom of action to customize the software based on the user experience of their platform.

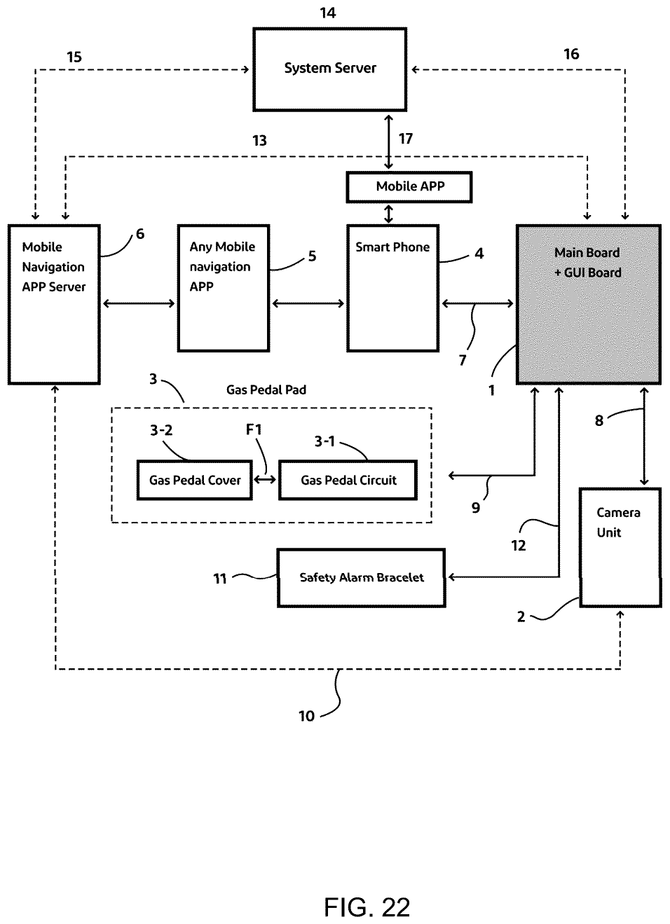

In addition, this road safety device is specifically designed for users of navigation apps, but it is designed to allows users who do not need to use navigation apps to use and take advantage of our system's services. The road safety device version 2 can be used by cyclists, scooter riders or drivers whose vehicles do not have capability to connect to the road safety device version 1. So, these users using the road safety device version 2, can take advantage of our system functionalities. Using road safety device version 2, users are able to connect to the smartphone and subsequently to the system app via Bluetooth and benefit from our system functionalities (FIG. 22, No. 7 and 17). Also, users are able to connect to our system server directly without any dependency through WIFI connection without using smartphone (FIG. 22 No. 16) and benefit from our system functionalities.

The road safety device may include the following features:
1. Gaining SCT rewards for contributing to the transportation metaverse for example when reporting road events or responding to request to verify road events.
2. Gaining SCT rewards by interacting with navigation Apps.
3. Warn driver about accident-prone areas, where the warning may be given according to the type of vehicle (cars, cyclists, scooter riders etc.)
4. To warn driver before a collision occurs at intersections or on side roads to the main or similar conditions
5. Creating dedicated vehicle avatars and user activity avatars to communicate with multiple geo-tiles of the Transportation metaverse roads network and facing SCT reward.
6. AI based virtual warning sign, for example an animal crossing sign. This feature actually is a warning of animal presence in road ahead of driver based on artificial intelligence algorithm. This feature is a suitable alternative to physical signs on the roads that are not very useful for drivers. The system has developed an AI engine that data in the system and gathered by the system to predict the possibility of colliding with animals or the presence of animals on the road ahead of the driver. The prediction possibility will be notified to the driver through car display or other GUI components (FIG. 13).

One purpose of road safety road safety device version 2 is to create a simple way with low risk for drivers to repot road events, as compared to reporting events on navigation Apps where it may be a distracting and time-consuming process of interacting with the navigation App to report the event, instead the road safety device may use an image acquired to determine the road event using AI image recognition technology.

The road safety device version 2 provides the driver to report road events (incident, anomaly) without getting on the time consuming and risky steps and without using smartphone display and car display (Car-Play and Android-Auto and etc.).

In the other hand the road safety device version 2 is always available to the driver to observe and report road events (incident, anomaly), to do this, there is no need to see the app screen on the smartphone or car display. The road safety device version 2 is easily placed on the steering wheel of a vehicle or motorcycle or any other place in the car that is suitable for driver (FIG. 3).

The road safety device version 2 also allows users of navigation Apps to use the other features of the navigation Apps while they do not need a navigation guide or navigation screen is closed and their interaction and communication with the navigation app is still connected. Therefore, the road safety device version 2 as a proper assistant is always ready to report road events with details like photos just by pressing a single button and notify the drivers of events or hazards at the right time.

The road safety device version 2 with a microphone and physical buttons and a three-mode round touch (to add the road event direction) enable the driver to report the road events in detail without any distractions or any risk by pressing a single button.

Using road safety device version 2, all the notifications will be notified at the right time to the user to drive safer. In order to the user (driver) be notified of these notifications, a round screen having LED around it, a beep alarm, and a vibrating alarm peripheral unit are used.

A Bluetooth connection is used to transfer data between road safety device version 2 and a smart phone. This road safety device is also capable of connecting to the server of navigation apps directly using Internet connection.

### The Operation and Design Process of Road Safety Device Version 2

In this version of the road safety device, it is not required to transmit data between motor vehicle and road safety device through OBD2 port. Therefore, making changes in the circuit design, the main board is combined with the GUI board, and as a result, users just will have a GUI road safety device which its appearance similar to the GUI road safety device version 1 depicted in FIG. 20. The road safety device version 2 may be placed by the driver in a conveniently location (i.e., on the steering wheel) in the vehicle without any wired connection.

Also, road safety device version 2 may be capable of connecting to the peripheral units and the user is not required to connect peripheral units to this road safety device to use the main functions of the road safety device version 2, but by connecting the peripheral units to the road safety device version 2, the users will access to more functionalities. Due to the design type and low price of the peripheral units it will be affordable for the user to buy the peripheral units.

### Components for Road Safety Device Version 2 and Connectable Units

### A: Main Part

A-1: Mainboard+ Graphical user interface board (FIG. 22, No. 1)

### B: Peripheral Units

B-1: Camera peripheral unit (FIG. 22, No2)
B-2: Vibrating alarm
   B-2-1: Gas pedal pad (FIG. 22, No. 3) for cars
   B-2-2: Safety alarm bracelets (FIG. 22, No. 11) for motorcycles, bicycles and scooters
      C: Other Parts which are Connected to the System
C-1: Smartphone (FIG. 22, No. 4)
C-2: Servers (FIG. 22, No. 6) (FIG. 22, No. 14)

In road safety device version 2, the main board is combined with the GUI board. Due to the placement of the road safety device on the steering wheel of a vehicle, motorcycle, bicycle and scooter; embedding any wired connection in the road safety device is impractical so a wireless connection is used for the connection of peripheral units to the road safety device version 2 which is depicted in FIG. 20.

To supply the voltage for the peripheral units in the vehicle, the vehicle cigarette lighter plug or USB charger port is used (F1 and F2 routes in FIG. 20).

To supply the voltage for Safety Alert Bracelets (which are used by motorcycle users, cyclists and scooters) an internal battery is used.

### A-1: Mainboard+ Graphical User Interface Board (FIG. 22, No. 1)

One of the important purposes of designing road safety device version 2 is to create a simple way with no risk for users of navigation apps to report road events without distraction and time-consuming steps and observe them always at the right time.

The road safety device version 2 is placed on a proper place like steering wheel in bicycle, scooter, motorcycle and car and it's always accessible for the users to report and observe the road events. Fulfilling this, the round display and Lighting LED around it and a buzzer are used.

In the other hand, the road safety device version 2 with a microphone and physical buttons and a three-mode round touch (The user uses it to specify the left, right or middle side of the reported road event) enable the driver to report the events in detail without distractions or risk.

The appearance of the road safety device version 2 is depicted in (FIG. 4), No. 1,2,3,4,5,6 are physical buttons for reporting road events, No. 7 (Yes button) for approving a road event, No. 8 (Return button) is for displaying other road events, No. 9 (No button) is for rejecting road event, No. 10 is charge connector, No. 11 is the on/off button, No. 12 is emergency button No. 13 is a round display, No. 14 is multi-color LEDs which are placed under the strip touch around the road safety device. This multi-color LED is additional warning feature that are used to notify the driver in various situations and also used as a guide to show the direction (left-right-middle-rear) of the reported road event. These LEDs are arranged in a circle and divided into 4 equal parts, each of these parts indicate the direction of the road event (left-right-middle-rear).

After a road event is being reported by the user pressing a physical button, in some cases it is necessary for the user to specify the direction of the road event (left-right-middle). In order to not distracting the user and determining the direction of the road event in a short time, the LEDs under the touch strip (in Equal Part) are lit in 3 colors to guide easily the user to choose proper part of the touch (right, left or middle) relating to side of road event. No. 15, 16, 17 is strip touch around the road safety device, which users will add the direction (side) of located road event to their report by touching each side of this strip touch (NO. 15—middle side-No. 17—right side-No. 16—left side).

Drivers can observe or report categorized road events with minimal distraction without using smartphone display or car display (Car-Play, Android-Auto, etc.).

By pressing one of the physical buttons (1, 2, 3, 4, 5, 6) in (FIG. 5 (5A)), a road event will be reported by the driver. By pressing button 8 in (FIG. 5 (5A)), the screen turns to FIG. 5 (5B) where more other road events are located. After a road event is reported, the buzzer of the road safety device beeps a short sound, if there is no warning or hazard to display, “sent report confirmed successfully” is displayed for 3 seconds (FIG. 5 (5C)). If there is a hazard or a road event to display, only a tick mark will appear on the reported road event icon (FIG. 5 (5D)), then the driver will be informed of successful reported road event by hearing the beeps sound of the buzzer.

As it is depicted in (FIG. 5 (5A)), the numbers 1I, 2I, 3I, 4I, 5I, 6I are user guide icons for physical buttons that are displayed near them. Despite the fact that the users can change the layout of the icons from the setting menu, the road event icons are designed in a such a way that to be moved automatically to the main page, when necessary, based on the conditions and road needs so that the users do not need to press button No. 8 as much as possible (FIG. 4, No. 8). For example, in an area where there are many reports of ice road in the winter season, the system moves “ICE ROAD” icon to the main page on the display by checking the different conditions so that it is easier for the users to access it, but in normal conditions the default icons are displayed.

FIG. 6 depicts various modes of road event reported by other users. The YES and NO buttons are for approving or rejecting road event reported by other users or automatic detection system of advanced camera peripheral unit.

In addition to displaying road events and other warning through the screen of road safety device version 2, the road safety device capabilities provide other ways to inform the users in various situations, which are as follows:
1—The strip LEDs around the road safety device version 2
2—Buzzer warning sound
3—Through the speaker or headset connected to the road safety device
4—Vibrating warning via the Gas pedal pad in car or via Safety Alarm bracelets for motorcycle, bicycle and scooter riders.

This type of announcement can be used in combination by evaluating the said conditions and level of dangers of road event ahead. The difference in the type of warning in various conditions makes the driver more sensitive to the categorized warnings, and notices them even without looking at the screen. Thus, the announcement of road events or other warning in navigations apps by using this road safety device are more useful and distract less the driver, and the chance of informing the driver of hazard will be increased. The combination of announcements to the users can be changed in different conditions, such as level of the road event dangerousness, validation rank of the reported event, type of road, speed limit, weather conditions, type of vehicle, and distance to the road event.

Sometimes, while users are informed of a road event or hazard on the display of the road safety device, they may report a new road event simultaneously. These modes are depicted in FIG. 7.

By pressing a single button, the users report a road event and at the same time the camera peripheral unit automatically takes a photo of road event. In some situations, or dangerous cases, the users may feel it necessary to provide more explanations about the road event so that other users will be more aware of it, and the users can press a report button for more than 3 seconds to add 6 seconds voice to the road event report, Numbers 1, 2, 3, 4, 5, 6 in (FIG. 5 (5A)), for example:
“There is a pit on the right side of the road which is hard to see”
“lots of deer on the left side of the road among the trees”
“Falling Rock from the mountain, stop!”
“Children are playing on the right sides of the street, be careful”

In order to the sounds played from the speaker not to be annoying, the sounds can be filtered by various algorithm in navigation app server.

To hear this voice, bicycle riders, scooter riders, or motorcyclist can use a headset which is connected to the road safety device or they can use the speaker of the road safety device. To hear this voice in the car this speaker can be placed at the pillar next to the driver (FIG. 8). Also, the road safety device's audio system has capability to connect to the vehicle's Bluetooth, but considering that the driver may be listening to music or a radio station, and preventing the music from being disconnected and connected over times, and also to avoid annoying the passengers of taxi, this speaker is a proper alternative, so the driver just hears the sound by adjusting its volume.

The appearance of road safety device is a little bit different in some vehicles such as fire trucks, ambulances and school buses (FIG. 9).

### General Description of the Road Safety Device Function, Peripheral Units and Other Related Sections (FIG. 22)

The main board and the GUI board are combined in the road safety device version 2, and the road safety device is connected to the smartphone and then to the desired navigation app via Bluetooth (FIG. 22, No. 7) to solve the said problems of navigation apps related to reporting and observing road events. This version of the road safety device has capability to work independently without our software system including mobile app and our system server, so it is easily connectable to the smartphone via Bluetooth and subsequently interact with the navigation app and its server (FIG. 22, No. 7, No. 5 and No. 6).

Also, this road safety device is capable of direct connection and interaction with the server of navigation apps without any dependency to connect to the smartphone, to do this the road safety device should be connected to the WIFI, then the data is transmitted between the road safety device and the server directly. So, users will benefit from said functionalities. In this case the connection to the server of navigation apps is done through route No. 13 in FIG. 22.

Therefore, when the users of navigation apps do not need to use navigation routing service, this road safety device provides the possibility to the users to use other functionalities of navigation apps. So, the communication and interactions of users with them is always maintained and users can benefit from them. The users' interaction with the server of navigation apps is possible without dependency on a smartphone or car display.

In addition to the said functionalities which are added to the navigation apps by connecting to the road safety device version 2, the developers of the navigation apps can provide more functionalities to their users by connecting to our system API (FIG. 22, No. 15), for example AI based animal crossing signs which is actually a warning of animal presence in road ahead of driver based on artificial intelligence algorithm to predict the possibility of colliding with animals or the presence of animals on the road ahead of the driver in different situations and earning cryptocurrency of the system (SCT) by contribution in POH network of the system and etc.

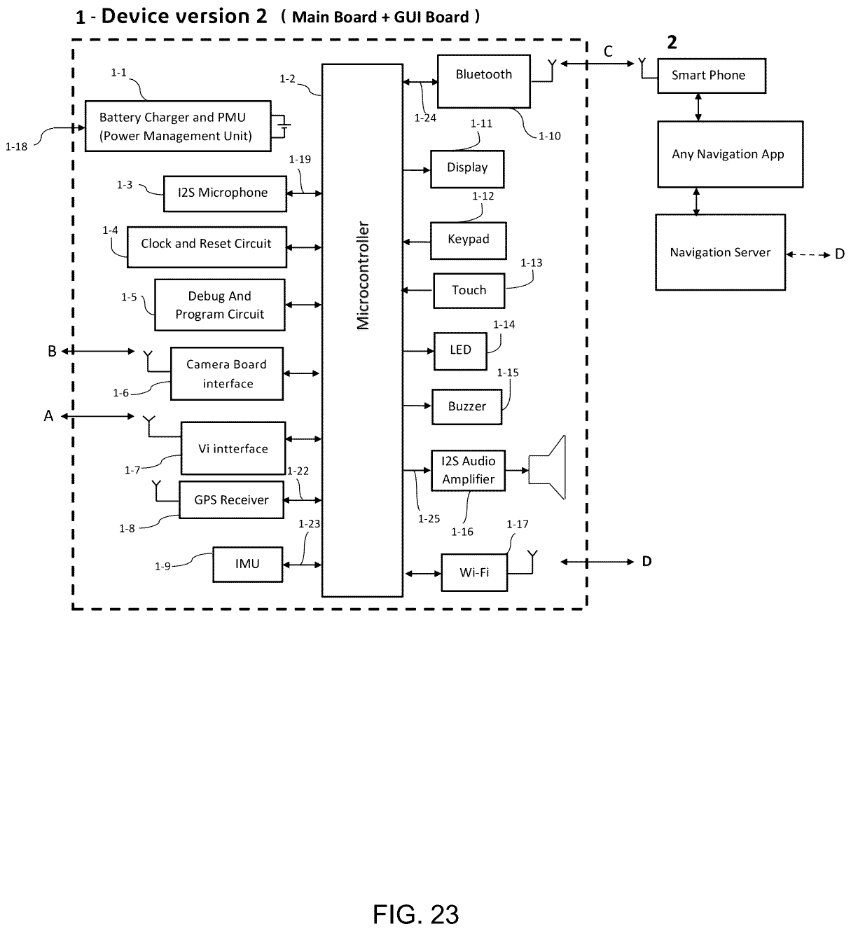

As it was explained, users can benefit from these features using Bluetooth (FIG. 22, No. 7) or using WIFI connecting (FIG. 23, No 13).

The connection of the camera peripheral unit to the road safety device version 2 is maintained through a wireless connection (FIG. 22, No. 8), this connection used to transmit data between the road safety device and peripheral camera unit such as commands of taking photo and unique encrypted code and etc. then images along with unique encrypted code are transferred to the server directly from camera peripheral unit through WIFI connection (FIG. 22, No. 10).

When camera peripheral unit is not connected to the Internet or there is a connection lost, the image is stored in the external memory of the peripheral camera unit; after the Internet connection be stable, it is automatically sent to the server.

Data transmission between the Gas Pedal Pad peripheral unit (FIG. 22, No. 3) and road safety device version 2 are maintained through the Gas Pedal Circuit via wireless connection (FIG. 22, No. 1-3 and FIG. 22, No. 9).

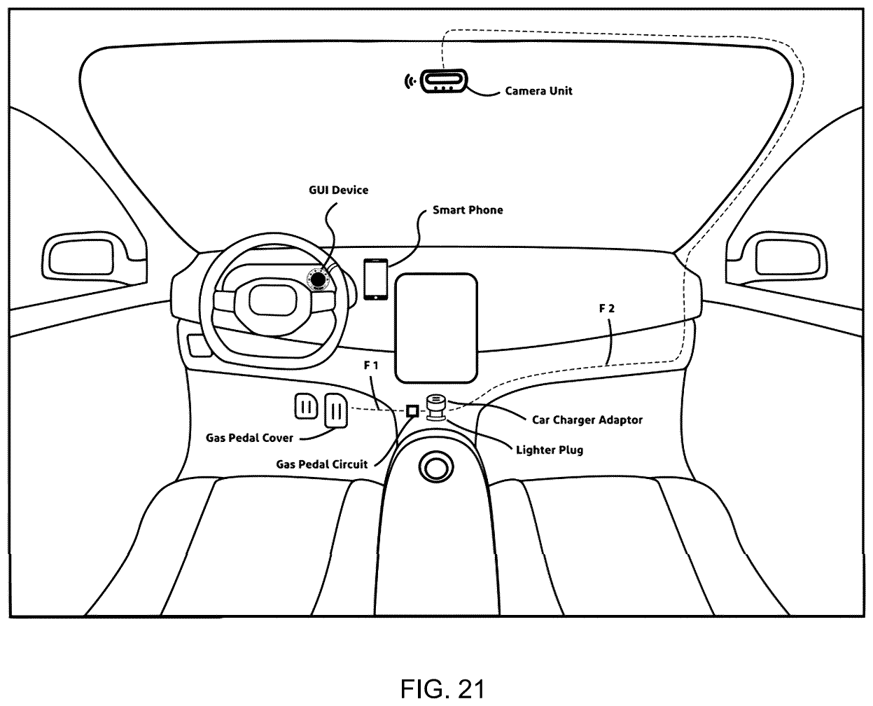

For data transmission between Gas Pedal Circuit and Gas Pedal Cover and also supplying voltage to the vibrators on the Gas Pedal cover, the wired connection is used (FIG. 22, No. F1), this wired connection in the car is displayed in FIG. 21, No. F1.

Data transmission and Connection between the Safety Alarm Bracelets peripheral unit (FIG. 22, No. 11) and road safety device version 2 are done wirelessly (FIG. 22, No. 12).

### Full Description for the Design of the Road Safety Device Version 2 and its Components (FIG. 23)

The main board and the GUI board are combined in the road safety device version 2, the block diagram and electronic components of the mainboard are displayed in FIG. 23, No. 1.

A STM32F42 9ZGT6 microcontroller with an ARM Cortex-M4 core is used in board of road safety device version 2 to control and coordinate all functions of electronic components in it.

To take advantage of the maximum performance of the processor and high response speed, no operating system has been used to launch the circuit and it is programmed with C language.

The road safety device version 2 is connected to the smartphone and interact with the desired navigation app via Bluetooth (FIG. 23, No. 1-10) and (FIG. 23, Route C),

Also, the Wi-Fi circuit (FIG. 23, No. 1-17) enable the road safety device to interact with the server of navigation apps directly without any dependency on the smartphone. In this mode the connection to the server of navigation apps is done through Route D (FIG. 23 Route D).

For maintaining wireless connection and transmitting data between the road safety device version 2 and the camera peripheral unit, the Camera Board Interface circuit (FIG. 23, No. 1-6) is used.

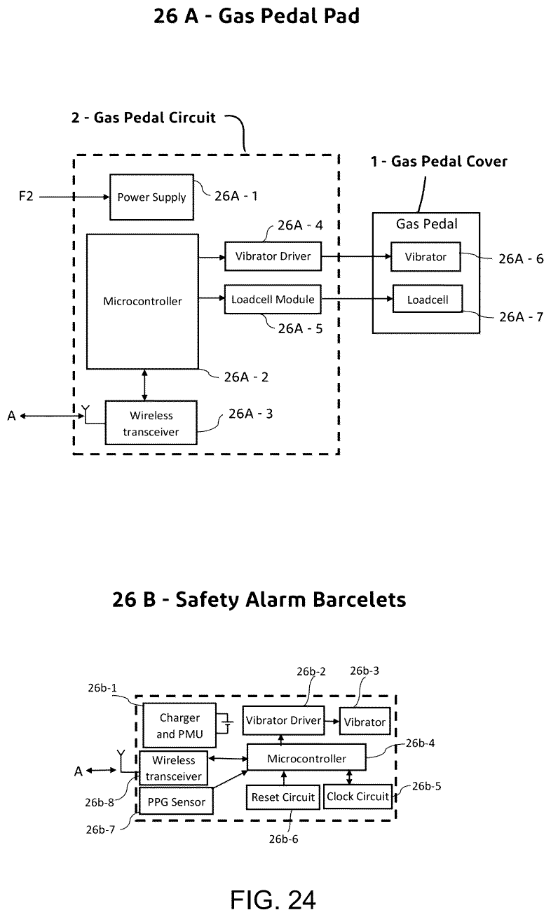

The VI interface (FIG. 23, No. 1-7) is also in charge of maintaining wireless connection between road safety device version 2 and the Gas Pedal Pad peripheral unit (FIG. 24, No. 26A) for vehicles and the Safety Alarm bracelets peripheral unit (FIG. 24, No. 26B) for motorcyclists, cyclists, and scooter riders.

### Battery Charger and PMU (FIG. 23 No. 1-1)

In addition to provide voltage for different sections of road safety device version 2, this circuit of the board is managing the power and charging of the lithium battery placed in the road safety device ver 2, it also manages power and battery charging and switches between input power and battery.

### Microcontroller (FIG. 23 No. 1-2)

The microcontroller may be embedded inside of the board to control a singular function in the road safety device version 2, doing that a microcontroller S T M 3 2 F 4 2 9 ZGT 6 with ARM Cortex-M4 core may be used. This microcontroller is responsible for receiving and processing input data from the user, including physical buttons, touch, and microphone and etc. and on the other hand, it is in charge of receiving and processing data from the peripheral units. It also starts up, controls and operates the various circuits in the road safety device version 2 board such as wireless transceiver circuits, buzzer, LEDs, round display, etc. In order to take advantage of the maximum performance of the processor and high response speed, no operating system has been used to launch the circuit, it is programmed using C language in the IAR IDE environment.

### I2S Microphone (FIG. 23 No. 1-3)

A microphone along with the relevant circuits is placed in this unit so that it is possible to receive the driver's voice messages and send them to the smartphone or server.

### Clock and Reset Circuit (FIG. 23 No. 1-4)

The clock circuit is providing the clock pulse for the correct and accurate operation of the microcontroller, and all the timings related to software and hardware functions, including the timings related to all types of serial connection which are coordinated by this unit.

The reset circuit resets the microcontroller when the system is turned on and before complete stability of the power supply and also when manually resetting the system.

### Debug and Program Circuit (FIG. 23 No. 1-5)

For ease of software implementation as well as diagnosing and fixing software bugs, a SWD port is designed for microcontroller programming and debugging.

### Camera Board Interface (FIG. 23 No. 1-6)

This circuit creates wireless connection between the road safety device version 2, camera peripheral unit or Dash Cams, so the data transmission is being encrypted.

In general, this circuit sends required data to the camera unit and evaluates the camera status through this connection. To create this connection, a radio data transmission circuit No. NRF24L01 is used in both mainboard of the road safety device version 1 named Camera board interface (FIG. 23, No 1-6) and camera peripheral unit board named camera wireless transceiver (FIG. 25 No. 3-7).

If peripheral camera unit has the capability to connect to Wi-Fi, the connection between the road safety device version 2 and the camera peripheral unit can be possible through API and route D without dependency on the camera wireless transceiver circuit and route B.

By pressing physical button on the road safety device version 2 to report road event, there are two encrypted commands which are issued simultaneously by the road safety device version 2 circuit: the first command is used to send the road event report after being processed by the microcontroller and will be combined with the required data like location (it is sent to the navigation app on the smartphone via Bluetooth or it is sent directly to the navigation app server via WIFI).

The second command along with the required data such as location, speed, direction of movement, etc. is also sent in an encrypted format to the camera peripheral unit (via Route B or D in FIG. 23) to be combined with taken photo of the road event then it will be sent to the server.

In case of hard braking or sudden change of direction and movement path of the vehicle, our road safety device checks other received data and sends the command of taking photo to the camera peripheral unit then reports the hazard automatically.

### VI Interface (FIG. 23 No. 1-6)

This part of the circuit is in charge of establishing wireless connection and issuing commands to the vibrating warning notifier Gas Pedal Pad peripheral unit (FIG. 24, 26 A) for vehicles and Safety Alarm bracelets (FIG. 24 26 B) for motorcycle, bicycle, and scooter riders.

### GPS Receiver (FIG. 23 No. 1-8)

An Ublox NEO-6M module as GPS component may be used to track and acquire user information, which communicates and transmit data with the microcontroller using a serial connection (FIG. 23, Route 1-22). To evaluate users' location validity, the system may randomly match the data of GPS module in road safety device and similar data from the smartphone.

### IMU (FIG. 23 No. 1-9)

An IMU (inertial measurement unit) is an electronic component that combines inertial sensors-gyroscopes, accelerometers and compass—to provide acceleration and orientation data that can be used to calculate position and velocity.

GPS and IMU module in the mainboard of the road safety device version 2 provide data to the microcontroller to be processed then the processed data is sent to smart phone oe server in an encoded format.

### Bluetooth (FIG. 23 No. 1-10)

As explained, the main basis of the operation of this version of the road safety device is based on the connection with the smartphone and navigation App, so for the purpose of data transfer between the smartphone and the road safety device, a Bluetooth connection has been used, and to operationalize this connection, A Bluetooth module with part number HC-05 is used. This module is connected to the microcontroller and its control is done using a serial connection (FIG. 23, Route 1-24).

### Display (FIG. 23 No. 1-11)

The display of the road safety device is a round display (480×480 pixel) that is connected to the microcontroller via SPI connection.

### Keypad (FIG. 23 No. 1-12)

The road safety device has 11 physical buttons that are directly connected to the micro ports and their status is continuously checked by the microcontroller.

### Touch (FIG. 23 No. 1-13)

A 3-mode round capacitive touch has been used around the physical buttons, which allows the user to determine the direction of the road event if needed.

### Touch (FIG. 23 No. 1-13)

A 3-mode strip ring touch has been used around the physical buttons, which make it possible for driver to determine the direction of reported road event via strip ring touch around the LCD easily with minimal distraction. The position of strip ring touch of the road safety device version 2 is displayed in FIG. 4 No. 15-16-17 (NO. 15—middle side-No. 17—right side-No. 16—left side)

### LEDs (FIG. 23 No. 1-14)

The multi-color LEDs which are placed under the strip touch around the road safety device's LCD are used to notify the driver in some situations and direction of road events. These LEDs are arranged in a circle and divided into 4 equal parts, each of these parts demonstrate the direction of the road event (left-right-middle-rear). Also, as a guide, it makes possible for driver to report the direction of road event via strip ring touch around the LCD easily with minimal distraction, the placement of these LEDs can be seen from the user side of road safety device version 2, it is depicted in FIG. 4 No. 14.

### Buzzer (FIG. 23 No. 1-15)

A buzzer is used to play different beep rhythms to notify the driver in necessary situations.

### I2S Audio Amplifier (FIG. 23 No. 1-16)

This circuit of the road safety device decodes, amplifies and broadcasts audio data. this circuit decoded the received data and by amplifying the range and power, it is delivered to the speaker then the audio messages will be notified to the users.

### Wi-Fi (FIG. 23 No. 1-17)

The road safety device version 2 also has capability to interact with server directly without involving smart phone through WIFI connection. An ESP32-WROOM-32 module has been used to operationalize Wi-Fi connection. The data received from various components and sensors of the mainboard are transferred to the microcontroller to be processed then it is sent to the server through Wi-Fi module (FIG. 23 No. 1-17).

### Peripheral Units Connected to the Road Safety Device Version 2 (for Example as Shown in FIG. 24)

### 1—Vibrating Warning Notifier FIG. 24

### Gas Pedal Pad (FIG. 24, No. 26A)

This peripheral unit is used for vehicles as a vibrating warning notifier to inform the drivers in dangerous situations by vibrating the gas pedal. The first part of this unit is Gas Pedal Cover that has a number of vibrators (FIG. 24, No. 26A-6). Also, a Loadcell sensor (FIG. 24, No. 26A-7) is embedded to detect the pressure of the driver's foot on the gas pedal. The Gas Pedal Cover made of silicone and is easily installed on the gas pedal of the vehicle by the user. A schematic diagram designed for Gas Pedal Cover is depicted in FIG. 29.

The second part of this unit is the Gas Pedal Circuit. This circuit includes a Microcontroller, a power supply and a Wireless Transceiver.

An STM32H725RGV6 Microcontroller (FIG. 24, No. 26A-2) is used to processing, controlling and managing the functionality of the Gas Pedal Circuit.

The power supply circuit (FIG. 24, No. 26A-1) is supplying the voltage of the Gas Pedal Circuit and the vibrators of the Gas pedal cover by receiving the required voltage from the vehicle (cigarette lighter plug, USB charger or etc.).

a Wireless Transceiver circuit (FIG. 24, No. 26A-3) is in charge of connecting the Gas pedal pad to the road safety device version 2 wirelessly.

### Safety Alarm Bracelets (FIG. 24, No. 26B)

The wireless Safety Alarm bracelet is used for motorcycle, bicycle and scooter riders as vibration notifier in dangerous situations by creating of vibration in the hand wrist. Safety Alarm bracelet also has a PPG sensor to measure heart rate in times of danger or accident. An emergency button is also embedded in this bracelet, by pressing it the location and request for help will be sent.

A schematic diagram designed for FIG. 24, No. 26B (Safety alarm bracelets) is depicted in FIG. 29

### 2—Camera Peripheral Unit (Camera Board).

This peripheral unit adds various automatic functions to the road safety device version 2, including taking photo automatically of the road events, detection of some road events to notify the drivers. But access to all these features depends on the type of camera peripheral unit that is connected to the road safety device version 2. The mainboard of the road safety device version 2 is designed in such a way to provide more options for connecting different type of Dash Cams or camera peripheral units to the road safety device, so camera units with different circuits can be connected to it. According to the type of camera unit features, the road safety device version 2 can provide the user with different functionalities, for example while basic peripheral camera unit is connected to the road safety device version 2, capabilities such as automatic taking photos of road event, initial matching and sending images to the server are added to the system.

By connecting the camera peripheral unit to the road safety device version 2 another problem of navigation apps is solved. As explained in the background section, in some navigation apps like Waze, there is an option to take a photo while reporting Road event but it is almost impossible.

In addition to the long and risky steps of road event report in Waze, it is impossible to take or add a photo to road event report while the vehicle is moving because by going through the required steps of road event report the driver has passed the location of the road event.

It is assumed that the speed of the vehicle is 60 miles per hour and the driver had full attention to smartphone or car display for going through steps of road event report (without adding a photo and comment) it takes at least 7 seconds but the report is not done yet.

It means that the driver's eyes are away from the road for an average of 7 seconds, which is equivalent (at 60 MPH) of driving almost twice length of the entire Football field and it entangles the driver in risky situation. During this time the vehicle has moved away from the area where road event had been seen, so taking a photo is impossible in practice. Reporting a road event with an attached image in Waze seems only logical when the vehicle is stopped for any reason.

By pressing a single physical button associated with the road event on the road safety device version 2, the camera unit is automatically activated to detect and match road events, takes photos, logs and sends them to the server. Based on the priorities and goals of our system, it is necessary to take photos and match images of some road events. The AI Engine may help determine the location and time for virtual animal crossing signs. This feature actually is a warning of animal presence in road ahead of driver based on artificial intelligence algorithm. So, it is very important to our system to collect more efficient data about animal in the road, thus when the driver wants to report an animal a photo is taken automatically and sending the proper image to the server help us to collect proper data about animals, and our AI engine has more inputs to predict animal presence in the road ahead.

In basic version of camera peripheral unit, while maintaining the production cost low, the expected performance of the camera peripheral unit is fulfilled. This version of camera is capable of taking photos automatically of the road events, initial matching and sending images to the server. This version does not have capability to identify road event automatically, but by pressing the single physical button on the road safety device version 2 for reporting a road event, the camera unit is activated automatically to take a proper image of a road events, and after matching, it will be stored.

The road safety device version 2, while providing reporting of road event in more detail just by pressing a single button, also enables automatic taking photos of road event without the driver's intervention. In addition, the developers can use road safety device version 2 features to verify the reported Road event and prevent fake reports of road event, also they can use the other features of the road safety device version 2 by connecting to the camera unit, for example automatic taking photo of the required road event, image verification and validation of user reports.

Users who have smartphones with good camera quality also can use their smartphones instead of the basic Camera peripheral unit. It is enough to place the smartphone on the holder of the dashboard in such a way that it is calibrated with the road (FIG. 11). Then the smartphone camera does the same jobs like Camera peripheral unit and taking photo without the driver intervention and without displaying it on the smartphone screen.

Using the road safety device version 2, in addition to the ease of collecting more and efficient data, allows navigation Apps developers to add more features to their Apps which is currently is not practical for them.

### Road Safety Device Version 3:

The road safety device is made for pedestrians, passengers and vehicle occupants and vehicles for the handicapped persons

These users have different categories. For example, handicapped persons, the elderly, children, etc. can connect to the system using their smartphones after creating a special avatar (in three ways), and in addition to providing security, they can benefit from the system's facilities and if they have appropriate legitimate behavior also receive SCT as a reward with the amount of validity and approval degree according to the POH algorithm. In addition to connecting using their smartphone Apps, users can use different or combined methods as follows to receive validity and an exact verification.
A: Using a smartphone or smart watch and staking the system token (as a validator)
B: Using a smartphone and connecting it to the road safety device via Bluetooth
C: Using a smartphone without staking the project token and without a road safety device (which will have the lowest validity and approval value and will receive the lowest reward in case of proper activities. Of course, the validity of IOS operating system users is higher than Android users which is given complete explanations in the corresponding section. These people can connect to Transportation metaverse by using their small road safety device and their own avatars and receive notifications of high-risk areas such as crossing the main street, drivers approaching the danger zone. With this method, their safety on the streets is ensured, and they can also report road events.

### System Architecture and Software Engineering

### The Road Safety Contribution Token Reward System

The system includes a road safety device, a POH algorithm, artificial intelligence algorithms and distributed ledger technology (e.g. blockchain technology), and a Safety Contribution Token and representation of road segments, V2V and V2X communication where the system collects, stores and provide transparent access to road incident data to improve road safety. The system associates the real world roads to the virtual representation of the road segments recorded using distributed leger technology.

In this SCT system, the road-based SCT Reward provided incentives for contributors with a transparent distribution reward (SCT). In the SCT Reward, the road-based rewards provides contributors with a transparent distribution reward (SCT).

Here are some of the features of these road geo-tiles: road type, number of roads, angle and direction of movement on the roads, speed limit, the length and width of the road, road signs, cameras, fences, road lighting facilities and parameters of the surrounding environment of the roads (ecosystem and the habitat) which will be explained in more detail later. Also, by validating, the contributors data stored in these blocks and be stored in the distributed ledger through smart contracts. The value of these geo-tiles may be determined based on the weight of some of their features such as daily transportation volume, user contributions, etc. Also made it practical to implement AI based prediction of animal presence in the road and pattern recognition of movement of animals on the roads in different conditions.

Using the POH algorithm, this system enables real road participants (drivers, vehicle occupants, and pedestrians) to store valid data using distributed ledger technology in multiple road geo-tiles and earn money. The road safety device facilitates the process of storing data in the distributed ledger by drivers without distraction while driving and vehicle automatically. Users who do not have a physical presence on the roads, buy a road consisting of multiple blocks as NFT, and by doing this, they earn daily revenue from the purchased roads and increase the safety of their roads.

In this system, users always benefit from the acceptable behavior and data sharing and other activities based on POH algorithm and receive SCT rewards. Also, Users' avatars evolve based on their activities and the validity of their avatars change, which is effective in the amount of SCT they will receive. our system's API functions help developers to join this ecosystem and work together to accelerate the expansion of V2V and V2X communication on roads and transparent and up-to-date data collection to protect humans, animals and the environment.

As mentioned, in this system, the road geo-tiles have different layers of data that are used as dataset features for the AI engine of our system to create an AI-based “animal crossing road sign”. This feature predicts the presence of animals on the road ahead of the driver and inform the driver. This feature is a suitable alternative to currently physical signs on the roads, which are not useful for drivers.

In this section, the focus is on predicting the presence of animals on the road ahead and the likelihood of the driver facing the animals. This method may also be used for other occasional road signs. Referring to FIG. 13, AI based prediction of animal presence being informed the driver by the road safety device screen. The system may also inform the driver by electronic road safety devices like smartphone or car display.

The road safety device may be designed so it can be connected to new and old vehicles and be compatible with vehicle screens operating systems. There is no need to activating navigation to use the SCT system. Also, vehicle manufacturing companies can benefit from the functionalities of the system using a customized road safety device or API so that drivers can receive notifications in dashboard or car display to bring more safety to themselves and vehicle passengers. Also using API, navigation App platforms and ride-hailing apps platforms such as Uber, Lyft, etc. can use AI based prediction of animal presence to their users on smartphones or vehicle screen or other electronic road safety devices.

With some new technologies, along with benefits and conveniences brought there may also be disturbances in existing status quo and new problem may be created for future generations. Motor vehicles are one such example where the increase of motor vehicles caused an increase in environmental pollution, the development of transportation infrastructure; the more detailed, validated, up-to-date and integrated data regarding the movements of different species of wildlife then their movement changes and collisions hot spot are being collected, researchers can speed up scientific progress and recognize new environmental patterns. Then, experts and policy makers can make better decisions for effective investment to build transportation and road infrastructure compatible with wildlife and road safety.

The SCT System looks to increase the rate of participation and the speed of collecting accurate data. This data includes the roads events and surrounding environment ecosystem data as well as related anomalies data, etc. These integrated data, which have been stored in multiple blocks and categorized layers, will be available to researchers and experts in the field of environment. This group of users can participate in the evaluating and collecting of relevant data by using the POH to ear SCT as rewards. Also, the system may evolve the user's avatar by evaluating and validating their activities.

Due to the data transparency and decentralization in this method of collecting data, in addition researchers and experts in the field of environment the system may allow the residents of different regions to access to the environmental phenomena and related anomalies in their regions. So, they can take action to assert their environmental and ecosystem (nature) rights and that of the future generation by communicating with local representatives.

### POH Algorithm

The various components of the system, along with distributed ledger technology, enable the creation of road-based SCT reward within the framework of a Decentralized Road Safety system. The reward system, in addition to increasing the speed of collecting the required reliable and transparent data and making efficient use of this data, can lead to financial rewards for the users, which may encourage contributors to join the Decentralized Road Safety ecosystem.

In the system, the virtual roads may be divided into multiple data blocks that have various features with different weight and also include users' data that are used in the artificial intelligence engine. The price of each geo-tile may be calculated using the weight of these features, such as the daily traffic volume and user contribution. These roads may be bought and sold by users around the world as NFTs, and the owners of these NFTs are the owners of the Transportation metaverse road, its data, and the earning of the roads is sent to their cryptocurrency wallet after being calculated by the POH algorithm.

Each road geo-tile is surrounded by adjacent geo-tiles that may not even have a road in them, but considering that the value and weight of the these geo-tile features is also effective in road conditions, the system is designed in such a way that the values and weight of the geo-tiles surroundings of the roads affect the values and weight of the road geo-tile features, With this method, the artificial intelligence engine will have more optimal learning and predictions and better patterns of animals movement on the roads will be recognize.

The system may implement a geographic coding method termed Geographic Event Hash (GEH), utilizing Geo-Hash with 12-digit floating point precision to optionally identify each geo-tile. This method may incorporate parameters such as time, bearing, NFT address, and other event-specific data to create a potentially unique identifier for events reported by users. Each GEH could uniquely identify an event, capturing it with millisecond accuracy and measuring the event's distance from the route in degrees from north. This capability allows for the potential precise storage and maintenance of user communications and interactions within the POE layer, using exclusive GEH. Additionally, Geo-Hash, along with distributed ledger addresses that include movement and time data, may be integrated into a single hash-based code, offering a framework for tracking and validating events.

### 1—Validating

Validation is done in two steps. The first step for avoiding displaying wrong or unreal road event to other users. For this purpose, in this step, the artificial intelligence engine evaluates the input data from the user side. The data that are evaluated in this step are as following: 1—the validity of the user avatars (user activity avatar and vehicle avatar) 2—the values of the data that has been sent along with the road event report from the user's road safety device 3—the appropriateness of the road geo-tile that is currently user traveling on with the event reported by the user.

The second step is done after displaying the road event to other users. In this step, evaluation and calculations of different ranks of reported road event are done using automatic or manual responding of users.

Acceptable behaviors and activities of users on real roads (data sharing, reporting road events and responding to them) will be rewarded (SCT). These rewards are calculated according to the functions of the POH algorithm and its artificial intelligence engine dataset.

### 2—Storing Int the Distributed Ledger, Rewards Calculation and Service Price Determination

Varied ranks of road event reported by users are calculated by POH algorithm. These ranks are used to confirm storing procedures in the blockchain and to calculate the reward of users (SCT) who were involved in reporting the road event or responding to it, and also to influence the validity of the user avatars features (user activity avatar and vehicle avatar).

In this system, various groups of users are contributing or using the services. The POH algorithm in addition to the reward calculation for contributors using various parameters evaluation, it also calculates the service price for consumers.

### 3—Making AI-Based “Animal Crossing Road Sign”.

Using system components and road geo-tiles which include features with distinct values and weight, the artificial intelligence engine makes machine learning and calculations operational to discover different patterns of animal presence in ecosystems and diverse conditions. This makes it possible to accurately calculate the prediction of an animal appearing on the road ahead of the driver, and by adding the user's movement data and analyzing it, custom-built notifications based on the driver's behavior are displayed to users

FIG. 58 illustrates a block diagram 5800 for the POH algorithm along with artificial intelligence engine.

### 1—Validating (Validity Calculation)

The system receives a set of input from the first group of users. The inputs include information regarding real world roads and streets, 5801. The data received includes: 1) data sharing (automatic), 2) reported road events (automatic, manual), and 3) reaction to the reported road events (automatic, manual).

The artificial intelligence engine validates data and removes reports for example for being duplicates or invalided. The validated data is stored. The AI Engine performs validating in two steps, specifically 1) displaying the event and receiving feedback on it veracity, and 2) calculating a final rank.

In the first step, displaying road event to the other users the POH algorithm 5890, the artificial intelligence engine evaluates the data received as follows. verifying the report's associated avatars are valid, both the user activity avatar 58903 and their vehicle avatar 58902.

2—the Values of the Data that has been Sent Along with the Road Event Report from the User's Road Safety Device FIG. 58901
3—is the Road Event Appropriate for the Road Geo-Tile that is being Reported on 5894

artificial intelligence engine performs the necessary calculations for the verification of the report and allows displaying road events to other users traveling on the same route.

### Second Step: Calculation of the Final Ranks

In the first step, by getting the necessary validity rank, road event displayed to users of the same route, and users (having different avatars validity) react automatically or manually to confirm or deny the road event, then POH algorithm calculates ranks of road event. These ranks are used for displaying continuity, displaying stop, confirm to storing in the blockchain and calculation of the SCT rewards for users who were involved in reporting the road event or responding to it, and also it is used for effect on the validity of avatars features for the involved users (user activity avatar and vehicle avatar).

The value and price of the road geo-tiles are determined by calculating the values of different features of road geo-tiles using the artificial intelligence engine FIG. 58 No. 9. This way the rate of system services such as advertising and campaign creation, virtual ride, etc. is determined in different routes, and finally calculation of the users' SCT reward based on the price of road geo-tiles and the validity of user avatars and the results of their activities. The system may divide the dataset of the AI engine into three general categories, in order to better describe this AI engine and the performance of POH dataset algorithm. The categories are as follows:
1—Features of the road event being reported by the user (the values of the data that has been sent along with the road event report from the user's road safety device) 5891.
2—Features of user activities avatar and features of vehicle avatar 5893, 5892.
3—Features of road geo-tiles 5894.

Combining these three categories, the artificial intelligence engine deals with training, testing, learning, decision making and calculations.

### 1-1: Road Event Features 5891:

As explained, the validity of the features of the user's avatars and the values of the features of the blocks in which users are traveling and perform activity along with the values of the features of the road event they are reporting, play a decisive role in the decision making of the artificial intelligence engine for matching and displaying road event to other users.

Road event features 5891 being reported may be as follows: user type, user category, type of network connection, road event type, grade of importance of the road event, direction and angle of movement, road type, time, light condition, weather, speed, etc.

The road event features 5891 may include a field ‘Wallet Validity’ with potential values A, B, C, D, or E.

The road event features 5891 may include a field ‘Season & Month’ with potential values Spring with months March, April, and May; Summer with June, July, and August; Autumn with September, October, and November; and Winter with December, January, and February.

The road event features 5891 may include a field ‘Directions’ with potential values North, South, East, West, North-East, North-West, South-East, and South-West.

The road event features 5891 may include a field ‘Road safety device Type’ with potential values Version 1, Version 2, or Version 3.

The road event features 5891 may include a field ‘Registration Channel’ with potential values Road safety device, Mobile App, or System Website.

The road event features 5891 may include a field ‘Driver Type’ with potential values Personal, Organizational, or Fleet service.

The road event features 5891 may include a field ‘Weather Condition’ with potential values Cloudy, Dizzy, Hot, Rainy, Snowy, Storm, and Foggy.

The road event features 5891 may include a field ‘Time’ with potential values Dawn, Morning, Noon, Afternoon, Evening, or Night.

The road event features 5891 may include a field ‘User Types’ with potential values Cyclist, Motorcycle rider, Scooter rider, Pedestrian, and Passenger.

The road event features 5891 may include a field ‘Speed’ with potential values High, Low, or Moderate.

The road event features 5891 may include a field ‘Car Types’ with potential values Lightweight cars and Heavyweight cars.

The road event features 5891 may include a field ‘Peripheral Parts’ with potential values Basic Camera, Advanced Camera, Vibrating Alarm, and VR 360 CAM.

The road event features 5891 may include a field ‘Week of month’ with potential values First, Second, Third, or Fourth.

The road event features 5891 may include a field ‘Anomaly Types’ with potential values Crash, Object, Stopping the car on the road, Hazard, Pit, Construction, Ice road, Storm, Fog, Dead Animal, Live Animal, and Children playing.

For example, one of the most effective features in validating reported road event is the type of network connection. To start performing file a report, the source of the data matters. The data may reach the system from various sources, for example from the smartphone app 6306, API 6304, or a road safety device 6308. The source of the data may pass through a combination of sources for example starting on the road safety device 6308 and passing through the smartphone app 6306. The source of the data changes in the amount and validity of the data which is sent to the network by the users, for example, a user who connected to the network using road safety device version 1 in a vehicle has a higher initial validity than other users, because road safety device version 1 is connected to the vehicle through OBD2 is capable to share vehicle data parameters like engine speed, fuel type, fuel consumption, etc., this data in addition to the shared data by the other network connection type like sharing location, direction of movement, speed, acceleration, etc.

The user activities and results change validity of the user activity avatar.

### 1-2: User Avatars Features FIG. 61

Each user has two avatars. User's activities avatar and user's vehicle avatar

### 1-2-1: User's Activities Avatar

In order to connect to the transportation metaverse the road safety device mints an avatar (a vehicle avatar, a user activity avatar, or both), the avatar may be a NFT (Non Fungible token), this avatar's features may evolve over time based on the contribution in the real roads and streets 5801 and other contributions, for example including recorded environmental activities 5806, recorded Points of Interest (POI) 5807 and recorded investments 5808. The results for all the mentioned activities make changes in the validity of the user activity avatar. The validity of the user's activities avatar is one of the influential factors in validating a road event report or other anomalies and calculating SCT reward for their activities. Furthermore, the user's activities avatar can be bought and sold in markets such as OpenSea. The validity of these features is displayed in the marketplace as an avatar attribute that determines the price of the avatar.

The records and activities performed by the user in the mentioned categories will bring results to form the validity of the users avatars. Various features have been defined to evaluate the validity of the user's activities avatar in the system, which are defined for each activity category according to its role. In this system, the user's activities avatar can work with different roles like pedestrian, driver, passenger, navigation software user, cyclist, etc. and according to these roles and performing various activities, provide different data to the artificial intelligence engine so that the system uses them to weight all users activities to evolve their avatar.

For example, when the user's avatar is identified as a driver, the effective features include as follows: type of road safety device and accessories connected to the our system network, number of blocks and traveled mileage by the avatar, the status of compliance with driving rules and standards, level of contribution in sending reports and its results, responding to the other users' reports, the number of reports stored in the distributed ledger by the user and owned reward NFTs, the amount of wallet validity, the amount of SCT wallet transactions, the amount of user's purchased NFTs, the amount of SCT staked, the amount of environmental activities and the results, the amount of POIs suggestions and the results of the users' rank rate, etc.

The user's activities avatar in any role, then the effective features related to the same role will also change. Therefore, two subcategories of specific and public features are defined for each role, and the system generates diverse data according to the specific and public features extracted for each of the user's roles, then the generated data will be analyzed by the artificial intelligence engine of the system. The data value of each category is specific to the role of the user's avatar, and in addition to affecting the validity of the desired category's feature, it also affects the overall validity of the user's avatar. The value of user activities avatar data is weighted in any role classified as private and public. The weight of each data is actually a coefficient that takes its value from the role of user activities avatar. The weight of the data is the amount of validity of the data in the network which plays a positive or negative role.

### 1-2-2: Vehicle Avatar Validity FIG. 56_A (9-3)

Vehicle Avatar validity data 56903. The user can mint several vehicle avatars as NFT by having several vehicles. For example; car avatar, bicycle avatar, scooter avatar, mobility scooters avatar for handicapped people, and etc. The user can switch to the related avatar while using any of the vehicles.

Motor vehicle avatars have two modes, Connected To Vehicle (CTV) mode and Not connected To Vehicle (NTV) mode. NTV can mean the avatar is not connected to the vehicle, some times the avatar may not have the ability to connect to the vehicle.

Vehicle avatars that are connected in CTV mode will be verified and will have high validity and provide more SCT rewards. The structure of motor vehicle avatars has features that are used to evaluate their validity. These features are categorized into general and specific categories. The avatars of both modes (CTV and NTV) have general features, but while they are placed in CTV mode, they have specific features related to the vehicle category (Electric vehicles, internal combustion vehicles, hybrid cars).

Road safety device version 1 with the ability to connect to the car, provides the possibility of connecting the avatar to the vehicle and running in CTV mode. Due to the various data received by the motor vehicle, the validity and weight of the specific features of the vehicle avatar are evaluated, which affects the overall validity of the vehicle avatar.

Some of the specific features of the motor vehicle in the internal combustion category may be as follows: Real-time parameters: RPM, speed, pedal position, spark advance, airflow rate, coolant temperature, fuel consumption rate, emission rate, mileage rate, etc. The general features are data which are received from the user during the creation of vehicle avatars, their validity is performed based on the user category of the vehicle avatar during the time the user performs activities. The user can purchase and add NFTs from the marketplace to increase the validity of some general features of the vehicle avatar. Non-motorized vehicles, bicycles and scooters, etc., can be connected to the vehicle's avatar through the road safety device version 2, but this connection is mostly used to verify non-motorized vehicles, and in this case, they will have more validity than bicycles and scooters which are not connected to the road safety device.

### 1-3 Features of the Road Geo-Tiles

One of the effective factors for validating the road event rank and the initial validity of the road event reported by the user is values of the features for road geo-tiles in a region or road network.

The system may preprocess street map data (for example, OpenStreetMap data) and extract features for all the blocks on the ground. For example, the system calculates and separates the roads in each geo-tile and added the road and the road distance as a feature of the geo-tile as a road distance attribute.

A virtual road is comprised of set of geo-tiles. The data associated with the geo-tile differentiate the values of the geo-tile features. Using these geo-tiles and features values of them, the AI engine may predict the animal presence in the road ahead of the vehicle.

Geo-tiles of the road network are connected with adjacent geo-tiles of the ecosystem in order that the features of the surrounding areas may be added to the features of the road geo-tile, because the features of the ecosystem adjacent to the road geo-tile are useful for the AI engine to make prediction about the road geo-tile, for example useful for predicting the presence of animals on the road ahead of the vehicle.

In addition to the street map data, other sets of data may be added to the road geo-tiles to add more capabilities to the AI system. Datasets such as road collision records, validated road event reports, various vehicle activities, also play an role in choosing effective features for the decision making of the AI engine to predict condition on road geo-tiles like the presence or increased likelihood of animals on the roads.

### Road Geo-Tile Schemas in the System:

### 1—First Schema: OSM

Containing processed OpenStreetMap data, which includes the features of all roads and ecosystems, all are stored and classified in different layers. Some of these features are: type of road, speed limit, length and width of the road, road signs, cameras, fences, road lighting facilities, etc. Some features of the ecosystem are: type of area (residential, commercial, forest park, forest, agriculture, etc.), landscape, vegetation, pond, river, weather, animal species, pollution rate, etc.

### 2—Second Schema: Valid and Verified Data

This schema includes three layers (categories) of data which are stored as features of road geo-tiles based on location and road type in the corresponding layer.

### 2-1: The First Layer (POE):

This layer contains the dataset of road events and anomalies reported by the users, which has been validated and ranked by the POH algorithm. The layer is called point of event (POE).

### 2-2: The Second Layer (POA):

This layer includes processed dataset related to official and valid data of collision and accidents in different regions of the US. The data have been collected by various institutions and law enforcement organizations. The layer is called point of accident (POA).

### 2-3: The Third Layer (POP):

This layer includes the dataset of environmental pollution like waste pollution, water pollution, visual pollution, land pollution, plastic pollution, which has been reported by users and has been evaluated, validated and ranked by the POH algorithm. The layer is called the point of pollution (POP).

### 2-1 Point of Event Layer (POE)

The category with a separate layer (POE) is dedicated to store road event or anomalies which have been reported by the user group of contributors in the real roads FIG. 56 (1) and all are validated according to the POH algorithm. In this layer, all validated reports are stored using an exclusive Geohash (GEH). Some of the road event or anomalies are as follows:

Users are able to report road event or anomalies (child safety, crash, object on the road, vehicle stop on the road, hazard, pit, fog, water congestion on the road, ice road, road maintenance, dead animal or live animal on the road, police, speed trap) just by pressing a single button without distraction. Lighting LED around the GUI road safety device (FIG. 14) remind the user in some of these reports to specify the direction of road event (Middle of the road, right shoulder, left shoulder) easily by pressing one of the three mode touch (Right, Middle, Left) placed around the GUI road safety device (FIG. 4, No 15, 16, 17).

### 2-2 Point of Accident Layer (POA)

The category with a separate layer (POA) includes a dataset related to the official and valid pre-processed data of road event and collisions on various roads in the US, which have been collected by various institutions and law enforcement agencies. In this layer, the system has added the collision records which have several features for the system AI engine. This data is added to related blocks according to the location.

One of the important categories in the system is animal collision records with related features which in this dataset the system has access to. This category, along with other components of the system, help us to implement the prediction of the presence of animals on the roads using an artificial intelligence engine. This dataset is updated periodically. Some of the most influential features of animal collision records in our AI engine are as follows:
Crash Date, Collision Type, Weather Condition, Light condition, Road Type, Roadway Surface Condition, Roadway Surface Type, Roadway Defect, Intersection Type, Traffic Control Type, Animal (Yes|No), Distracted (Yes|No), Pedestrian (Yes|No), Speed (Yes|No),
School Zone (school_zone), Night (Yes|No), etc.

### 2-3 Environmental Pollution Layer (POP)

The category also has a separate layer that is called point of pollution (POP). The two previous layers were related to road data, but in this layer environmental contributors FIG. 58 No. 8 can share places or points of various environmental pollution and anomalies. Other users can view pollution with accuracy and rate after validating these points by POH algorithm. These pollutants include all kinds of visible environmental pollution, including residual pollution, water pollution, and visual pollution.

### 3—Third Schema:

This schema has three layers (categories).

### 3-1 Campaign Layer

Creating a campaign, individuals or organizations can create a new layer on road geo-tileroad geo-tiles, storing of user data in the relevant layers does not change by this. User data is always stored in dedicated layers. The price of creating a campaign is determined using POH algorithm analysis and according to the type of campaign. By payment using SCT, access permission for data of different layers based on type of campaign is given to the owner or managers of the campaign. The SCT reward of contributors or owners of the road in an area will be increased by POH algorithm when a new campaign is created.

### 3-2 Advertising Layer

In this layer, advertiser userID can setup the system to display advertisements to the contributors by selecting road geo-tiles and paying the costs using SCT. This section includes settings that enable the advertiser to apply various filters, like displaying an advertisement to a certain number of contributors or set displaying the period time of an advertisement, etc. Advertising cost will be calculated based on budget, price of blocks, number of views and number of interactions. The SCT reward of contributors or owners of the road in an area will be increased by POH algorithm when a new advertising campaign is created.

### 3-3 Point of Interest Layer (POI)

In this layer, users can send their feedback rate directly without mediation or suggestion (direct mode) for transportation metaverse or physical businesses like stores, entertainment centers, educational centers, restaurants, etc.

Users also can find a place through mediation or suggestion from other users (POI suggestion). This kind of experience and feedback rate which is formed by suggestion is known as mediated (indirect mode) feedback, and in addition to influencing the overall rate of the business, it will have an effect on the value and weight of a POI suggestion trust feature specific to the user's avatar in which the user suggested it (POI).

This feature caused the effectiveness of user feedback rate not to be the same.

Suppose the maximum and minimum rate are 5 and 1 respectively. Now consider two users A and B who contribute to send feedback. The feedback rate for the said business is given by the user A and B, 3 and 5 respectively.

Each user will have different coefficients from 1 to 10. User A, who has an activity avatar with a high weight for the POI suggestion trust feature, gets coefficient 10, as a result his score is calculated as 30 out of 50, for user B, who has a low weight for the POI suggestion trust feature, gets coefficient 2 and his score is calculated as 10 out of 50.

(User A feedback=3)*(User A coefficient from POI suggestion trust feature=10)=(Rate score which is applied for business=30)

(User B feedback=5)*(User B coefficient from POI suggestion trust feature=2)=(Rate score which is applied for business=10).

Another feature that is checked by the system to insert the feedback rate for physical businesses with a location is the value of the distance and validity of the user location. This feature (the distance between the feedback giver and the business) has a coefficient from 1 to 5.

Users in the POI layer do not receive SCT rewards for their activities, but according to the followers' reviews, their activities will have an impact on the weight and value of the POI suggestion trust features of avatar. Subsequently, it affects the overall validity of the user avatar. This validity will affect POH algorithm calculation procedure of SCT rewards for other activities with capability to earn reward.

### 4—Fourth Schema

This schema has different layers (categories) including:

Avatars, Road safety devices, Transportation metaverse Online Store, GIS layers, POI verification logs, authentication, access control and—tracking GPS point tables.

### Validating Process of Road Event Reported by the Users

### The First Step: Displaying Road Event to the Other Users

Using the road safety devices, smartphone app or API, Contributors in the real streets and roads are able connect to the V2V, V2X communication system and start doing different activity, for example:
data sharing (automatic); submitting road event reports (automatic, manual); and reaction to the road event reports (automatic, manual).

AI engine FIG. 58 No. 9 using the features of the road event or anomalies being reported by the user FIG. 58 No. 9-1 and the features of road network blocks in which the user is traveling FIG. 58 No. 9-4 and the validity value of the user avatars features FIG. 58 No. 9-2, 9-3, performs validating in two steps. In the first step, deciding to display the road event to the other users, and in the second step, determining the final rank and calculating the SCT reward and storing in the distributed ledger.

### Ranks Definitions:

### Rank Y (FIG. 58 No. 9-8):

The artificial intelligence engine calculates the rank required to display each of the various road events or anomalies in the road using variables and values of the road geo-tile features.

### Rank X (FIG. 58 No. 9-7):

X is the Rank of reported road event.

When the user reports a road event, the engine calculates the Rank X based on the three items:
1—The features value of the user's avatars.
2—The features value of the road event being reported.
3—The features value of the road multiple blocks that the user is traveling on.

If rank X is greater than or equal to rank Y, the road event is displayed to the users of the same road. Simultaneously, Rank S and Rank T are calculated (rank S FIG. 58 No. 9-11) (rank T FIG. 58 No. 9-12). Then rank S and T calculated to specify the time of the stop displaying.

Simultaneously, rank Z FIG. 58 No. 9-13 as a required rank of the road event to be stored in the distributed ledger is calculated.

### Second Step: Calculation of the Final Rank

After validating in the first step, reported road event display to the other users in the same road. Simultaneously Rank Q is activated for calculation.

Rank Q FIG. 58 No. 9-10 is a variable rank which starts to change according to the type of true or false responses of users to the report and the time passing. Each user's influence on increasing or decreasing the rank Q is not the same. The influence of users' responses on the rank Q depends on the validity of their avatars' features. If the Q rank falls below the defined S rank without any increase, displaying of the road event to the other users will be stopped, it means that the road event was wrong and will have a negative impact on the validity of the user's activities avatar features.

If the rank Q increases with the users' confirmations, the displaying of the road event to the other users in the same route will continue, and if this rank rises above the defined rank Z, this road event will be stored in the Distributed ledger, then the SCT reward is calculated and sent to the user's wallet.

If the rank Q decreases after an increasing process and passing time, it means that the road event or anomaly was correct but it has ended. For example, there was an object in the road, but after one hour, this road event has been resolved, now the users responding with disconfirmation causing the Q rank to decrease. When this rank is lower than the rank S, displaying the road event to the other users will be stopped.

If the rank Q increases but does not reach the defined rank Z, it means that the road event is true but it does not get enough score to store in the Distributed ledger. But it will have a positive effect on user avatar feature validity and the amount of SCT reward.

Rank T is the rank of time. If the users are not passing by or not responding to the road event report and no changes made in rank Q, Rank T determines the stopping displaying time of the road event. Rank T is not a fixed Rank in different situations. It will be changed according to the validity of the user avatar, importance and features value of reported road event, as well as the values of the features of the corresponding road geo-tileroad geo-tiles. The performance process of these ranks is shown in FIG. 60.

The user's records which created the avatar features of his activities are effective in validating, increase of the Rank X above the defined Rank Y.

The type of road safety device and the accessories connected to it, is one of the effective features for validity rate of the road event being reported, which has a great effect on the rise of the X rank above the defined rank Y. The features of the road event or anomaly being reported can be seen in FIG. 59, the weight for each of these features is different in the initial validation phase.

Type of network connection, type of road safety device and peripheral road safety devices connected to the network, are some of the features affecting the validity of the road event report.

As described in the background section, everyone with Android phones can report a fake road event thousands of miles away on a road easily just by creating a fake location in navigation Apps like Waze. In our system, the location of the user has a validity rank (the validity of the location feature). For example, a user who is reporting a road event or anomaly using an Android phone has less validity than a user who is doing this using an iOS phone.

An Android phone user can increase the validity of his location by connecting to our road safety devices. This process provides for the system to validate the location of a road event being reported. This process takes 50 to 100 milliseconds. In this process, the GPS embedded in the road safety device circuit evaluates the location of the road event being reported. The road safety device compares the user GPS route taken from different apps with the data of the embedded GPS module and encrypts the confirmation result with a unique identifier before sending the event. If the data is verified on the server side, the system will assign the road event or anomaly the highest validity score to the location feature in the first validating phase.

While a camera is connected to the road safety device as an accessory, a photo is taken automatically from a road event being reported, and then it is sent to the server to be evaluated by the object detection module. If a reported road event is detected in the image, Rank X will be higher than Rank Y and it will be placed above Rank Z without users' confirmation, then it will be stored in the Distributed ledger. The performance process of the ranks in this case is shown in FIG. 61. In this case, SCT reward calculator engine FIG. 58 and FIG. 61 No. 9-5, needs the influence amount for the reported road event to calculate the SCT reward of the corresponding road event. Therefore, the maximum value of the Rank Q, the duration of the road event display, the number of times it is displayed and other values are sent to the engine.

### 2—Storing in Distributed Ledger and SCT Reward Calculation and Service Price Determination of the System

Each geo-tile has fixed boundaries in which some roads are placed on. The price of each road will be determined based on the features value of the road geo-tiles and supply and demand.

The following are some of the features affecting the price of a road geo-tile: type of road network, length of the geo-tile roads, daily transportation, user interactions, ranks, number of POEs stored in the distributed ledger, number of POAs stored in the Distributed ledger, number of advertisement and activated campaigns on blocks, etc.

The private key that controls these NFTs controls the Transportation metaverse roads and the data of the set of geo-tiles that make up the road. The earnings by the various activities recorded in the transportation metaverse from on the real world roads is calculated by the POH algorithm, then it is sent to be under the control of the private key that controls the NFTs.

Virtual road controller userIDs are associated to the real world roads and they access some feature to monitor and increase the safety of their own roads to increase their SCT rewards. Also, the owner can apply certain policies to the purchased road geo-tiles.

Road owners can purchase virtual speed control cameras as NFT and add them to their roads. If the speed of the avatar of the user's driving activities exceeds the limit, the avatar of the user receives a virtual traffic ticket, which he is obliged to pay. Continuing to receive traffic tickets will have a negative effect on the validity feature of the compliance with driving rules of the user avatar. A percentage of the earnings from virtual traffic tickets payment are sent to the private key of the virtual road controller.

If the users have activated the advertising service, they are able to earn extra SCT. The road owner can activate the advertising at certain road stations and display it for a few seconds on the road safety device or smartphone app of the user who stopped. A percentage of the advertising earnings belongs to the road owner and user.

As explained earlier, individuals or organizations with different goals can create and launch a campaign by creating new layers on the multiple blocks of the road. The price of creating a campaign is determined according to the type of campaign and POH algorithm analysis. Paying the costs of creating a campaign is done using SCT then according to the type of campaign, access permission to the information of various layers will be given to the owner or admins of the campaign.

These campaigns make possible data collecting and free access to decentralized and transparent data (without violating users' privacy). The SCT reward of contributors in the area of those blocks increases by new campaigns on the road geo-tiles. A percentage of the campaign's earnings belongs to the road owners and some of the earnings is returned to the treasury of the system to control inflation. Also, a percentage of Transportation metaverse taxis earning belongs to the owner of the roads.

As the Transportation metaverse system grows, road and land owners will be able to create virtual 3D locations on their blocks. The owner can create and upload 3D models to be viewed on the map and allow passengers to interact with it. Furthermore, the owner can set up businesses on the blocks adjacent to roads or other blocks without roads, make advertising, broadcast a public radio channel, or create games and complements for travelers passing through their blocks. The price of all services like advertising, campaigns, Transportation metaverse taxi trips, etc. is determined by the POH algorithm based on the price of road geo-tiles and the applicable policies of the road owner.

### 2-1: SCT Rewards for Users Who is Contributing in the Real Roads and Streets

All acceptable activities and behaviors of users on the real roads (data sharing, reporting Road events and responding to them) will be rewarded. SCT rewards for users are calculated by the POH algorithm using the artificial intelligence engine dataset. As it has been fully described in the previous sections, user avatars, road multiple blocks, and user-reported road event have various features with different weights. The combination of these features and their values are also used for user SCT reward calculations.

The function of SCT reward calculation for users is a fraction in which the distance traveled by the user is the numerator and the value of user avatar validity is the denominator.

### 2-1-1 how to Calculate SCT Rewards for Users Who Travel on the Roads (Data Sharing)

Suppose there are two users, A and B who are connected to the network and they are traveling on the roads, then there are three parameters for calculating their reward, in general, they are as follows:
1—Values of the road (that is the value of the set of geo-geo-tiles) that the user is traveling on.
2—The validity of the user activity avatars.
3—The validity features of shared data.

The first parameter: one of the features of multiple geo-tiles of road is the value.

In the function, the sum of the values of multiple geo-tiles of the road traveled by road safety device is placed in the numerator of the fraction.

The second parameter (validity of user activity avatar): This parameter is the result of a function, when the validity of the user activity avatar increases, the output is numerically reduced. This parameter is placed in the denominator of the fraction. The third parameter: The validity and the number of features for the shared data by the user which is used as a coefficient in the result of the fraction for two mentioned parameters. The type of connection to the network determines the validity of the data. For example, road safety device version 1 along with peripherals have the highest degree of validity in the system and have a higher coefficient.

An example calculation for two a high-validity user activity avatar and a low-validity user activity avatar, both the high-validly and lower-validly have records indicating they have traveled the same distance on the same virtual road, for example a 1000 geo-tile virtual road with a total value of 1350 SCT. So, the numerator of the fraction for both activity avatars is 1350. The high-validity user activity avatar, gets a lower denominator (i.e., 1450), and low-validity activity avatar gets the higher denominator (i.e., 2740). The result of the fraction for high-validity activity avatar will be 2.9 and the low-validity activity avatar will be equal to 0.246.

The high-validity activity avatar may have the road safety device version 1 connected to the transportation metaverse, where the using road safety road safety device is directly connected to and getting a live data feed from a car and gets a higher (e.g., 2.9) connection coefficient The low-validity activity avatar may have the road safety device as an app running on a smartphone and gets a lower (e.g., 0.5) as a connection coefficient.

If the reward calculation is as follows:

$$Reward = \frac{Value}{Validity} \times Connection$$

Where:
   Value is the value of the road traveled
   Validity is the validity of the user activity avatar
   Connection is the connection coefficient that indicates a level of confidence of the data depending on the way the data entered into the transportation metaverse.

### High-Validity User Activity Avatar:

$$Reward = \frac{1350}{1450} \times 2.9 = 2.70 SCT$$

### Low-Validity User Activity Avatar:

$$Reward = \frac{1350}{2740} \times 0.5 = 0.25 SCT$$

To determine the connection coefficient, each feature of the shared data has different weights and coefficients. For example, the coefficient of the vehicle fuel type features is different from the coefficient of the speed limit feature, and in various road networks these coefficients will be changed. For example, in a road network where crashes are more likely, the speed limit feature for the user will be higher coefficient than the fuel type of the vehicle. Or in a road network where the rate of air pollution is a more important index, the coefficient of the fuel type feature will be higher than the speed limit feature.

### 2-1-2 Calculating SCT Rewards for Users Who Report Road Event on the Road

Road event that are recognized as true by the system's artificial intelligence engine or fulfilled by the condition in the flowchart FIG. 60 and FIG. 61 (with or without the responding of other users) are rewarded using SCT, but the SCT reward amount of the reported road event depends on various factors as described below.

For example, consider two users A and B who are connected to the system network and proceed to report a road event. The following five parameters are generally used to calculate their SCT rewards.
1—The first parameter (average calculated SCT reward for data sharing): the average SCT reward received by the user for sharing data in one geo-tile (based on the average SCT reward of the user in the last 120 blocks being traveled).
2—The second parameter (the final ranks of the reported road event): is a coefficient that is calculated in the corresponding function. The inputs of this function are: road event type, maximum value of Rank Q, duration of display, number of views of the users. This coefficient is multiplied by the first parameter and the result is placed as a numerator of the fraction.
3—The third parameter (validity of user avatars): The user's avatar validity has a reverse relation with the number for the user's avatar validity. It means that the increase in rank of the user's avatar validity causes the amount to be lower. This parameter is placed in the denominator of the fraction.
4—The fourth parameter (type and features of road event): The fourth parameter is the type of reported road event, which is determined based on the road geo-tiles network and other features of the road event, its importance and coefficient.
5—The fifth parameter (condition of storing in distributed ledger): road event or anomalies that are stored in the Distributed ledger will increase the user SCT reward and will bring more validity to the user's avatars. There are two conditions to store in Distributed ledger:

$$X \geq Y \& X > Z \qquad ( FIG . No . 61 )$$

$$Q > Z \qquad ( FIG . No . 60 )$$

If any of these conditions are met, the hash of the event (GEH) is sent to the address of smart contract in distributed ledger and is stored there.

### Example

The first parameter: the average reward received by user A for sharing data in one geo-tile (based on the user reward in the last 120 blocks) is equal to 0.3228 (SCT) and the average reward for user B is equal to 0.02952 (SCT).

The second parameter: the coefficient for user A is 300 and user B is 500.

The numerator of a fraction for user A is 96.84 and for user B is 14.76.

Third parameter: User A with higher avatar validity, gets a lower denominator of a fraction (i.e., 1450) and user B with lower validity, gets a higher denominator of a fraction (i.e., 2740). The result of the fraction for user A is 0.0667 and user B is 0.00538. So, A=0.667 and B=0.269.

The fourth parameter: The importance and coefficient of type of reported road event is determined based on the road geo-tiles network and other features. For example, user A, who reported a vehicle stopped on the shoulder of the road, gets a coefficient of 10, and user B, who reported a deer on the shoulder of the rural road, gets a coefficient of 50. The result of the fraction for user A equals to 0.667 and for user B equals 0.269.

The Fifth parameter: If the conditions are met, the event will be stored in the Blockchain and the user's SCT reward will be increased according to the price of the multiple blocks of road.

### 2-1-3 how to Calculate the Reward of Users Who Respond to the Reported Road Events in the Road.

Users who respond to the road event, their positive response increases the Rank Q. It means the road event is still there.

Users' negative response has caused a decrease in Rank Q. The decrease in Rank Q after an increasing process means that the road event is over. The decrease in Rank Q without an increasing process means that the reported road event has been false.

Users will be rewarded using SCT for their true responses (the response that has been validated as true by the system) to the current conditions on the road.

Receiving SCT rewards depends on four parameters.
1—The first parameter (the average calculated SCT reward for data sharing): The average SCT reward received by the user for sharing data for each geo-tile (based on the average SCT reward of the user in the last 120 geo-tiles traveled).
2—The second parameter (the user's avatar validity): The user's avatar validity has a reverse relation with the number for the user's avatar validity. It means that the increase in rank of the user's avatar validity causes the amount to be lower. This parameter is placed in the denominator of the fraction.
3—The third parameter: The number of contributors while responding to the reported road event. The number of contributors has a reverse relation with the number of this parameter. The increase in the number of contributors for the responses causes this parameter to be lower.
4—The fourth parameter (type and features of road event): The fourth parameter is the type of the reported road event, which is determined based on the road geo-tiles network and other features of the road event, its importance and coefficient.

### 2-2 Define Roads on Distributed Ledger

The set of geo-tiles on the roads create a quad side border for the road.

In the AI engine, each geo-tile may have various features with different values based on data in various layers of the geo-tiles, which makes each block unique. The value of a geo-tile is determined based on the values of some of their features, like daily transportation, user contributions, etc. All user interactions are stored in these geo-tiles. The Roads (a set of geo-tiles) can be owned by a private key of a crypto wallet as NFT. The private key controlling of these NFTs are actually the owners of the transportation metaverse roads and the data corresponding to the blocks, and some of the earnings (SCT) from the various activities of users on real roads is calculated by the POH algorithm and sent to be under the control of the user private key.

Utilizing OpenStreetMap data, the system preprocesses and extracts features for all geo-tiles globally, ensuring comprehensive coverage of roadways. Each geo-tile is uniquely characterized by its ecosystem features, including the type of area (residential, commercial, forest, park, agricultural, etc.), landscape, vegetation, bodies of water, weather conditions, prevalent animal species, and pollution levels. This method facilitates the integration of geographic and location data into the AI engine, allowing for more accurate and personalized predictions.

Each road geo-tile contains several features and the values and weight of the features are different in separate geo-tile. Some of these features of the geo-tile are: road type, speed limit, road length, road signs, cameras, fences, road lighting facilities, etc.

Road geo-tiles are connected with adjacent blocks (ecosystem) and some features of road geo-tiles are affected by the fixed and variable features of the ecosystem. The values of the Ecosystem features are parameters for pattern recognition and prediction of animal presence on the road.

Each road is comprised of multiple blocks which are connected to each other. The different values for features of these blocks allow the pattern recognition in a small range (the same road) and a large range (a specific area) to predict the presence of animals on roads. Road network features and blocks are periodically updated with the latest OpenStreetMap data.

In addition to the OpenStreetMap data, other data like road collisions have been added to the road geo-tiles, this way more features have been extracted for the artificial intelligence data set of the system. These official and valid data have been collected by different institutions and law enforcement agencies in different states of the US. One of the important categories in this system is the records of vehicle animal collisions and corresponding features, which along with other components of the system help us to implement the prediction of the presence of animals on the roads using an artificial intelligence engine. These data are updated periodically.

Various user activities like reporting road events and responding to them and user traffic in the road network will add new and validated data to these blocks. This data will also play an important role in determining the effective features for the decision making of the artificial intelligence engine to predict the presence of animals on the roads.

To store road events in the distributed ledger, these geo-tiles will play an important role. There are so many road events or anomalies being sent concurrently, so a efficient fast solution is needed to link the location of the road event with its corresponding geo-tile. Determining geo-tile bounds has to be precise to minimize wrong geo-tile detection.

To create such a demarcation for each geo-tile, the earth is not flat, therefore, it is not precise and has a high error rate.

Spherical calculations for the earth, being that the earth is not flat rather it is a sphere, so the prevalent Cartesian coordinate system (x, y) cannot be used to determine distance as easily as crossing a line between two points and calculating the distance with a line equation.

### Geographical Event Hash (GEH for Short)

So each land has its own bounding and a unique geo-hash that are easily convertible to each other (FIG. 56) Now, these blocks can be bought and sold as NFTs, and the owners of these NFTs are actually the owners of the Transportation metaverse roads and the data of those blocks, and some of the earnings from the activities of real users on these roads and lands is calculated according to the POH algorithm then is sent to the owner wallet.

These geo-tiles interact with the Distributed ledger and their prices are based on the road network, daily transportation, user activities and their interactions, etc.

The system may implement a geocode system for location-based events. This geocoding system may use 12 precision Geo-hash (GEH) that relates to location and adds time, movement bearing and NFT address to it in order to specify unique events submitted from users. The system calls named this new geocode system, a geographic event hash which is defined as GEH. Every GEH can uniquely identify an event, that is submitted from a user, at a time referenced as seconds, that is moving to a direction referenced as degrees from north.

All user communications and interactions in these road multiple blocks are stored and maintained using the POH algorithm in the POE layer with a dedicated GEH. Geo-hash, Distributed ledger address, bearing movement and time will be combined into a single hash-based code.

### Safety Contribution Token (SCT for Short)

In SCT may be implemented on an existing cryptocurrency platform, like Ethereum, for geographical data and V2V, V2X communication.

The system, a Distributed ledger DApp (Distribute Application) containing smart contracts. The users' event report (POEs) along with a dedicated GEH which are the result of their communications in the V2V and V2X network are validation by POH algorithm then sent to the address of smart contract and will be stored in the distributed ledger.

The Ethereum Blockchain platform is not specifically designed to store and process geographic data. In this system, a cache server may be used that also acts as a proxy for the Distributed ledger to speed up the Distributed ledger transaction and is able to enable V2V and V2X communication in the fastest possible time by connecting in real time through the user smartphone App or electronic road safety devices. Such users can view road events reported on the road ahead in real time without interruption.

All services operate independently and are deployed as a Docker container. The system may deploy service instances in our cloud clusters around the world then use a location-based load balancer to send traffic to neighboring clusters.

All services are stand-alone and deployed as a docker container. The system may deploy service replicas to cloud clusters around the world and apply location based load balancers to dispatch traffic into nearby clusters. Each service has special responsibilities and full health check service to make fault detection, debugging and service upgrades easier.

Road safety devices are physical hand sized devices to accompany users on their journey and reduce complexity of interacting with software applications and mobile phones while driving, running or cycling. These road safety devices are stand-alone hardware road safety devices that can pair with cars, smart phones, smart wearable gadgets or IoT road safety devices and act as a link from real-life to our system digital world.

The SCT may, may be implementing Ethereum EIPs. Main token is an ERC1155 multi-token standard which is fungible-agnostic and cost efficient token contract. It contains user activity avatar NFT, vehicle avatar NFT, Virtual Road NFT, POE NFT and the main currency token SCT.

Every token in ERC1155 has a manifest file in JSON format that describes token value and properties. These properties can be used to display item properties in marketplaces like OpenSea. Write transactions to transfer value or mint NFTs have to contain an ID. This ID is a unique identifier of token type ID. Token types are defined at the beginning and can be updated later if needed by updating the contract.

ERC1155 has the ability to batch transactions. For example, in order to mint a virtual road geo-tiles, the system has a mint roads endpoint that can mint roads in batches and move them to the user address.

The smart contract implementation may delineate distinct roles, namely those of the Chief Technology Officer (CTO), Chief Executive Officer (CEO), and Chief Compliance Officer (CCO), to ensure a clear separation of responsibilities within the organizational framework. Each role may be defined within the smart contract and may be able to be dynamically updated at any time through a secure transaction initiated from the distributed ledger address associated with the CEO.

The system may create another ERC20 token that is responsible for holding user rewards. All rewards may be minted in Distributed ledger and avatars evolve as a new rewards are minted. Users can swap these reward tokens to main tokens in order to buy avatars, attachments and virtual roads.

### 3—Making AI-Based “Animal Crossing Road Sign”

The effectiveness of “wild animal crossing” road signs is limited compared to other warning signs like those for school zones. Factors like climate change and seasonal shifts alter animal behavior and movement, yet these signs remain static and outdated, leading to drivers overlooking them. Unlike school zone signs, which are well-defined and regulated with speed cameras in urban areas, animal crossing signs are often placed in rural or inter-city areas without clear boundaries or adequate lighting, and they lack enforcement measures like speed limits. Consequently, these signs do poorly in modifying driver behavior and preventing collisions.

### Problems for Display Notifications on the Electronic Road Safety Devices or Navigation Apps or Vehicle Screen Based on Animal Crossing Road Warning Signs

In some vehicles and navigation systems, the road speed limit and school zones are announced to the driver. These notifications are announced based on speed limit and school zone. Now, if the vehicle or navigation system displayed warnings based on animal road signs on the user's electronic road safety device or navigation display or vehicle screen, then the driver would always receive these notifications en route. As a result, these notifications will become ineffective and boring like current road warning signs

Based on the operational schedules of educational institutions, warnings may be scheduled. For example, as a vehicle approach the vicinity of a school zone sign, during designated hours, notifications may be sent to be displayed. Designated hours may be for example such as 9:05 AM to 4:05 PM or 5:05 PM to 8:05 PM. The notification may be displayed on the road safety device, navigation applications, or vehicle displays. This approach facilitates timely and relevant communication of safety alerts, specifically tailored to the active hours of nearby schools.

If the same school zone sign approach is take for animal crossing road signs the animal crossing road signs would be an animal crossing zone notification. But unlike the school zone signs, animal crossings do not have a precise location and a specific time. Therefore, if the system use the display process similar to the school zone, display a notification this will lead to inaccuracy due to repeated notifications and will lose their ineffective in time as driver be come numb to the notification.

### Work Procedure:

The system may implement an AI engine to analyze patterns and predict the spatial and temporal likelihood of animal presence on roadways. This AI engine may utilize collected data to estimate the probability of encountering live animals ahead on the route. Based on these predictions, the system might generate notifications that can be displayed on the user's electronic road safety device, vehicle display, or navigation app. The AI engine processes this data through specific steps including collecting, preprocessing, and analyzing data using advanced algorithms designed to enhance prediction accuracy for potential road hazards such as animal crossings, unexpected accidents, and other safety threats.

The system may tailor notifications to each driver, factoring in vehicle speed and driver behavior to predict and alert about potential animal crossings. This dynamic approach means that even on the same stretch of road, a driver might receive different notifications at different times, depending on the specific conditions and detected animal activity at that moment. Unlike traditional, static animal crossing signs, this method provides timely and relevant alerts that adapt daily to the ever-changing variables of animal presence.

Each geo-tile may have specific ecosystem features, for example: type of area (residential, commercial, forest park, forest, agriculture, etc.), landscape, vegetation, pond, river, weather, animal species, pollution level, etc.

The system may segment all the roads across the set of geo-tiles, then the system may separate the roads of each geo-tile and calculated the length of each road segment. Each virtual road consists of a set of geo-tiles that are connected to each other. Each road geo-tile, in addition to the road features, contains various features of the ecosystem with different values and weight.

Some of the road features may be: road type, speed limit, road length, road signs, cameras, fences, road lighting facilities, etc. and some ecosystem features, like type of area (residential, commercial, forest park, forest, agriculture, etc.), landscape, vegetation, pond, river, weather, animal species, pollution level, etc. Furthermore, in these geo-tiles, animal collision records for US states may be stored and the AI engine features extracted based on these collision records. (POA layer). The POH algorithm calculated SCT rewards encourage more contributors to submit road event reports of the presence of live or dead animals or injured animal in the roads. The more submitted road event reports will increase of valid data in the road geo-tiles and as a result, the system AI engine capabilities will enhance and become more accurate. This data may be stored as points of events (POE) related to animals in these geo-tiles. The POE data in a geo-tile may be used by the AI engine to learn, test and predict animal movement patterns.

The system may use a set of recognized patterns in multiple geo-tiles for a route or an area to predict the presence of animals in the road ahead of the vehicle. The recognized patterns from the data of these multiple blocks tend to be repeated in the same ecosystem conditions. The system monitors the current conditions in road geo-tile an area or a road way and use the knowledge generated by the AI engine and other information like the similarities and differences of the climate, to predict what could happen in the future.

Members of the ecosystem, including animals, are interconnected with other ecosystem components. Each element within the ecosystem may depend on another, either directly or indirectly. For instance, variations in temperature within an ecosystem can influence the flora present. Consequently, animals reliant on these plants for sustenance and shelter may need to adapt, possibly relocating or altering their behavioral patterns. Therefore, changes in seasons, months, and weather conditions may affect the timing, routes, and behaviors of animal movements across different geo-tiles.

By analyzing data related to animal-vehicle collisions in Virginia, the system may identify regional patterns. For instance, analysis of data from the years 2019 to 2021 revealed that a significant number of collisions occurred during the fourth week of November, predominantly at night. This discovery represents a regional pattern that enables the system to provide timely notifications. The system may transmit warnings to drivers through electronic road safety devices, navigation applications, or vehicle displays, indicating an elevated collision risk in specific geo-tiles during these identified peak periods.

The notifications generated by the system, while more accurate than those based on conventional road signs, may still require refinement to enhance their predictive accuracy regarding the presence of animals on roadways. To more precisely predict and notify of potential animal crossings, the system may utilize detailed, smaller-scale patterns and relevant features identified within each road network. For this purpose, the system may perform data mining and analysis on records of animal-vehicle collisions along specific geo-tiles of a road in Virginia, focusing on data collected during the fourth week of November over three consecutive years. This analysis has enabled the identification of recurring small-scale patterns specific to these geo-tiles. The features influencing pattern recognition for these animal-vehicle collisions were found to be consistent across the studied period.

Data from a specific road during a seven-day period in November of 2019 and 2020 was analyzed and processed. Based on the features of the geo-tiles and prevailing weather conditions, predictions for potential collision spots and times were made for 2021. Upon comparison with the actual 2021 data, the results were found to closely align with the observed outcomes. Consequently, by considering additional features of the geo-tiles and monitoring weather conditions over short intervals, it was determined that it is possible to recognize patterns indicating the presence of animals on specific roads. This methodology enabled more precise predictions for each road, based on the characteristics and conditions of the geo-tiles. Furthermore, by incorporating and analyzing data on drivers' movements, customized notifications tailored to drivers' behaviors were displayed, enhancing situational awareness and road safety.

FIG. 63 illustrates a system block diagram 6300 showing a Distributed App, Dapp 6301; a database 6302; a Global Information System, GIS 6303; an API 6304; a transaction explorer 6305; a distributed ledger proxy DAPP 6307; a native smartphone applications 6306; and a hardware road safety device 6308.

The DAPP 6301 is a decentralized blockchain application that runs on a distributed ledger, like a blockchain. The DAPP 6301 may use a smart contract to communicate with the blockchain, NFT and user wallets. The DAPP 6301 contains smart contracts that are able to store road event's Point of Event, POE, on the distributed ledger, the stored POE are the validated road events. Confirmation and validation of information (like road event POE) for storing in distributed ledger and calculation of SCT reward is done by the POH algorithm.

The Database 6302 provides data for all services and has similar nodes (replicas) for ease of recovery in case of possible attacks. The database 6302 may run in a container.

The database 6302 may be a relational database, for example a PostgreSQL database with a GIS extension, for example the PostGIS extension enabled for geospatial data indexing and queries. Most of the system data is structured, so the system would benefit from using a relational database engine with strictly typed columns and tables. The relational database with the GIS extension that allows geographic query filters to make working with geographic data fast and easy.

The system works with the geometry data type to achieve faster query speeds and better indexing of geographic data, furthermore the system data may be fully represented as 2D layers, so there's no need for the complexity of storing data as the system does not have a spherical geographical type.

All location data in the system may be indexed with GIS indexes, for example PostGIS Gist indexes, that will make geographical queries execute quickly, for example in milliseconds if used with optimal query.

For data may be pre-processed before the creation of world blocks and adding features to it, all data may be first downloaded in a standard form, such as XML. The map data may come from an OpenStreetMap XML export from Geofabrik website. This data may be imported, for example to PostgreSQL with full Gist index using official OpenStreetMap open-source tool called Osm2PgSQL. In order to make processing faster and make database size smaller, the system may remove unwanted data. This may be done using the Osmosis project before importing to PostgreSQL. This may have a great effect on performance because of removing unnecessary data from index tables.

In the same way, the system may add the official and valid data of crashes, accidents and vehicle-animal collisions on different roads of the United States of America to the database. These data have been collected by various institutions and law enforcement organizations.

User GPS traces, road events and event verification are all indexed with Gist and are stored with exact geometry values, geo-hash and GEH. This will guarantee maximum query performance that can be fed to the AI engine.

Other than geographic data, the system has a large community, and the system is designed to enable v2v and v2x communication for them in milliseconds, we want users to be able to define points of interest (POI) and rate it, share opinions and share personal POI points with others and discuss places, events and points of interest. So, we decided to do full indexing to maximize performance while still being small in size. Brin is a type of index in PostgreSQL that satisfies the system demands. The system may index all the data that is often needed or filtered in queries using the Brin index.

There are two main indexes that are used to store and search for location coordinates, PostGIS location GIST index and geo-hash. Any location and land are searchable by either providing a PostGIS location or geo-hash.

Latitude and longitude coordinates will be converted to equivalent geo-hash value and then a search can match this geo-hash with land block geo-hash value. So that we can find event land by comparing its geo-hash value with lands in the database.

The GIS (Geographic Information System) 6303 provides geographic data layers for Android, IOS or any standard web map. The service also maintains real-time two-way communication with clients to notify the latest updates in real time. The GIS 6303 may run in a container.

GIS 6303 is responsible for any geographical data representation. This data may be clustered into layers. All geographical data layers are exported as vector geo-tiles from PostgreSQL with optimal PostGIS powered queries. A caching service can easily cache vector geo-tiles to speed up geo-tile fetch requests.

In order to represent geographical data on map clients, the system may provide data as map geo-tiles. A map geo-tile contain part of the geographical data contained in a square geo-tile that is defined with a bounding based on latitude, longitude pairs and a zoom level. The bounding box will limit a geographic square in real-life and the zoom level will determine the number of details that is needed on that zoom level.

Geographical data may be provided in a number of ways for example as raster geo-tiles or vector geo-tiles.

For raster geo-tiles the geographical data may be rendered into a raster file (like JPEG/PNG) for every map geo-tile. These raster files get generated on the server or will be generated on the fly as the client's map requests it. When a user scrolls or zooms on the map, for any missing geo-tile, the map client will send a request to the server and fetch a raster file to show this file content as missing map geo-tile. Many map client libraries have implemented caching strategies to cancel fetching a geo-tile twice. This file format is useful when the client road safety device is too low on performance because it will only fetch and directly show geo-tiles without needing any additional processing power.

For vector geo-tiles the geographical data will provided in a metadata format (like XML/JSON/PBF) to the client map application. The client map application will send a request to GIS server 6303 in order to fetch geo-tile date. When a client application fetches vector geographical data for a geo-tile, the client application is responsible to render the metadata into a raster image. The vector method needs more client processing power to render every geo-tile on the client road safety device. The vector method decrease server processing power required to render geo-tiles or even if geo-tiles are cached, it will make cache updates faster with lower processing power. The client applications are smartphone phone apps, the system has no problem to push this processing to clients and these smartphone phone clients are more than capable to render geo-tiles fast and with low performance cost as they all have integrated OpenGL, Vulkan or Metal support and will do the processing quickly, for example in milliseconds for a geo-tile.

Another benefit of using vector geo-tiles is the smaller size of vector file than a raster image as we will only pack required metadata to the package and don't need to provide every pixel data. For example, having a geo-tile with no data, vector geo-tiles will be as small as some bytes only for metadata structure, but a raster file has to contain every pixel data even if these pixels are empty and have no color. Using a vector layer will decrease smartphone data usage for clients and transform map updates faster.

As the client is responsible for rendering geo-tiles, client applications can easily change the render process of a geo-tile and can customize colors, symbols, fonts and every aspect of data that is shown on the map. This level of customization cannot be done with raster geo-tiles. Our server is serving vector geo-tiles to minimize client data usage and provide a smooth and fast map view component on client applications.

As the system has many data attributes on the world, the system has clustered geographical data into layers. A layer is a cluster of geographical data and metadata that are related together and will be served as a separate vector layer. Road layer, Lands layer, Transit layer and accidents layer are examples of some base layers. To optimize map geo-tile loading performance, layers can be merged and provided in a single layer. Every vector layer contains a Geo-tileJSON endpoint to provide its latitude and longitude bounding box, minimum and maximum zoom levels and any other required metadata information.

Another responsibility of GIS 6303 is to create a real-time two-way connection to clients in order to send location and event updates or receive GPS traces and road safety device statistics at any time. In order to achieve this objective, the system may use web sockets with minimum overhead. Web sockets can communicate with a smartphone, web or even embedded road safety devices and provide the most compatibility.

Web sockets are perfect to create a real-time two-way connection to clients but can create problems if not implemented the right way. Every web socket instance will open and maintain a connection to the server.

It is important to maintain these connections with low overhead and remove connections as soon as they are inactive. the system has implemented a heartbeat service that will send small heartbeat packages to inactive clients, if the client is not answering 3 heartbeats, the socket will be stopped and the client socket connection will be destroyed. All geographic data and updates are committed through web socket connection. Road events that are done by users to the server and server will broadcast road events to nearby road safety devices as fast as possible. With this real-time connection users can verify road events nearly in real-time and all other processing like communicating with distributed ledger proxy will happen in the background.

As described, the GIS 6303 plays an important role in application architecture. So, the system has decided to develop this service with a fast compiled programming language to achieve native binary performance on the servers and make this service self-contained with all its dependencies to make this service easily scalable in deployment. Another important factor is to provide good type support to minimize errors in development before even being deployed.

There are may programming languages that may be used for example Go and Rust. These programming languages deliver fast compiled outputs in binary that are self-contained and do not require any prerequisites on the host machine.

The API 6304 API is responsible for authentication, avatar and road safety device management and all interactions and communications from users and vehicles, road geo-tiles, etc. The API 6304 may run in a container.

The API 6304 may be written using a different programming language from the GIS 6303, for example the API 6304 may be written in PHP. PHP is an interpreted language that can deliver high performance HTTP/HTTPS web API because of its library implementations in C and C++. In PHP there is a Swoole package that will mimic Go and Rust multi-threaded async request handling. The API 6304 may be based on Alpine Linux to minimize OS overhead and may use Swoole multi-threaded request handling to maximize performance. The API 6304 may implement the REST API. The API 6304 may add a unique middleware to bring filter query parameters for every endpoint.

The transportation metaverse explorer 6305 provides access to the SCT system data. The transaction explorer 6305 may be is a web-based application. The transaction explorer 6305 may run in a container.

The transportation metaverse explorer 6305 may connect to the DApp 6301 smart contracts in order to make sure our contracts will work independently of installing and under and using existing crypto infrastructure. The transportation metaverse explorer 6305 may provide access to view points of Interest (POI), road events, and road segment NFTs and their properties and other transportation metaverse data. The data provided by the explorer 6305 may come from a distributed ledger cache service in order to make distributed ledger data accessible with a fast response time, for example in the milliseconds, to provide a good user experience.

Transactions submitted to the DApp 6301 smart contracts may use Web3 Javascript APIs. The DAPP 6301 may provide access to a distributed ledger marketplace and the DAPP 6301 may connect to in-browser wallets, for example Metamask so that users can trade lands, avatars NFTs, road safety devices and items.

The smart phone app 6306 (also known as native applications) provide a smartphone applications that communicate with the API and GIS services. The smartphone app 6306 may act as a trusted client for users to easily interact with these services without learning the current interaction complexities of distributed ledger-based systems.

The smartphone app 6306 is to provide a smooth and uninterrupted user experience. The goal of a smooth and uninterrupted user experience is difficult if not impossible be achieved with current multi-platform SDKs like Flutter, React native or Xamarin. So the smartphone app 6306 may be develop as Operating System native applications separately for the Operation Systems, for example Android and IOS.

The Android smartphone application (smartphone app 6306) may be developed with Kotlin and a new Compose library to create better user interfaces for the smartphone app 6306. The smartphone app 6306 may be developed using Maplibre GL native package to display map which is an predecessor open-source version of Mapbox GL. This map uses data from the GIS service 6303 vector geo-tiles managed as layers.

The smartphone app 6306 developed for the Apple IOS may be developed with Swift and may use the Maplibre GL native package to display maps which is an older open-source version of Mapbox GL. This map may use data from the GIS service 6303, specifically vector geo-tiles managed as layers.

For web socket connection the system has developed our custom web socket library that connects to our GIS service. All API requests are managed with a retrofit package that forces us to create model classes for every API data and helps in better development of applications. All application code is designed with the latest Kotlin features.

The Distributed ledger Proxy DAPP 6307 acts as a distributed ledger DApp project and may be used when the road safety device running on the smart phone cannot communicate to the distributed ledger directly using a local wallet for example a smartphone wallet or hardware wallets. The Distributed ledger Proxy 6307 may run in a container.

The Distributed ledger Proxy 6307 acts as a middle man between distributed ledger contracts and other services. This service will receive a user account public address and min NFT or send reward transactions to users. In order to maintain transaction requests and cover any possible slowdowns on the distributed ledger, this service has a custom job handler to queue and monitor pending transactions. The system has separated this service from other services in order to add maximum security for it. This service can be accessed only from inside Kubernetes deployment pod and has no exposed service outside its pod.

This service may use the latest Web3 library to communicate with the Distributed ledger and monitors and reacts to DApp events as they are created on the distributed ledger like on a distributed ledger.

Hardware Road safety devices 6308 provide easy data transfer (manual and automatic) from vehicles, users, environment to connect the real world with the system (the transportation metaverse)

FIG. 64 is a block diagram of Distributed ledger proxy interface between the database and the distributed ledger.

The only endpoint that is open in distributed ledger proxy service is the caching service. This service will cache all distributed ledger data in order to cover distributed ledger low speeds in reading data. This endpoint is read-only and provides cached insensitive data FIG. 64. This service may be written in any number of programming languages for example the Rust programming language. The service and its cache service may be behind a load balancer, or a load balancer for container environment like a Nginx controller.

### Hardware Road Safety Devices

The system API may have endpoints to register, verify and update hardware road safety devices. The API may be integrated into current road safety devices or future road safety devices. Users may authenticate, for example using an OAuth service and share an access token with the road safety device. The road safety device may communicate with the server using the access token.

Road safety devices can interact with API service and GIS service all with one access token that user creates by interacting with OAuth service. Users can easily manage access tokens from native smartphone apps or web applications. Removing or adding a new road safety device will work as easy as adding new road safety devices from official apps or through provided web APIs. We provide Java, Swift, Flutter and JavaScript programming APIs to fasten our system service integration in any software or smart hardware road safety device.

As explained in the GIS section, data is managed in general-purpose layers. A road safety device may automatically create a special layer and add data to that layer. This way user generated data will stay isolated from road safety device data for better security. This security is required as the system may welcome road safety device manufacturers to create and deploy new road safety devices that can connect to the system APIs.

The road safety device may link a real-life entity and its properties with the transportation metaverse. Road safety devices can connect to the server directly and the user can authenticate them for example by scanning a QR (Quick Response) Code or using a NFC (Near Field Communication) tags. Road safety devices may connect through Bluetooth or local network protocols that are provided in a road safety device with network connection to the server, for example the road safety device may be a smartphone, and in this case the connection and authorization process may be left to the smartphone Safety Application.

In the system, each event is catalogued in the database as a Point Of Event (POE) model, which includes location and additional event information linked to a User ID, a Vehicle Avatar, a Road Safety Device, and a designated Layer. Layers are employed to categorize related POEs and control access levels accordingly.

The system may process requests to update the location of the road safety device, for example, through WebSocket/MQTT connections. These requests for location updates may be managed periodically as the device moves, with the updated data, including GPS traces, being stored in the database. This database may utilize various technologies and vendors, such as a cluster of PostgreSQL servers equipped with the PostGIS extension and PostGIS GIST index to enhance geographic data retrieval.

Further, the system may adopt a schema derived from OpenStreetMap data, transforming OSM files into vector data, filtering out redundant data, and storing selected road data in the PostGIS format for subsequent processing. The Planet OSM Line table, for instance, contains comprehensive road data.

POE access is managed through a Campaign system and a Layer system, where each campaign manages its users, roles, and access levels. A campaign may control numerous Layers, each with specific role-based access management, allowing members of a campaign with the necessary roles to create and manage these layers.

The primary application API delineates the system's capabilities, which are predominantly accessible to authenticated users, although certain layers and campaigns may be accessible without authentication.

The GIS API handles data updates and user management. For real-time road user notifications, WebSocket/MQTT protocols, defined within a Rust Actix backend, are utilized. This backend authenticates users via keys generated through the API, with valid tokens maintaining WebSocket connections.

Additionally, the system may implement a Vector tile source server to display maps, POEs, and GPS traces. This implementation may align with Mapbox's open specifications, accommodating various map libraries that support Mapbox to render maps and data layers, such as POEs and user GPS traces.

In terms of distributed ledger technology, the system may deploy NFTs on diverse platforms, including Ethereum and Solana, utilizing technologies like the ERC-1155 standard for efficient smart contract management. Users may initiate transactions using a private encryption key, interacting with smart contracts to mint new tokens for land or road tiles, which are then associated with metadata on the transportation metaverse server.

Regarding token management, a coin token, representing a fungible token with a predetermined total value, may be exchanged for in-app rewards, with transactions facilitated via user wallets in web browsers. Coin burn strategies are employed to maintain network stability and control token supply.

Minting processes within the system are designed to ensure that land blocks and event NFTs are only minable post-verification, adding value to the certified POEs.

Finally, the AI component of the system is initially developed using a crash dataset, such as the Virginia crash dataset combined with OpenStreetMap data, to create the system's inaugural training dataset. As the system evolves, this dataset is continually expanded by incorporating new POE data and updating with external data sources, enhancing the AI model's effectiveness in road safety applications.

1. A virtual animal crossing alert system for vehicles, comprising:
a network-connected road safety device that can be installed in a vehicle,
a server configured to communicate with the road safety device,
an artificial intelligence (AI) module hosted on the server, designed to analyze real-time data related to wildlife activity, environmental conditions, and vehicle traffic patterns, where the AI module determines the likelihood of animal presence on the roadway based on seasonal animal behavior patterns, daily weather conditions, time of day, and recent wildlife sightings reported by vehicles, and
wherein the server sends a dynamic alert to the road safety device to activate an on-screen animal crossing warning sign when the likelihood of encountering wildlife is high.

2. A portable road safety device for enhancing user interaction with navigation apps, comprising:
a wireless communication module for exchanging data with a smartphone,
a plurality of physical buttons on a GUI board for user input,
a camera interface for connecting to a peripheral camera unit, and
a vibration alert interface for connecting to a peripheral vibration unit.

3. The road safety device of claim 2, wherein the road safety device is configured to wirelessly connect to a smartphone running a navigation app.

4. The road safety device of claim 3, wherein the road safety device is further configured to receive navigation app data and display relevant information on the GUI board.

5. The road safety device of claim 3, wherein the road safety device is further configured to transmit user-reported road events or hazards to the navigation app, including images captured by the peripheral camera unit.

6. The road safety device of claim 3, wherein the road safety device is further configured to receive road event or hazard notifications from the navigation app and present them to the user via the display and the peripheral vibration unit.

7. The road safety device of claim 2, wherein each physical button corresponds to a specific road event or hazard.

8. The road safety device of claim 2, further comprising a display on the GUI board for presenting navigation app information and road event notifications to the user.

9. The road safety device of claim 2, wherein the camera unit is configured to automatically capture images of road events or hazards upon user button presses.

10. The road safety device of claim 9, wherein the camera unit is further configured to transmit the captured images to the smartphone for reporting purposes.

11. The road safety device of claim 2, wherein the vibration unit is configured to provide haptic feedback to the user when approaching reported road events or hazards.

12. A system for displaying virtual road signs, comprising:
a computer server that processes data to determine when to display the virtual road sign, where the data quality impacts the issuing of rewards.

13. The system of claim 12, wherein the reward is the issuance of a fungible token.

14. The system of claim 13, wherein the fungible token is issued on a distributed ledger.

15. A Virtual Road sign system comprising:
a computer server that uses data to determine when the Virtual Road Sign should be displayed, where that data is associated with distributed ledger NFT.
